(19) United States
(12) Patent Application Publication
(10) Pub. No.: US 2022/0391921 A1
(43) Pub. Date: Dec. 8, 2022

(54) SYSTEMS AND METHODS FOR ELECTRONIC PORTFOLIO MANAGEMENT

(71) Applicant: Takeda Pharmaceutical Company Limited, Osaka-shi, Osaka (JP)

(72) Inventors: Richard Todd Wilner, Wayland, MA (US); Jason Leedy, Simi Valley, CA (US); David Shane McCarroll, Watertown, MA (US); Sandor Miletic, Rattelsdorf (DE); Nader Ali, West Hills, CA (US)

(73) Assignee: Takeda Pharmaceutical Company Limited, Osaka-shi, Osaka (JP)

(21) Appl. No.: 17/771,414

(22) PCT Filed: Oct. 23, 2020
(86) PCT No.: PCT/US2020/057216

§ 371 Date: Apr. 22, 2022

Related U.S. Application Data
(60) Provisional application No. 63/079,772, filed on Sep. 17, 2020.
(60) Provisional application No. 62/925,483, filed on Oct. 24, 2019.

(51) Int. Cl. G06Q 30/00; G06Q 10/10

(52) U.S. Cl. CPC G06Q 30/018; G06Q 10/103

(57) ABSTRACT

Described herein are embodiments of an electronic gas emission management system. The system accepts values for a plurality of emission sources of a portfolio according to native input formats for the plurality of emission sources. The system translates the native input formats into a first format, wherein the first format allows comparing emissions among the plurality of emission sources. The system accepts user input specifying a target emission for the portfolio. The system determines values for one or more parameters using the emission values for the plurality of emission sources stored in the first format and generates a display for the portfolio based on the parameter(s).

### RELATED APPLICATIONS

This application claims priority under 35 U.S.C. 119(e) to U.S. Provisional Application No. 62/925,483, filed Oct. 24, 2019, entitled “System and Methods for Electronic Portfolio Management,” and to U.S. Provisional Application No. 63/079,772, filed Sep. 17, 2020, entitled “Electronic Greenhouse Gas Emission Management System,” which are incorporated herein by reference in their entireties for all purposes.

### BACKGROUND

Conventional systems are available that attempt to provide platforms to facilitate project and/or portfolio management for companies, development entities, and/or collaborators on such projects. Although these conventional systems address some issues with project management, various conventional approaches fail to provide a holistic platform that can handle incorporation of any type of project, under dynamic time lines and under various stages of development, and/or fail to provide a summary of multiple projects, the combination of which constitutes a portfolio.

### SUMMARY

The inventors have realized that there is still an unmet need for a holistic approach to portfolio management that delivers a minimum consistent set of performance indicators that can be extensible on demand without conflict. Stated broadly, an electronic portfolio management system can be configured to organize multiple individual project records into a combination of hierarchical (e.g., a tree data structure) and non-hierarchical data structures for treatment and management as a collective. In some embodiments, these collections can be dynamically defined and re-defined to establish a portfolio—the collective of individual projects. The system further enables “templatized” project lifecycle management. For example, a variety of customer defined portfolios can rely on template artifacts (e.g., standard data structures) and select unique sets of the template artifacts defined on the system to be universally applicable to the management space. Various embodiments are configured to provide baseline data presentation and analytics through selection of one or more template artifacts. In further embodiments, the system is configured to manage extensions to the baseline data presentation and analytics. For example, the system guides users through creation of custom templates that can be applied to individual projects and/or portfolios as the users see fit. In other embodiments, system administrators can also provide customization options for templates and analytics made available for project management. Various conventional platforms simply fail to address the need to define flexible baselines for project data and analytics, and further fail to enable extension over any such baseline as needed.

The inventors have realized that conventional project management systems do not allow users to efficiently manage greenhouse gas emissions for projects. Conventional systems may fail to generate a measure of greenhouse gas emissions for collections of different projects. Furthermore, conventional systems do not allow users to efficiently view historical emission performance of a collection of projects, nor predicted emission performance of the collection of projects. Various embodiments described herein provide an emission management system for managing greenhouse gas emissions for collections of projects. Further embodiments provide a system for incorporating evolving infrastructure (e.g., power grid, distributed energy systems, etc.) into projections of emissions values of existing projects. The emission profile for such infrastructure can be dynamically evolving. Accurately predicting changes in underlying infrastructure enables the system to generate more accurate modelling, and improves targeting of resource allocation when compare to conventional approaches. In various examples, conventional systems do not provide this functionality and modelling capable of projecting dynamic infrastructure changes (for example, which can be entirely independent of the projects being managed by a system user).

According to one aspect, an electronic gas emission management system is provided. The system comprises: at least one processor configured to: accept emission values for a plurality of emission sources of at least one portfolio according to native input formats for the plurality of emission sources; translate the native input formats into a first format, wherein the first format allows comparing emissions among the plurality of emission sources; and accept user input specifying a target emission for the at least one portfolio; a data store configured to store the emission values for the plurality of emission sources of the at least one portfolio in the first format; a reporting component, executed by the at least one processor, configured to determine values for one or more parameters using the emission values for the plurality of emission sources stored in the first format; and a user interface component, executed by the at least one processor, configured to generate a display for the at least one portfolio responsive to determination of the one or more parameters by the reporting component.

According to one embodiment, the first format comprises a first unit of measurement of emission. According to one embodiment, the first unit of measurement is tCO2e/year. According to one embodiment, the plurality of input formats comprise a plurality of units of measurement. According to one embodiment, the plurality of units of measurement include one or more of the following units: kilowatt-hours (kWh), gallons (gal), or pounds (lbs.).

According to one embodiment, the one or more parameters include one or more of net emission, mean emission per project, or projected net emission. According to one embodiment, the one or more parameters include cost of emissions, projected cost for reduction of emissions, cost for achieving the target emission, emissions abated per unit of currency spent. According to one embodiment, the at least one processor is configured to accept the target emission in the first format. According to one embodiment, the at least one processor is configured to: use the stored emission values and the target emission to generate input features for a machine learning model; and provide the generated input features to the machine learning model to obtain an output indicating one or more actions to modify emissions of the at least one portfolio to achieve the target emission.

According to one embodiment, the at least one processor is configured to determine a resource value associated with projected changes in greenhouse emission values for the at least one portfolio. According to one embodiment, the resource value is a cost of impact, a cost of reduction, or a temporal averaged cost for reduction. According to one embodiment, the at least one processor is configured to determine a resource valuation for achieving the target emission for the at least one portfolio. According to one embodiment, the at least one processor is configured to: determine a timeline associated with achieving the target emission; and dynamically project the resource valuation based on the timeline. According to one embodiment, the reporting component is configured to access project events associated with the target emission and the timeline. According to one embodiment, the at least one processor is configured to: automatically generate the project events; and evaluate completion criteria associated with the project events against the target emission and the timeline.

According to one embodiment, the target emission comprises a target percentage decrease in emissions and/or a target emission output value. According to one embodiment, the user interface component is configured to: generate a display showing the emission values for the plurality of emission sources in the native input formats and the first format. According to one embodiment, the user interface component is configured to: toggle display of the emissions values between the native input formats and the first format responsive to a user selection.

According to one embodiment, the at least one processor is configured to accept an input specifying an action for modifying emission for the at least one portfolio; the reporting component is configured to determine, responsive to the specified action, a predicted change in the emission for the at least one portfolio in the first format; and the user interface component is configured to generate a visualization of the predicted change in emission in the display for the at least one portfolio.

According to one embodiment, the reporting component is configured to: determine a change in emission factor for at least one of the plurality of emission sources; and update at least one of the one or more parameters responsive to the change in emission factor. According to one embodiment, the data store is configured to store historical, present, and projected emission values for the plurality of emission sources of the at least one portfolio. According to one embodiment, the at least one processor is configured to use the historical, present, and projected emissions values to determine net emission for the at least one portfolio over a time period; and the user interface component is configured to generate a graph including a plot of the net emission over the time period.

According to another aspect, a computer-implemented method of managing greenhouse gas emissions is provided. The method comprises: accepting emission values for a plurality of emission sources of at least one portfolio according to native input formats for the plurality of emission sources; translating the native input formats into a first format, wherein the first format allows comparing emissions among the plurality of emission sources; accepting user input specifying a target emission for the at least one portfolio; storing, in a data store, the emission values for the plurality of emission sources of the at least one portfolio in the first format; determining values for one or more parameters using the emission values for the plurality of emission sources stored in the first format; and generating a display for the at least one portfolio responsive to determination of the one or more parameters by the reporting component.

According to one embodiment, the first format comprises a unit of measurement of emission. According to one embodiment, the first unit of measurement of emission is tCO2e/year. According to one embodiment, the plurality of input formats comprise a plurality of units of measurement of emission.

According to one embodiment, the one or more parameters include one or more of net emission, mean emission per project, or projected net emission. According to one embodiment, the one or more parameters include cost of emissions, projected cost for reduction of emissions, cost for achieving the target emission, emissions abated per unit of currency spent. According to one embodiment, the method comprises determining a resource value associated with projected changes in greenhouse emission values for the at least one portfolio. According to one embodiment, the method comprises: automatically generating the project events; and evaluating completion criteria associated with the project events against the target emission and the timeline.

According to another aspect, an electronic project portfolio management system is provided. The system comprises: at least one processor operatively connected to a memory; a template database stored in the memory, wherein respective templates define project data to be made available for display, and analysis metrics for use with the project data; a portfolio manager component, executed by the at least one processor, configured to accept user selection of one or more templates from the template database, and generate a plurality of display windows based on the user selection of the one or more templates, wherein the plurality of display windows includes at least a portfolio dashboard view; and a project navigator component, executed by the at least one processor, configured to visualize a user defined grouping of projects, and enable navigation within the plurality of display windows for information on the respective project.

According to one embodiment, the at least one processor is configured to group the projects into a portfolio. According to one embodiment, the portfolio manager component is configured to: accept user selection of multiple templates; and apply the multiple templates to the portfolio. According to one embodiment, the portfolio manager component is configured to resolve one or more redundancies induced by application of the multiple templates. According to one embodiment, the portfolio manager component is configured to: accept user input indicating a grouping of the plurality of projects; and group the plurality of projects into the portfolio based on the user input.

According to one embodiment, the system comprises a filter component configured to define queries to execute on the project data based on user input. According to one embodiment, the at least one processor is configured to dynamically update one or more of the plurality of display windows in response to execution of queries defined through the filter component. According to one embodiment, the system comprises an analytics component configured to generate analysis of the project data responsive to aggregating analysis metrics defined in the one or more selected templates.

According to another aspect, a computer-implemented method for electronic project portfolio management is provided. The method comprises: using at least one processor to perform: visualizing a user defined grouping of projects; enabling navigation within a plurality of display windows for information on the respective project, including at least a portfolio dashboard view; storing a plurality of templates in a template database, wherein respective templates define project data to be made available for display and analysis metrics for use with the project data; accepting a user selection of one or more templates from the template database; and generating at least some of the plurality of display windows based on the user selection of the one or more templates.

According to one embodiment, the method comprises grouping the projects into a portfolio. According to one embodiment, the method comprises: accepting user selection of multiple templates; and applying the multiple templates to the portfolio. According to one embodiment, the method comprises resolving one or more redundancies induced by application of the multiple templates.

According to one embodiment, the method comprises defining queries to execute on the project data based on user input. According to one embodiment, the method comprises generating analysis of the project data responsive to aggregating analysis metrics defined in the one or more selected templates.

According to another aspect, an electronic project portfolio management system is provided. The system comprises: at least one processor operatively connected to a memory, the at least one processor when executing configured to: display at least a first portfolio dashboard view, the dashboard view comprising at least one of A, B, or C: A) a plurality of display tiles, wherein the plurality of display tiles are configured for a consistent display across a plurality of portfolios, each portfolio defining a grouping of projects, and wherein the plurality of display tiles include at least one of: i, ii, iii, iv, v, or vi: i) a priority display tile reflective of an alignment value automatically determined by the system between project status and business strategic objectives; ii) a phase display tile configured to aggregate a grouping of projects assigned to a portfolio into phase status categories including at least one of an initiate and close phase, optionally including a define phase, a plan phase, an execute phase, or a track post close phase; iii) a milestone performance tile configured to display aggregations of project information; iv) a budget display tile configured to display at least one of current portfolio budget, planned budget, forecast budget, or year to date actual budget; v) future time period display tile configured to display information on at least one of: milestones coming due within the time period, projects completing within the time period, risk/issues items coming due within the time period, or ask/need coming due within the time period; vi) last time period display tile configured to display information on at least one of milestones completed, projects completed within the time period, projects started within the time period, projects finished execution phase, or projects put on hold; B) a project display grid including a plurality of columns including at least one of a project name, priority, phase, PM Sponsor, and one or more key performance indicator (KPI) displays; and C) a filter interface configured to receive user input specifying one or more filters to apply on the first portfolio.

According to one embodiment, the at least one processor is configured to: build queries on the portfolio and/or project data based on the user input specifying the one or more filters to apply on the project data; and dynamically trigger at least one of the plurality of display tiles or the project display grid, to re-compute and re-display respective data responsive to application of the query on the project data.

According to one embodiment, the at least one processor is configured to: monitor data associated with a respective project; and update a KPI display in the project display grid of the respective project in response to detecting a defined event from the data. According to one embodiment, the at least one processor is configured to set one or more of the plurality of display tiles by applying one or more business rules to data associated with projects of a portfolio.

According to one embodiment, wherein the at least one processor is configured to: determine, for a respective project, at least one of the following parameters: a percent of project milestones completed on time, percent of milestones predicted to be on time in a specified time period, or a historic complete rate for project milestones; and set a display of the milestone performance tile for the respective project based on the determined at least one parameter. According to one embodiment, the at least one processor is configured to determine one or more projects to include in the project display grid based on the user input obtained from the filter interface.

According to another aspect, an electronic gas emission management system is provided. The system comprises: at least one processor configured to: accept emission values for a plurality of emission sources of at least one portfolio according to native input formats for the plurality of emission sources; translate the native input formats into a first format, wherein the first format allows comparing the emission values for the plurality of emission sources; and accept user input specifying a target emission for the at least one portfolio; a data store configured to store the emission values for the plurality of emission sources of the at least one portfolio in the first format; a reporting component, executed by the at least one processor, configured to determine values for one or more parameters using the emission values for the plurality of emission sources stored in the first format; and a user interface component, executed by the at least one processor, configured to generate a display for the at least one portfolio responsive to determination of the one or more parameters by the reporting component.

According to one embodiment, the first format comprises a first unit of measurement of emission. According to one embodiment, the first unit of measurement is tCO2e/year. According to one embodiment, the plurality of input formats comprise a plurality of units of measurement. According to one embodiment, the plurality of units of measurement include one or more of the following units: kilowatt-hours (kWh), gallons (gal), or pounds (lbs.). According to one embodiment, the one or more parameters include one or more of net emission, mean emission per project, or projected net emission. According to one embodiment, the one or more parameters include cost of emissions, projected cost for reduction of emissions, cost for achieving the target emission, emissions abated per unit of currency spent.

According to one embodiment, the at least one processor is configured to accept the target emission in the first format. According to one embodiment, the at least one processor is configured to: use the stored emission values and the target emission to generate input features for a machine learning model; and provide the generated input features to the machine learning model to obtain an output indicating one or more actions to achieve the target emission.

According to one embodiment, the at least one processor is configured to determine a resource value associated with projected changes in greenhouse emission values for the at least one portfolio. According to one embodiment, the resource value is a cost of impact, a cost of reduction, or a temporal averaged cost for reduction. According to one embodiment, the at least one processor is configured to determine a resource valuation for achieving the target emission for the at least one portfolio. According to one embodiment, the at least one processor is configured to: determine a timeline associated with achieving the target emission; and dynamically project the resource valuation based on the timeline. According to one embodiment, the reporting component is configured to access project events associated with the target emission and the timeline. According to one embodiment, the at least one processor is configured to: automatically generate the project events; and evaluate completion criteria associated with the project events against the target emission and the timeline.

According to one embodiment, the target emission comprises a target percentage decrease in emissions and/or a target emission output value. According to one embodiment, the user interface component is configured to: generate a display showing the emission values for the plurality of emission sources in the native input formats and the first format. According to one embodiment, the user interface component is configured to: toggle display of the emissions values between the native input formats and the first format responsive to a user selection.

According to one embodiment, the at least one processor is configured to accept an input specifying an action for modifying emission for the at least one portfolio; the reporting component is configured to determine, responsive to the specified action, a predicted change in an emission value for the at least one portfolio in the first format; and the user interface component is configured to generate a visualization of the predicted change in emission in the display for the at least one portfolio.

According to one embodiment, the reporting component is configured to: determine a change in emission factor for at least one of the plurality of emission sources; and update at least one of the one or more parameters responsive to the change in emission factor. According to one embodiment, the data store is configured to store historical, present, and projected emission values for the plurality of emission sources of the at least one portfolio. According to one embodiment, the at least one processor is configured to use the historical, present, and projected emissions values to determine net emission for the at least one portfolio over a time period; and

the user interface component is configured to generate a graph including a plot of the net emission over the time period.

According to another aspect, a computer-implemented method of managing greenhouse gas emissions is provided. The method comprises: accepting emission values for a plurality of emission sources of at least one portfolio according to native input formats for the plurality of emission sources; translating the native input formats into a first format, wherein the first format allows comparing the emission values for the plurality of emission sources; accepting user input specifying a target emission for the at least one portfolio; storing, in a data store, the emission values for the plurality of emission sources of the at least one portfolio in the first format; determining values for one or more parameters using the emission values for the plurality of emission sources stored in the first format; and generating a display for the at least one portfolio responsive to determination of the one or more parameters by the reporting component.

According to one embodiment, the first format comprises a unit of measurement of emission. According to one embodiment, the first unit of measurement of emission is tCO2e/year. According to one embodiment, the plurality of input formats comprise a plurality of units of measurement of emission.

According to one embodiment, the one or more parameters include one or more of net emission, mean emission per project, or projected net emission. According to one embodiment, the one or more parameters include cost of emissions, projected cost for reduction of emissions, cost for achieving the target emission, emissions abated per unit of currency spent.

According to one embodiment, the method further comprises determining a resource value associated with projected changes in greenhouse emission values for the at least one portfolio.

According to one embodiment, the method further comprises: determining automatically generating the project events; and evaluating completion criteria associated with the project events against the target emission and the timeline.

According to another aspect, an electronic project portfolio management system is provided. The system comprises: at least one processor operatively connected to a memory; a template database stored in the memory, wherein respective templates define project data to be made available for display, and analysis metrics for use with the project data; a portfolio manager component, executed by the at least one processor, configured to accept user selection of one or more templates from the template database, and generate a plurality of display windows based on the user selection of the one or more templates, wherein the plurality of display windows includes at least a portfolio dashboard view; and a project navigator component, executed by the at least one processor, configured to visualize a user defined grouping of projects, and enable navigation within the plurality of display windows for information on the respective project.

According to one embodiment, the at least one processor is configured to generate a portfolio comprising the user defined grouping of projects. According to one embodiment, the portfolio manager component is configured to: accept user selection of multiple templates; and apply the multiple templates to the portfolio. According to one embodiment, the portfolio manager component is configured to resolve one or more redundancies induced by application of the multiple templates. According to one embodiment, the portfolio manager component is configured to: accept user input indicating a grouping of the plurality of projects; and group the plurality of projects into the portfolio based on the user input.

According to one embodiment, the system further comprises a filter component configured to define queries to execute on the project data based on user input. According to one embodiment, the at least one processor is configured to dynamically update one or more of the plurality of display windows in response to execution of queries defined through the filter component. According to one embodiment, the system further comprises an analytics component configured to generate analysis of the project data responsive to aggregating analysis metrics defined in the one or more selected templates.

According to another aspect, a computer-implemented method for electronic project portfolio management is provided. The method comprises: using at least one processor to perform: visualizing a user defined grouping of projects; enabling navigation within a plurality of display windows for information on the respective project, including at least a portfolio dashboard view; storing a plurality of templates in a template database, wherein respective templates define project data to be made available for display and analysis metrics for use with the project data; accepting a user selection of one or more templates from the template database; and generating at least some of the plurality of display windows based on the user selection of the one or more templates.

According to one embodiment, the method further comprises generating a portfolio comprising the user defined grouping of projects. According to one embodiment, the method further comprises: accepting user selection of multiple templates; and applying the multiple templates to the portfolio. According to one embodiment, the method further comprises resolving one or more redundancies induced by application of the multiple templates. According to one embodiment, the method further comprises defining queries to execute on the project data based on user input. According to one embodiment, the method further comprises generating analysis of the project data responsive to aggregating analysis metrics defined in the one or more selected templates.

According to another aspect, an electronic project portfolio management system is provided. The system comprises: at least one processor operatively connected to a memory, the at least one processor when executing configured to: display at least a first portfolio dashboard view, the dashboard view comprising at least one of A, B, or C: A) a plurality of display tiles, wherein the plurality of display tiles are configured for a consistent display across a plurality of portfolios, each portfolio defining a grouping of projects, and wherein the plurality of display tiles include at least one of: i, ii, iii, iv, v, or vi: i) a priority display tile reflective of an alignment value automatically determined by the system between project status and business strategic objectives; ii) a phase display tile configured to aggregate a grouping of projects assigned to a portfolio into phase status categories including at least one of an initiate and close phase, optionally including a define phase, a plan phase, an execute phase, or a track post close phase; iii) a milestone performance tile configured to display aggregations of project information; iv) a budget display tile configured to display at least one of current portfolio budget, planned budget, forecast budget, or year to date actual budget; v) future time period display tile configured to display information on at least one of: milestones coming due within the time period, projects completing within the time period, risk/issues items coming due within the time period, or ask/need coming due within the time period; vi) last time period display tile configured to display information on at least one of milestones completed, projects completed within the time period, projects started within the time period, projects finished execution phase, or projects put on hold; B) a project display grid including a plurality of columns including at least one of a project name, priority, phase, PM Sponsor, and one or more key performance indicator (KPI) displays; and C) a filter interface configured to receive user input specifying one or more filters to apply on the first portfolio.

According to one embodiment, the at least one processor is configured to: build queries on the portfolio and/or project data based on the user input specifying the one or more filters to apply on the project data; and dynamically trigger at least one of the plurality of display tiles or the project display grid, to re-compute and re-display respective data responsive to application of the query on the project data.

According to one embodiment, the at least one processor is configured to: monitor data associated with a respective project; and update a KPI display in the project display grid of the respective project in response to detecting a defined event from the data. According to one embodiment, the at least one processor is configured to set one or more of the plurality of display tiles by applying one or more business rules to data associated with projects of a portfolio.

According to one embodiment, the at least one processor is configured to: determine, for a respective project, at least one of the following parameters: a percent of project milestones completed on time, percent of milestones predicted to be on time in a specified time period, or a historic complete rate for project milestones; and set a display of the milestone performance tile for the respective project based on the determined at least one parameter. According to one embodiment, the at least one processor is configured to determine one or more projects to include in the project display grid based on the user input obtained from the filter interface.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1A illustrates a block diagram of an example management system, according to some embodiments;

FIG. 1B illustrates a block diagram of an example management system, according to some embodiments;

FIG. 2 illustrates a block diagram of an example management system and environment, according to some embodiments;

FIG. 3A illustrates a block diagram of an example component, according to some embodiments;

FIG. 3B illustrates a block diagram of an example management system, according to some embodiments;

FIG. 4 is an example screen capture, according to some embodiments;

FIG. 5 is an example screen capture, according to some embodiments;

FIG. 6 is an example screen capture, according to some embodiments;

FIGS. 7A-H are example reports generated according to some embodiments; and

FIG. 8 is a block diagram of an example a computer system that can be specially configured as disclosed herein;

FIG. 9 is a block diagram of portfolio management operations, according to some embodiments;

FIG. 10 is an example screen capture of a portfolio view, according to some embodiments;

FIG. 11 is an example screen capture of a project dashboard, according to some embodiments;

FIG. 12 is an example screen capture of a portfolio performance view, according to some embodiments;

FIG. 13 is an example screen capture of an associated projects view, according to some embodiments;

FIG. 14 is an example screen capture of a budget view, according to some embodiments

FIG. 15 is an example screen capture of project details and forms user interface, according to some embodiments;

FIG. 16 is an example screen capture of a user interface for managing portfolio filters, according to some embodiments;

FIG. 17 is an example screen capture of a user interface for generating portfolio reports, according to some embodiments;

FIG. 18 is an example screen capture of a user interface for configuring project phase, according to some embodiments;

FIG. 19 is an example screen capture of a user interface for editing milestones, according to some embodiments;

FIG. 20 is an example screen capture of a user interface showing network performance, according to some embodiments;

FIG. 21 is an example screen capture of a generated project report, according to some embodiments;

FIG. 22 is an example screen capture of a user interface for submission of a problem for a project, according to some embodiments;

FIG. 23 is an example screen capture of a user interface for recommending an option, according to some embodiments;

FIG. 24 is an example screen capture of a project specific report, according to some embodiments;

FIG. 25 is an example screen capture of a portfolio report, according to some embodiments;

FIG. 26A illustrates a block diagram of an environment in which an emissions management system may operate, according to some embodiments;

FIG. 26B illustrates a data flow diagram of translation of emission formats, according to some embodiments;

FIG. 27 shows a flow chart of an example process for determining parameter(s) for portfolio(s), according to some embodiments;

FIG. 28 shows a flow chart of an example process for implementing actions to modify emission of portfolio(s), according to some embodiments;

FIG. 29 shows a flow chart of an example process for implementing a change in emission factor(s) in portfolio(s), according to some embodiments;

FIG. 30 shows a flow chart of an example process for implementing project event(s) in portfolio(s), according to some embodiments;

FIG. 31 shows an example user interface display of emission values for a project, according to some embodiments;

FIG. 32 shows an example user interface display of emission information for portfolio(s), according to some embodiments;

FIG. 33 shows an example user interface display of emission information for projects of a portfolio, according to some embodiments;

FIG. 34A shows an example user interface display for historical emissions for portfolio(s), according to some embodiments;

FIG. 34B shows an example user interface display of emission information for a specific project selected from the user interface display of FIG. 34A, according to some embodiments; and

FIG. 35 shows an example user interface display of target contributions of different projects of portfolio(s) to a target emission reduction, according to some embodiments.

### DETAILED DESCRIPTION

According to some aspects, an electronic portfolio management system is provided. The portfolio management system provides a vehicle for end-users to define and operate via a single point of truth for understanding a large volume of project/portfolio information that can entirely replace a constellation of disparate, independent or semi-connected legacy systems (i.e. conventional portfolio management). Various embodiments integrate and execute templatized approaches for data processing, development lifecycle, and business decision making, and further improves over conventional approaches by eliminating redundant systems, redundant reporting, and defines a consistent view for understanding and accessing large volumes of project data consistently. Unlike conventional approaches, various system examples leverage the consistent views and templated approach to redefine portfolio management from an administrative data/information collection effort into a value-added analytics posture. Further embodiments build system intelligence (e.g., machine learning and modelling) into (1) prioritization of projects, tasks, and/or portfolios to meet business goals, for instance, providing recommendations on resolution for management issues; and (2) predicting future performance (e.g., using historical performance of projects with similar characteristics).

According to some embodiments, the system may generate visualizations for a collection of projects more efficiently than conventional systems. In some embodiments, the system can be configured to use a template to generate a user interface for providing a visualization for the collection of projects. The system can be configured to apply the template to the collection of projects to obtain the visualizations. The template may allow the system to more efficiently generate different visualizations for the collection of projects. For example, a template may define one or more displays that are to be provided in the visualization. The system may use the template to generate a visualization including the display(s) by applying the template to data from a collection of projects (e.g., a portfolio).

A portfolio may comprise a data structure storing a collection of one or more projects. For example, a portfolio may be one or more projects associated with a geographical location or region. In another example, a portfolio may be one or more projects associated with a product or industry. In another example, a portfolio may be one or more projects that impact greenhouse gas emissions. In some embodiments, the system can be configured to dynamically define and redefine a portfolio. The system can be configured to define and redefine the portfolio by including and/or excluding project(s) from the portfolio (e.g., responsive to user input).

Further embodiments provide consistent visualizations of project data via standardized and user-configurable dashboard view(s), which link users to further detailed view(s) accessible on-demand. The visualizations establish a baseline view of a massive volume of project data that establishes a consistent baseline for every project, portfolio, and/or development site/partnership. The visualizations further establish a consistent baseline view of the project data across multiple disparate systems. In further embodiments, the baseline view and data being analyzed can be extensible. Some embodiments provide visual user interface elements that convey large amounts of information about portfolio(s) and/or project(s) in limited space of a user interface.

Some embodiments provide a computer system that provides visualizations of large amounts of information about portfolio(s) and/or project(s) more efficiently than conventional systems. Conventional systems may generate numerous different user interfaces in order to visualize large amounts of data about portfolio(s) and/or project(s). Some embodiments of the technology described herein provide graphical user interface (GUI) elements that present large amounts of information about portfolio(s) and/or project(s) in a limited space of a user interface. The GUI elements may allow the system to provide a visualization of a set of data by generating fewer user interface screens than would be generated by conventional systems to provide a visualization of the set of data. As the system generates a fewer number of user interface screens to provide a visualization of the set of data, the system may perform fewer computations to provide the visualization compared to conventional systems. Accordingly, the computer system may provide visualizations of large amounts of data more efficiently than conventional systems.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, any combination of, and all of the described terms.

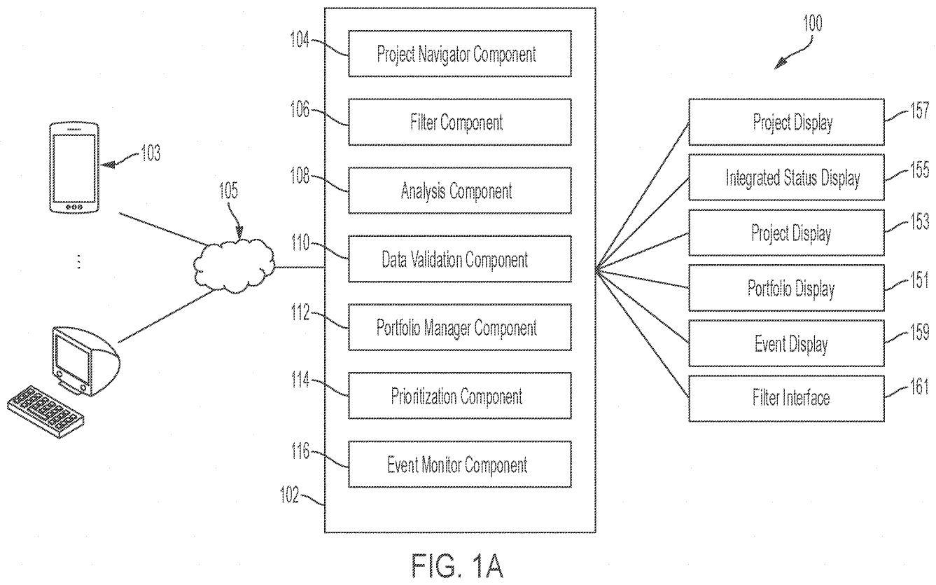

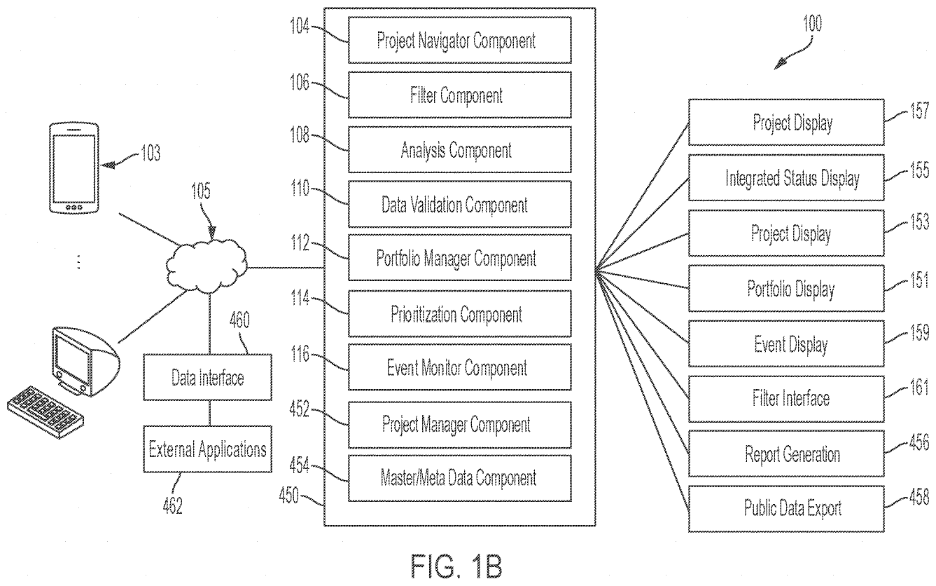

Shown in FIG. 1A is a block diagram of an example system 100, according to one embodiment. System 100 can include a variety of components which are configured to perform specialized functions in the system (e.g., discussed below). Alternatively, system 100 can perform the discussed functions without instantiating the specific components.

According to some embodiments, system 100 can include an execution engine 102. The execution engine 102 can be configured to instantiate the various components and/or execute the discussed functionality. According to one embodiment, system 100 can include a project navigator component 104. The project navigator component 104 can be configured to accept user input to navigate between defined portfolios which include groupings of projects and/or to navigate to detailed information on the portfolio and constituent projects. Users may access the system in a variety of ways. For example, system 100 can include localized hardware accessible at a user site. In other embodiments, system 100 can be implemented as a cloud-based service accessible to end-users at 103 via a communication network 105 (e.g., the Internet).

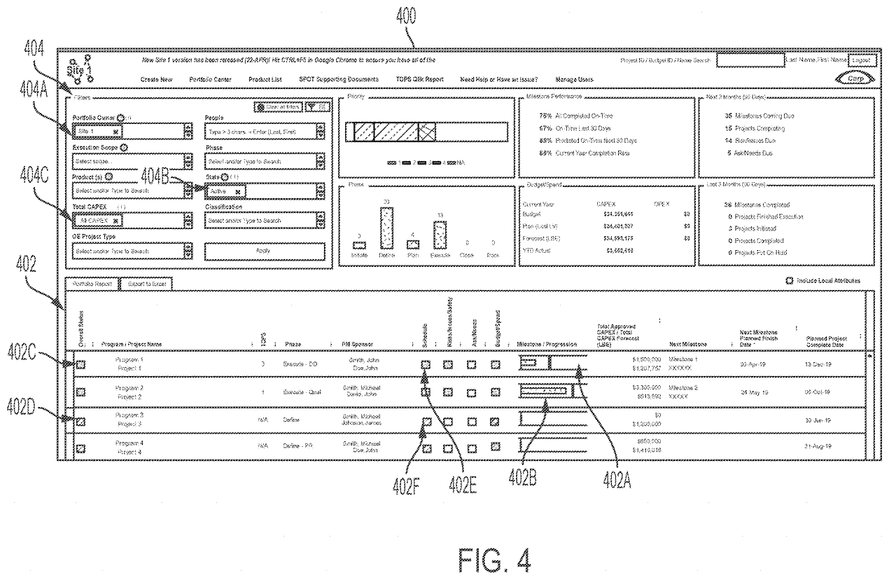

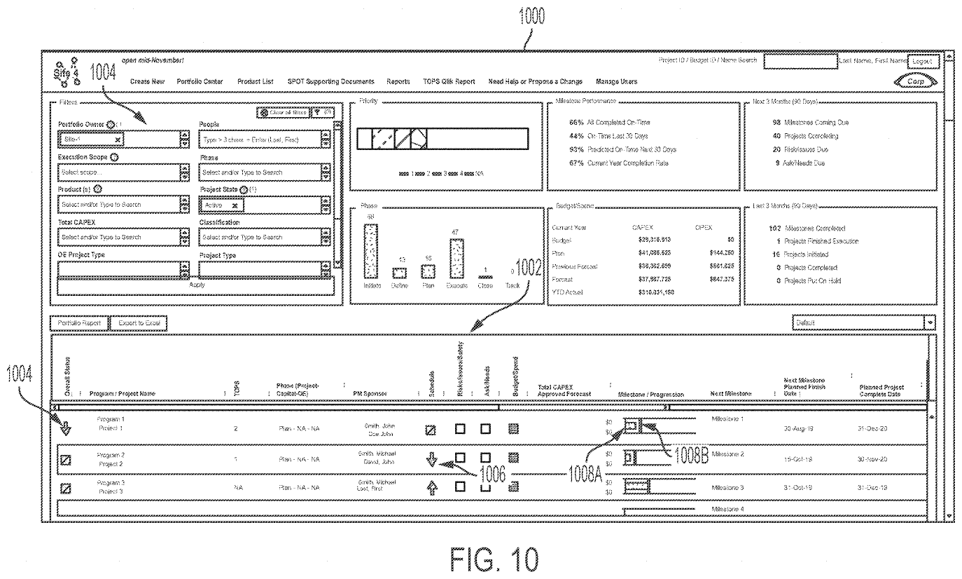

In some embodiments, the project navigator component 104 can be configured to provide a dashboard view of projects and portfolios available on the system. For example, the project navigator component 104 can present a portfolio view (including, for example, portfolio display 153), which may include a grid-based view of constituent projects that make up a respective portfolio. In another example, each row of the grid-based view represents a project in the portfolio. Each row may include information on status of the project and may include a set of key performance indicators for each project. For example, shown in FIG. 4 (discussed below) is a portfolio view which includes a grid view of the constituent projects that make up the portfolio. In some embodiments the system provides a portfolio display 151 which can include, for example, the portfolio view of FIG. 4 and FIG. 10.

In some embodiments, the system can also include a filter component 106. The filter component can be configured to build queries on portfolio and/or project data and return the output of those queries to the navigator component for display. In other embodiments, the filter component 106 can be integrated within the project navigator component and execution of the filter component results in an updated display of the portfolio information. For example, selection of one or more filters may trigger responsive updates to the display of Referring to FIG. 4, shown is an example of user interface elements presented by the filter component 106. As shown in FIG. 4 various filter criteria can be presented in the user interface. For example, filter criteria can include portfolio owner. In some embodiments, specific values for the filter field may be available via drop-down menu selection. Other criteria can include filters on people (e.g. via name), execution scope, phase, product, state, total CAPEX, classification, OE project type, among other options. Responsive to selection of a filter criteria (and/or representative visual object) in the user interface, the filter component 106 can apply any specified filter criteria on the data set and result in the system updating the information displayed.

According to some embodiments, the dashboard display can include portfolio tiles configured to provide real-time dynamic performance analytics. The display of the analytics can also be configured to expand into additional detailed views responsive to selection in the user interface. In one embodiment, the portfolio tiles include priority, milestone performance, next three months, phase, budget spend, last three months, among other options. In some embodiments, the information shown in the portfolio tiles can be generated by an analysis component 108. The analysis component 108 can be configured to provide aggregated information based on information associated with constituent projects and/or any baseline information defined for respective portfolio (e.g., completion date, current status, current spend, change requests, change approvals, etc.).

According to some embodiments, the analysis component 108 comprises an internal analysis component and an external analysis component. In some embodiments, the internal analysis component can be configured to provide aggregated information within the system 450. For example, the system may execute analytics within a portfolio management platform provided by the system 450 and display results of the execution therein. In some embodiments, the external analysis component can be configured to provide data to external applications 462. For example, the external analysis component can be configured to provide results of executed analytics to Power BI and/or Qlik. Some embodiments are not limited to example external applications discussed herein.

In some embodiments, the analysis component 108 can be configured to receive updated information from an event monitor component 116. For example, system 100 can be connected to other system and/or data sources that are monitored and processed to maintain a repository of standardized project information. An event monitor component 116 can be configured to monitor the connected systems and/or the standardized repository for updates, change notices, etc. The event monitor component 116 can be configured to identify any update as an event to refresh various displays presented by the system. Examples of events that can be configured to trigger an update include a user request for a dashboard, update of data, and/or update made to an associated project (e.g., a child project). An event may trigger an update to a project and/or portfolio. For example, the event may trigger an update to project status and/or data quality. In some embodiments, the event monitor component can include application programming interfaces (APIs) for external system and/or connected systems, and the system can receive information from the APIs (e.g., push or pull, among other options). In further embodiments, the event monitor component can include file import functionality to obtain and/or retrieve updated information.

In some embodiments, the analysis component 108 can be configured to determine one or more key performance indicators (KPIs). In some embodiments, the KPIs may have a lead-lag relationship. Accordingly, if one KPI goes bad (e.g., red) and remains un-remediated, others may be likely to follow. In some embodiments, the analysis component 108 can be configured to define a relationship among KPIs based on intended use of the use of the KPIs. In some embodiments, a machine learning algorithm is trained on patterns of KPIs as they relate to individual projects and portfolios. The trained machine learning model may be used to predict the future state of those KPIs. For example, if there is a risk that the KPI will be red for 3 reporting cycles, there may be a risk of a schedule turning from green to yellow. A machine learning model may predict that a schedule will turn red in the next reporting cycle. For example, the analysis component 108 may determine feature values (e.g., current KPI values) based on data from project records and provide the determined feature values as input to the machine learning model to obtain an output indicating whether there is a risk of the schedule being delayed.

In other embodiments, the event monitor component and analysis component can be configured to work in conjunction to provide analysis information on continuously updated data feeds. In some examples, event-based updates will be analyzed by the analysis component and update any portfolio display (e.g., 151) rendered by the system.

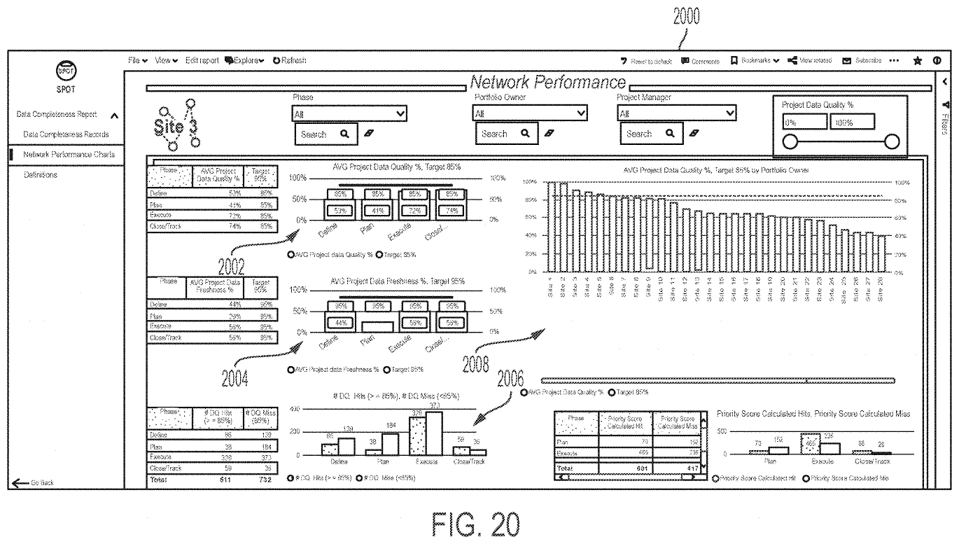

In other embodiments, the event monitor component and analysis component can be configured to work in conjunction to provide an objective indication of the quality of the data resident in the records accessible to the system. In a significant departure from conventional approaches, the data quality indication can provide instant, actionable insights to the managers responsible for the data. The data quality indication can provide insights into which data and elements require remediation on a real-time basis, across a part of a portfolio, an entire portfolio, or any combination of portfolios. An example report generated by the event monitor component and/or analysis component is discussed herein with reference to FIG. 20.

Other components may also contribute information to a portfolio display. For example, a prioritization component 114 can be configured to analyze current information against business rules aligned with strategic objectives (for example, defined or specified by portfolio administrators). In some embodiments, the prioritization component 114 enables definition of custom business rules tailored to portfolios and/or projects, that deliver analysis of strategic objectives against the project and portfolio information.

According to some embodiments, an intelligent mathematical model can be processed to assess projects and status and determine alignment with strategic objectives. In further embodiments, the prioritization component 114 is configured to deliver consistent ranking of projects based on an intelligent assessment of business value (e.g., alignment with strategic objectives defined by the model). In a significant departure from conventional approaches, the prioritization component 114 is configured to deliver a standardized modeling of value across projects, across portfolios, and even across new acquisitions. The prioritization component 114 can deliver standardized modeling within the same baseline set of interface displays. In further embodiments, prioritization component 114 is further configured to execute scenario planning against existing projects, portfolios, etc. In one example, scenario planning includes an extrapolation by the system of the analytics and business value metrics into future actions and candidate priorities that should be placed on or removed from respective portfolios and/or respective projects.

According to various embodiments, the respective components executed by the system can deliver associated views or portions of views to be shown in integrated displays and/or dashboard displays. For example, the portfolio display 151 can include event display elements 159, filter interface 161, project display (e.g., project grid display) 153, integrated status display elements 155, and/or priority display 157, amongst other options. Examples of the various views, displays, display elements are shown by way of example in FIGS. 4-7.

In further embodiments, system 100 can include a data validation component 110. The data validation component 110 can be configured to ensure project and or portfolio data analyzed by the system is consistent in both format and quality across various projects and portfolios. The data validation component 110 can be used in conjunction with a data import function and/or component that enables new project information to be imported to system 100. In some examples, data validation component 110 can also include data translation and/or data mapping functions that take as input any data format and apply transformations to output the consistent data format enforced by the data validation component 110.

According to one embodiment, the system 100 can include a portfolio manager component 112. In some settings, access to the portfolio manager component 112 can be limited to portfolio administrators and/or other authorized users. For example, portfolio administrators can be responsible for defining portfolios and the grouping of projects that go into a respective portfolio. The administrators can access the portfolio manager component to define groups of projects into a portfolio and also select data templates that will apply to the portfolio and/or projects. In some examples, data templates define a set of core data elements that can be used to analyze any project or portfolio. The data templates can also define associated metrics or analytics that can be used to evaluate, with consistency, respective projects or portfolios within and across one another.

According to some embodiments, portfolio definition includes identifying a group of projects, identifying data templates to apply, and/or customization of data sets to be used with the respective project or portfolio. According to some embodiments, users can customize data to include and analytics to apply. The system can resolve any conflicts in the data templates, and leverage the new data into current analytics. Once the conflicts are resolved or if no conflicts result, customized data and analytics can be integrated into the standardized views (e.g. 151 through 161). In some examples, the additional customizations can include additional visualization elements to render the new or custom data.

In some embodiments, the templates may be preconfigured arrangements of fields, each of which is linked to one or more database fields (e.g., columns). When the user initiates a request for a report, the system may retrieve the fields related to that specific record or set of record (e.g., rows) and populate the relevant fields into the template. The populated template is then made available to the user (e.g., as an email attachment, or as a file available for download on a website). In some embodiments, the system may perform calculations on one or more database fields to populate one of the template fields (e.g., a status indicator and/or a progress bar).

In some embodiments, the standardized data sets and analytics enable views and functionality on the system. For example, portfolio tile displays show dynamic real-time data, and include an associated detailed view or set of views linked to each tile. Further the project grid view (which can be part of a project display 153) can also display dynamic real-time data and incorporate event driven updates to the same.

In further embodiments, system 100 can be extended with additional components or the system can include different components, and may include additional functionality. Shown in FIG. 1B is an example system 450 with some common components (e.g., with respect to system 100 labelled similarly). As depicted, system 450 includes additional components. In some embodiments, the new components can be instantiated as alternatives to the architecture of system 100.

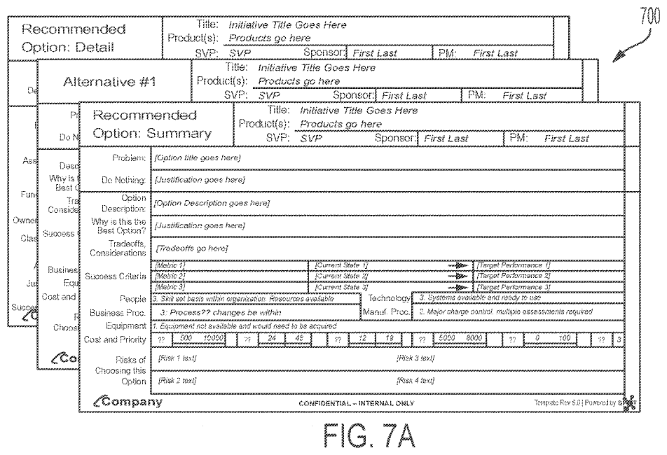

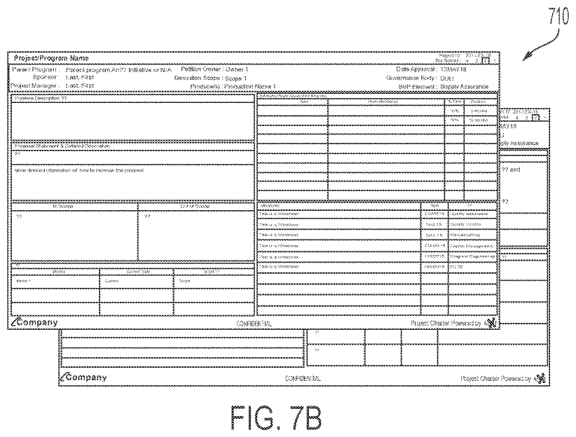

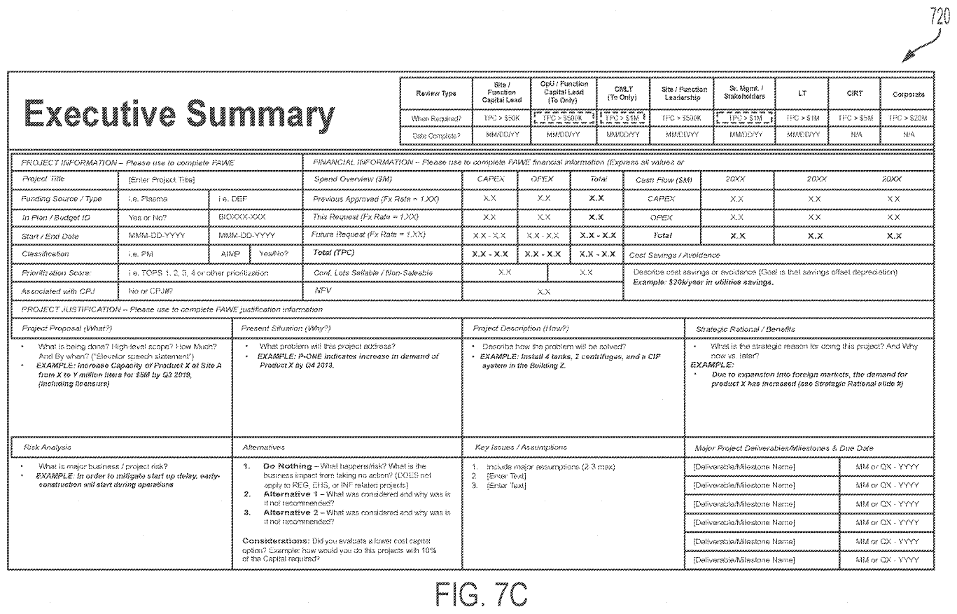

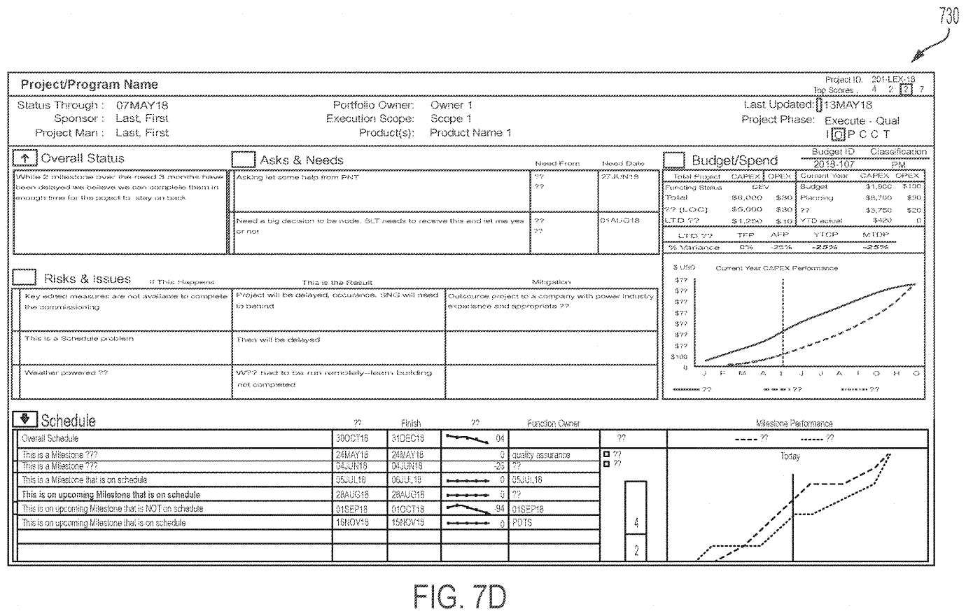

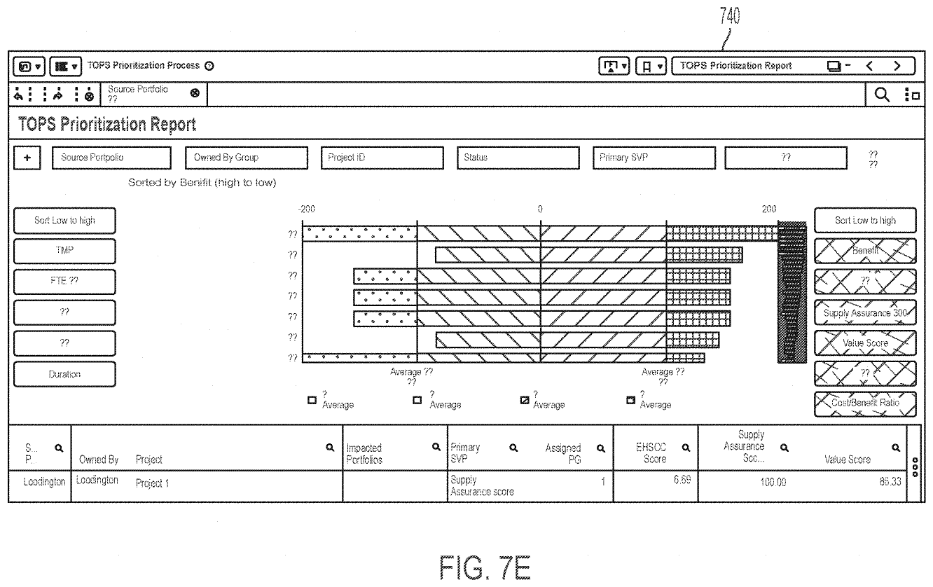

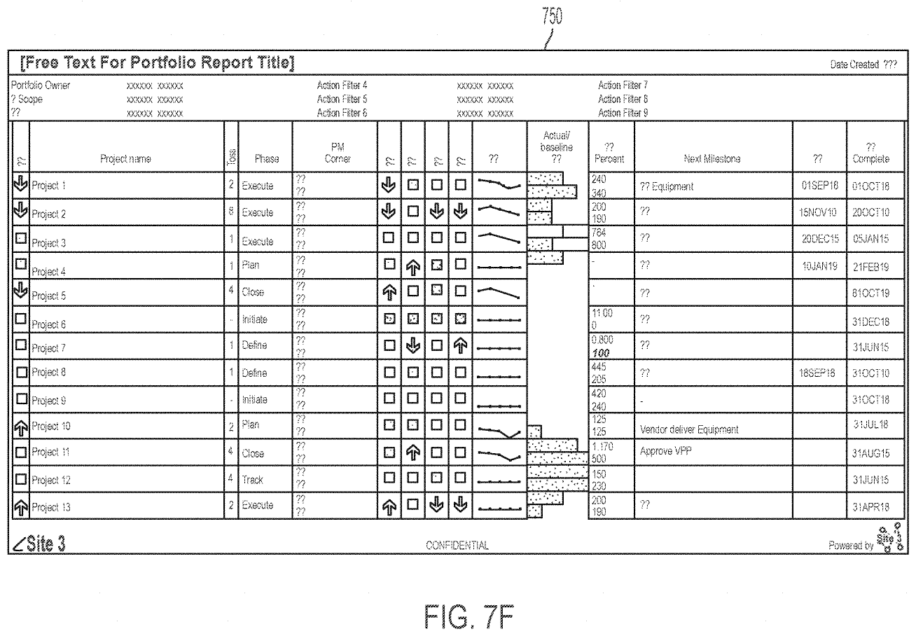

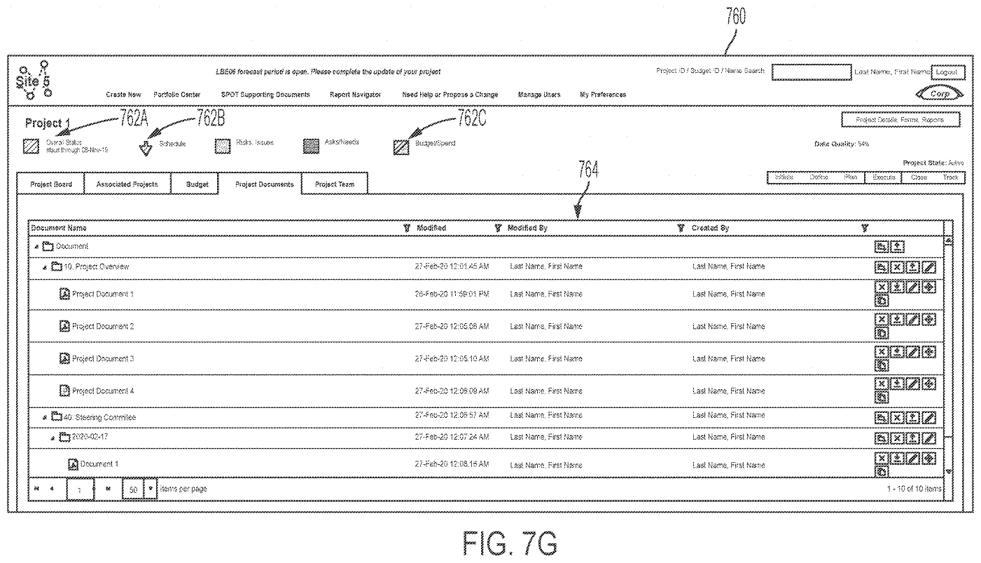

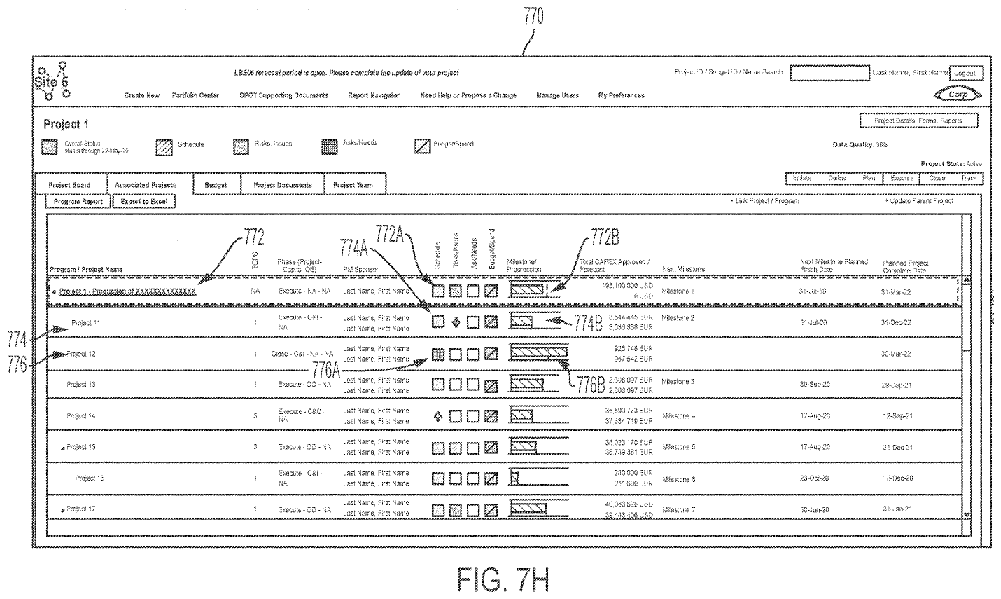

In some embodiments, system 450 can include a report generation component 456 configured to build reports on portfolios, projects, and/or and filter data a user has selected. The system can generate a variety of reports. Some examples of such reports are discussed below with respect to FIGS. 7A-F, 20-21, and 24-25. Reports may be formatted for public data export, which can include operations performed to prepare data for public access. For example, a public data export 458 can be based on an output after executing scrubbing operations to remove sensitive date (e.g., personally identifying information, trade secret information, project details, personnel details, etc.) prior to being made public.

In some embodiments, a portfolio management system 405 can include a project manager component. The project manager component is configured to enable operations and access for individual projects stored on the system. The project level operations can include access restrictions/definitions, as well more granular data control (e.g., additional access restriction and/or generic aggregated data access specification, among other options). In some embodiments, the system can enable data mapping functions to be defined on an individual project level (e.g., through a project manager component 452). In further embodiments, the project manager component can be a sub-component of, operate in conjunction with a portfolio manager component (e.g., 122), or can a stand-alone component.

According to one embodiment, system 450 can also include a master/meta data component 454. Is some embodiments, the master data component 454 is configured to host a standardized repository for the project data being analyzed/presented on the system. In various embodiments, data validation component can communicate validated (e.g., translated, mapped, etc.) data for use on the system. The master/meta data component 454 can also be configured to manage and store meta data on the respective projects and/or portfolios. In further embodiments, the master/meta data component can be configured to manage data access and/or retrieval from external systems and/or applications. In some embodiments, a portfolio may be configured based on user-configured metadata. For example, the metadata may specify location, function (e.g., engineering), business unit (e.g., biological), or specific term associated with a project. In some embodiments, a portfolio may be stored as links between data tables of a database. The links may be updated in response to user actions in a user interface. For example, the data component 454 may generate new links in response to a user action to create a new portfolio. In another example, the data component 454 may add a new link to a portfolio definition in response to a user action to add a project to a portfolio. In another example, the data component 454 may remove a link in response to a user action to remove a project from a portfolio.

For example, the system may also include a data interface component 460 configures to manage interaction with external applications 462 (e.g., access control, data formatting, permissions, etc.). In some embodiments, system, 450 can interact with external application that provide business intelligence tools, as well as other external applications.

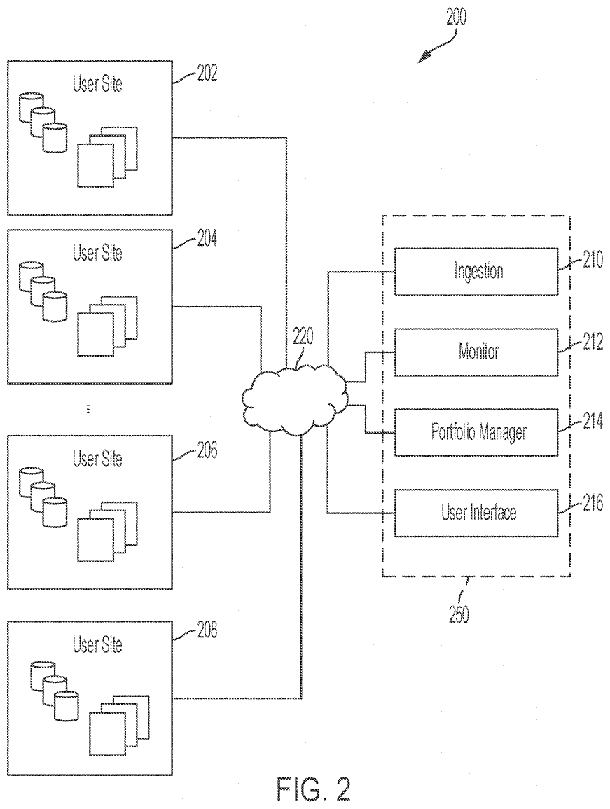

Shown in FIG. 2 is a block diagram of an example environment in which a portfolio management system operates. According to some embodiments, a plurality of user sites (e.g., 202-208) can access the system over a communication network 220. According to one embodiment, a portfolio management system 250 can be implemented as a cloud-based service. In some examples, the cloud-based service can be made up of a number of cloud services that perform specialized functions. In other examples, there does not need to be a separation between the various components and the system 250 can perform any of the functions disclosed.

According to one embodiment, system 250 includes an ingestion component 210. The ingestion component can be configured to accept project data in any format from the various user sites and process the input data into a standardized format for use on the system 250. In some embodiments, the ingestion component is configured to transform and/or map input data into the standardized format.

The ingestion component 212 can work in conjunction with a monitor component to 212. The monitor component 212 can be configured to monitor the various user sites and any changes in project information, data sources, or administrative information that may be relevant to managing projects and portfolios. The monitor component 212 can include associated processes at the user sites, and the monitor component can pull or receive updates via push from respective processes.

In further embodiments, system 250 can include a portfolio manager component 214. The portfolio manager component 214 can be configured to allow users from the user sites to access the system and define the projects and/or portfolios to be managed by the system 250. For example, portfolio administrators can define what groups of projects belong to what portfolios and select data templates and associated analytics that will be used to manage those portfolios. In further example, portfolio administrators can also define extensions beyond selected templates. In one example, portfolio administrators can extend the standardized data set to include additional information relevant to respective projects and/or portfolios.

According to some embodiments, the system 250 can include standardized user interfaces to facilitate such operations. For example, the system 250 can include a user interface component 216. The user interface component can be configured to generate a variety of displays (e.g., priority display, integrated status displaying, project display, portfolio display, event display, filter interface display, among other options). In some embodiments, the user interface component can be configured to generate status indicators for respective portfolio(s) and/or project(s). In some examples, system 250 includes a variety of configuration displays that enable portfolio administrators to define the details of the projects to be managed, the portfolio groupings for those projects, any custom data needed, any custom analytics needed, and select any template applicable.

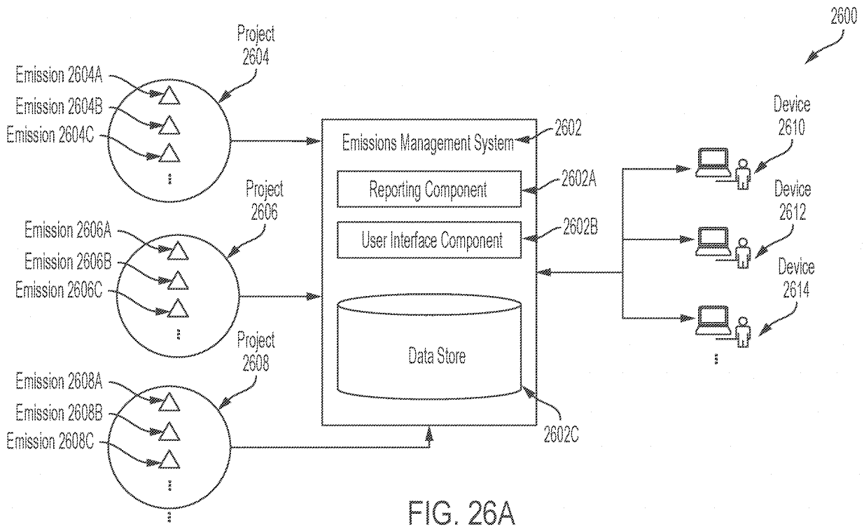

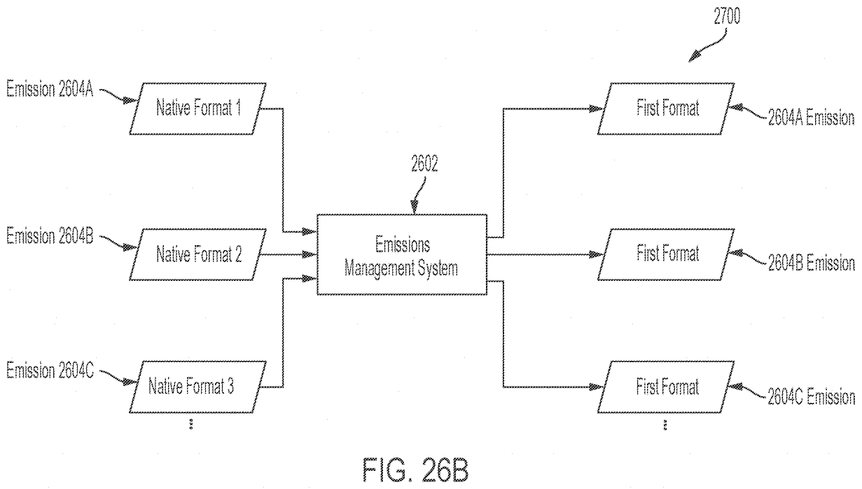

According to some embodiments, the execution engine 102 and/or the system 450 can be configured to include an emissions management system as a component of the execution engine 102. In some embodiments, the execution engine 102 can be configured to include emissions management system 2602 discussed herein with reference to FIGS. 26A-B. Example embodiments of the emissions management system are discussed herein with reference to FIGS. 26A-35.

FIG. 2 focuses on operations for bringing project data under management of system 250 for the purposes of clarity. In other embodiments system 250 can include any of the components described with respect to FIG. 1. In some embodiments, the system 250 may perform any of the operations, functions, processes, etc. discussed with respect to FIG. 1 and any function described with respect to any embodiments of a portfolio management system discussed herein.

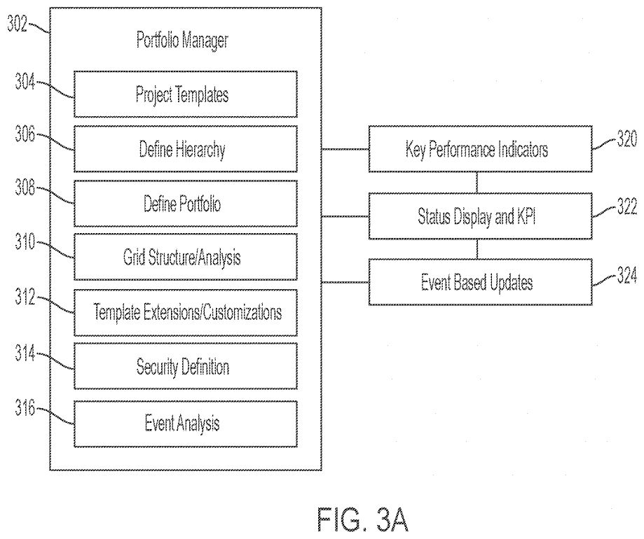

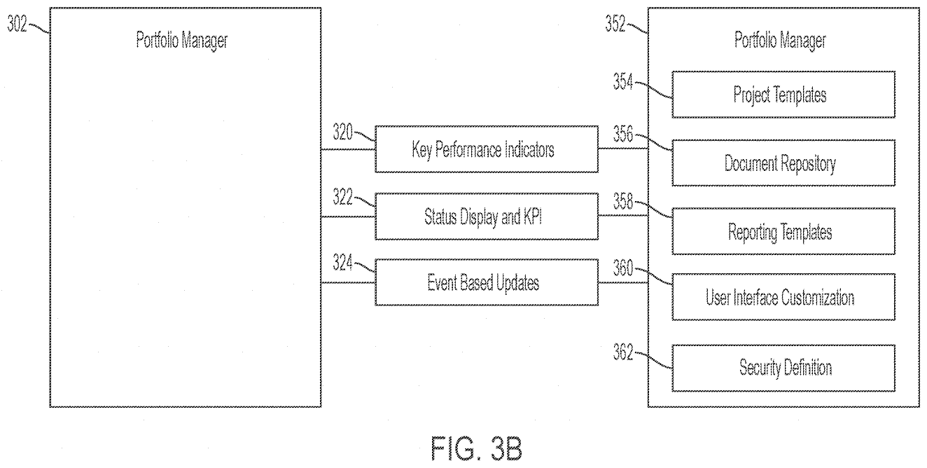

Shown in FIG. 3A is a block diagram of a portfolio manager component according to one embodiment. The portfolio manager component 302 can include the functionality discussed above with respect to portfolio manager 214 of FIG. 2. In addition, the portfolio manager component can also be configured to manage user interaction with project/portfolio management data, analytics, and associated views.

According to one embodiment portfolio manager component 302 provides access to defined project templates 304. The project templates define sets of data that are to be used in monitoring the performance of respective projects. The project templates are defined to be usable together, such that selection of multiple templates extends the sets of data used, analyzed, and/or monitored with respective projects. In further embodiments, the system maintains the templates to ensure no conflict results from the selection of multiple templates. In some examples, the system can enforce data formatting and analytic definition rules to ensure that the templates are usable together without conflict. In other embodiments, the system can identify and resolve conflicts between various templates (e.g., eliminate redundant analysis, data, metrics, update data sets to support analysis, etc.).

According to some embodiments, the portfolio manager 302 establishes a defined hierarchy 306 for managing respective projects. In some examples, an end user (e.g., a portfolio administrator) can access the portfolio manager to define their own hierarchy of projects to be contained within a portfolio. For example, the portfolio manager is configured to accept portfolio definition criteria (e.g. at 308). In some examples, the portfolio manager can provide a preview of the grid structure/analysis that will be the end result of the portfolio and template definition. According to one embodiment, the portfolio manager allows an end user to access and leverage a consistent baseline grid view for management of selected projects. Projects collected and organized in this way may also be referred to as a program, and a portfolio can consist of any user-defined combination of projects and programs.

According to some embodiments, the system enables users to connect individual projects together into a tree structure. In some examples, the tree structure can be used to define a management program. For example, programs can be modular and self-referential. According to one embodiment, programs can be included as substructures within a larger program. Various subprograms can be managed as a larger collective via the system. In some examples, the project referenced within the tree structure can be incorporated for display in the user interface, and analytical calculations applicable to the program can also be displayed. An example of a tree structure connecting associated projects is shown in FIG. 7H discussed herein.

In further embodiments, status indicators can be displayed with respect to information on any program. In one example, a milestone managed within a project may turn red responsive to updated information. The change to red indicates that a milestone may not be met on a defined schedule, or is at risk of not being completed according to the schedule. According to some embodiments, programs are interconnected, and the change of the status indicator in one program can be reflected in any linked program's display. For example, the change in indicator to red in one project can be reflected in any calculations utilizing that milestone and/or status within the given program.

According to some embodiments, the program interface can display information on respective projects and/or individual information elements of projects built into a program. In further embodiments, the program interface can display information on linked and non-linked status for individual elements. Once linked, the project information elements can be considered and/or analyzed by the system during subsequent status displays, analytics, assessment of schedule, among other options. In one example, milestone status can be linked to an overall schedule status and any change in the status of a linked milestone can be reflected in an indicator of the overall schedule status.

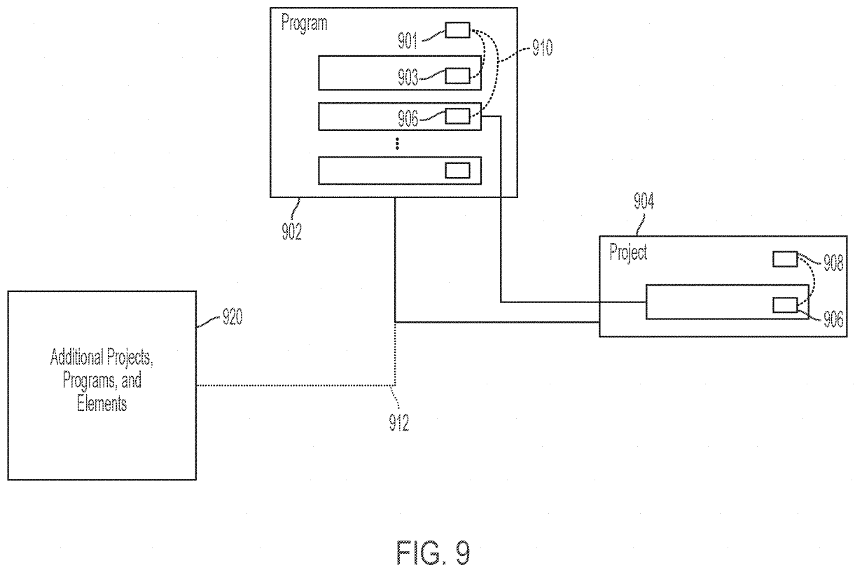

Shown in FIG. 9 is a logical block diagram illustrating system capability for defining linked status indicators (e.g., 901) within programs. For example, at 902 a user can define a program including multiple projects (e.g., 904) and/or information elements (e.g. 920) within projects.

For example, the system can enable users to define links between status indicators (e.g. 901, 903, 906) illustrated by the dashed lines at 910. For incorporated projects (e.g. 904), the system can define links between project status indicators (e.g. 908) and individual elements (e.g. 906 (which can be a milestone for project 904)) of the respective project. In further embodiments, additional projects programs and/or information elements (e.g. 920) can be included in any program. The system can be configured to allow linkage between any status indicator defined in the constituent elements in the status indicator for the defined program. According to various aspects, the program architecture enables the system to be highly flexible in defining management targets and in creating status displays that can be linked, for example, to other programs, to other projects, and any information element within either. The flexibility provided by the program architecture is not available in many conventional approaches.

In some embodiments, the system provides a grid structure view (e.g. 310) made up of key performance indicators (e.g. 320), and provides a real-time status display for those key performance indicators (e.g. 322). In further embodiments, the grid view is updated in real time and/or updated responsive to the detection of events (e.g. 324).

As discussed above, the system enables end users to extend the data being viewed and analyzed. In one embodiment, the portfolio manager 302 is configured to enable template extensions and/or selection of customized data (e.g. 312). In further embodiments, the customized selections can be incorporated into, for example a grid view, and/or status displays of key performance indicators.

The portfolio manager 302 can also be configured to establish security definitions for projects and/or portfolios managed on the system. In one example, the security definition component 314 is configured to establish access permissions to specific projects, portfolios, and can be used to define access permissions to specific analytics shown in the various views.

In further embodiments, the portfolio manager 302 can also be configured to identify events on which to trigger updates. For example, the portfolio manager 302 can include an event analysis component 316. The event analysis component can detect defined events and trigger associated actions responsive to identification, or be configured to execute actions according to a defined schedule (the first Thursday of the Month) or frequency (once per day).

Shown in FIG. 3B is a block diagram of a portfolio manager component according to one embodiment. The portfolio manager component (e.g., 302) can include the functionality discussed above with respect to portfolio manager 214 of FIG. 2 or 112 of FIG. 1A or 1B. In addition, the portfolio manager component can also be configured to manage user interaction with project management data, analytics, and associated views.

In further embodiments, the portfolio manager component can work in conjunction with the project manager component 352. The project manager component can enable operations on a more granular level and for example with respect to individual projects. According to one embodiment, each project can be associated with respective templates. And in further example, the user can define templates (e.g., 354) in association with specific projects. In some embodiments, the project manager component 352 can be configured to maintain and/or manage a document repository 356 including the data for respective projects. In further embodiments, the project manager component 352 enables users to define reporting templates 358. For example, the reporting templates 358 can include selection of metrics, analytics, displays, reporting elements, and/or other information items to automatically include in a given report. In other examples, users may customize reporting templates by adding additional data, analytics, display elements, etc.

In some embodiments, users may define customizations for user interface displays (e.g., 360). The custom displays can include structural and organizational information, specific data and/or analytics to include, as well as comparative information from other projects and/or portfolios, among other examples.

According to another embodiment, the system can include a security definition component 262. In various examples, the security definition component 362 can be part of the project manager component 352. The security definition component 362 can be configured to accept access control parameters and/or definitions. According to one embodiment, the security definition component enables users to defined access rights/permissions on a project by project basis. Other embodiment enable further security definition on a portfolio basis as well as user by user.

According to some embodiments, the portfolio manager component can operate in conjunction with the project manager component 352 to provide information on and/or define key performance indicators. The key performance indicators can be incorporated into status displays and/or customized user interface displays. Further, the information in any display can be updated based on event triggers. For example, a portfolio manager component and/or project manager component can monitor and/or receive event-based triggers and associated data to update respective displays. In some embodiments, the portfolio manager component and/or the project manager component can be configured to update a status indicator in response to an event-based trigger. For example, the component may modify a bar representing a milestone progression of a project and/or portfolio. In another example, the component may modify a color of a status indicator responsive to the event-based trigger. In another example, the component may modify a direction of an arrow of the indicator displayed. Example status indicators are discussed herein.

According to some embodiments, portfolio manager component and project manager component can work in conjunction, and can also be configured to work separately, and/or in the alternative. FIGS. 3A and 3B provide example embodiments and respective example architecture. In other embodiments, different components can be instantiated on the system and or different architectures can be implemented.

Example User Interfaces

Stated broadly various embodiments of the system can be configured to display any combination of data elements and/or calculations made from the combination or transformation of data elements of respective projects. In some implementations, the system can include a standardized repository of project data that the system references to display data or perform transformations for further display. The following example user interfaces are provided to illustrate some examples of displays available to users and/or customizations available to users of the system.

FIG. 4 is an example screen capture showing a portfolio management view according to one embodiment. The portfolio management view provides visualization of project data where respective projects have been organized into a portfolio. At the bottom of FIG. 4 is shown a grid view 402 of projects making up a portfolio. The grid view includes a set of key performance indicators on which the respective projects are evaluated. For example, the key performance indicators can include an overall status (e.g., reflective of the overall state of a project) and schedule indicator (e.g. reflective of whether a project is meeting a defined schedule). Another indicator can include information on risks, issues, and safety concerns for the project. Further indicators can include ask/needs which provide a visual indication of additional material resources and/or information that may be necessary in order to complete a project. As shown in the example embodiment FIG. 4, the grid view 402 includes an overall status indicator 402C for a first project and an overall status indicator 402D for a second project. A color of the indicator may indicate the overall status of a respective project. For example, a green color may indicate that the portfolio and/or project is meeting goals (e.g., there are not delays, safety concerns, and/or budget concerns) while a red color may indicate there are concerns in delays, safety concerns, and/or budget concerns in the project. As another example, the grid view 402 includes a schedule performance indicator 402E for a first project and a schedule performance indicator 402F for a second project. In some embodiments, the indicator may have a color that provides a visual indication of a status of the project and/or portfolio. In some embodiments, the indicator may include an arrow indicating an expected or predicted future state of the project and/or portfolio.

Another key performance indicator can include budget/spend in the grid view, which can include a visualization of how well the project is meeting its desired budget and cash flow compared to what has been spent. The grid view may include information about one or more projects of a portfolio including one or more visual status indicators for each of the project(s). Another key performance indicator can include a milestone progression indicator. In one example, this can include a bar graph showing a degree of completion of a specific project towards the next milestone. As shown in the example embodiment of FIG. 4, the grid view includes a milestone indicator 402A for a first project and a milestone indicator 402B for a second project. In the example of FIG. 4, the bar graph shows a horizontal bar indicating the progress of the project towards a milestone represented by a vertical line. Accordingly, some embodiments provide large amounts of information in a single user interface display element (e.g., in a row of the grid view 402). Further embodiments may include an approved capital expense (CAPEX) versus a forecast capital expense.

As shown in the example embodiment of FIG. 4, the user interface screen 400 includes a filtering section. In some embodiments, the system can be configured to receive user specified filter options and generate the grid view 402 according to the received filter options. For example, as shown in FIG. 4, the user may specify values for a portfolio owner filter 404A, a state filter 404B, and a capital expenditure (CAPEX) filter 404C. In some embodiments, the user interface 400 can be configured to provide a pre-populated list of options for a user to select from to specify values for one or more filters. In some embodiments, the user interface 400 can be configured to provide a searchable set of options for a user to specify values for the filter(s). In some embodiments, the system can be configured to provide a filter for portfolio owner, execution scope, product, CAPEX, project type, people, phase, state, and/or classification.

In further embodiments, the grid view can include information on a next milestone as well as a planned finish date for the next milestone and/or any planned project completion date. According to some embodiments, the portfolio management view can include display titles which are configured to be shown consistently across any portfolio in any collection projects. In one example, a display tile can be labeled priority and provide information (e.g., via visualizations) on an assigned priority or a system determined priority level. In one example, the system can be configured to determine a priority level based on intelligent algorithms and/or modeling performed on a given project against business rules defined on the system.

According to some embodiments, additional data display tiles can be shown. For example, a phase display tile can be shown which provides a visual indication of what projects and/or tasks are in what project phase. In another example, the display tile can show a bar associated with a number of projects or tasks in the initiate phase, define phase, plan phase, execute phase, closed phase, and/or track phase, among other options.

According to one embodiment, a display tile can include a milestone performance display tile. The milestone performance display tile can detail information on the percentage of projects and/or tasks completed on time, or that are expected to complete on time (past and future). The milestone performance tile can also display information on how many projects and/or tasks are on time within the last 30 days, a percentage of projects and/or tasks predicted to be on time in the next 30 days, and a percentage for current year completion rate, among other options.

According to some embodiments, additional tiles can include a budget spend tile. The budget spend tile can detail information on current year budget, planned costs, forecast costs and year to date actual costs. In another embodiment, additional display tiles can include next three months and last three months. These tiles can show information on milestones coming due, projects completing, risks issues due, and ask needs that are due. These tiles can also show information on milestones completed, projects and finished, projects initiated, projects completed, projects put on hold, among other options.

The portfolio management view can also provide additional functionality to facilitate drilling into the information available. For example, this system can provide access to filter templates that allow users to build queries and visualize data easily and effectively. In one example, the filter criteria can include portfolio owner, people, execution scope, phase, product, state, total Acts, classification, OE project type, among other options. The visualized information can also be exported to a static report in a variety of formats including, for example, into a spreadsheet or static presentation.

According to some embodiments, the interface shown in FIG. 4 enables additional functionality to facilitate portfolio management. For example, the user interface enables users to target any aggregated set of records, which can drive the summary calculations presented. In some examples, the system accesses the metadata defined for the records in the database to provide filter options to the user in the display.

In another example, multiple project types are made available on the system. The various project types can provide different combinations of fields for display within the user interface. According to one embodiment, a project type can be specified at creation which provides a baseline set of datatypes to be displayed. The project type can be changed after creation resulting in different displays and data sets. In one example, users can access the interface of FIG. 4 to create new projects and define project types with associated data displays. Also shown in FIG. 4 are options to produce a portfolio report and export to excel. These options enable users to generate raw data exports and generate user-defined templatized reports on demand.

Returning to the grid view display shown in FIG. 4, status indicators can be provided at the beginning of each row to provide information on the recency or freshness of the data being displayed. For example, up-to-date or recent data can be displayed without an indicator, and older data (e.g., greater than 30 days) can be displayed with a gray and/or colored bar at the beginning of a row. Within each row of the display, detailed project records can be accessed directly via system executable mappings.

According to some embodiments, status indicators displayed within the grid view are calculated uniformly for all records within a portfolio/program. For example the system can access business rules to evaluate what status indicator should be displayed. In some embodiments, the business rules that support the calculations are configurable. In various examples, the indicator can communicate status for more than one calculation (e.g. budget/spend).

According to some embodiments, the columns displayed in the grid view can be associated with database fields. The database fields can be configurable, filterable, and sortable. In further embodiments, the interface includes an option to show local attributes (e.g. “include local attributes”). For example, a user can select include local attributes to identify additional metadata fields that are part of a single project, portfolio, combination of projects, combination of portfolios, etc., available in the system database that can be displayed and/or manipulated.

In further embodiments, the display tiles and summary information can provide direct links to the data underlying the summary information. The summary information can be based on summary calculations specific to a subset of the portfolio, an entire portfolio, multiple portfolios, or the entire set of portfolios stored within the database. In various examples, the summary information is generated in real time by the system and any updates are reflected in the display tiles.

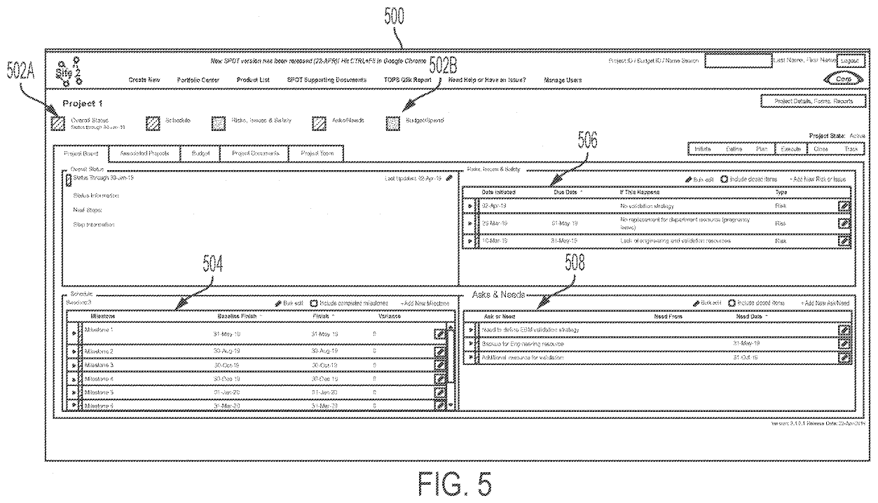

According to some embodiments, the system can display information on the current user (e.g. “Doe, John”). In further embodiments, the system includes a user profile that defines features and data that the identified user can access or has permission to view, manipulate, or customize. FIG. 5 is an example screen capture 500 showing a project management view. In the project management view, users can access information on the project board, planning, next steps, among other options. Information on the associated projects budget, project documents, and project team are available via tabs in the display among other options. For each project visualized in the project management view, status indicators are also displayed, where green indicates a project in good status, red indicates a project that is failing to meet its goals, and yellow indicates a project at risk of not meeting its goals. The system can be configured such that the calculations that determine the state of the indicator can be pre-defined and applied automatically to one or more portfolios, or set manually by a user.

As shown in the example embodiment of FIG. 5, the user interface screen 500 of the project management view includes status indicators for an overall status of a project and status indicators for other aspects of the project. For example, the user interface screen 500 includes an overall status indicator 502A for the project and a budget/spending status indicator 502B for the project. A green color of the overall status indicator 502A indicates that the project is meeting its goals, while the red color of the budget/spending indicator 502B indicates that the project is failing to meet goals in budget/spending. The user interface screen 500 includes multiple sections for different aspects of the project. For example, the user interface screen 500 includes a schedule section 504 displaying milestone(s) of schedule. The schedule section 504 may include milestone names, baseline (e.g., target) finish dates, and actual finish dates. The schedule section 504 includes a status indicator (e.g., a color indicator) for each milestone. As another example, the user interface screen 500 includes a risk, issues, and safety section 506. The risk, issues, and safety section 506 includes a date of initialization, due date, response strategy, and categorization of type for each item. The section 506 further includes a status indicator (e.g., a color indicator) for each item. As another example, the user interface screen 500 includes an asks and needs section 508. The ask and needs section 508 includes a listing of asks or needs, from what the ask or need is from, and a need date. The ask or need section 508 includes a status indicator (e.g., a color indicator) for each item.

According to one embodiment, the project management view includes information on the current schedule for the project. For items contained in a schedule (e.g. milestones), a display provides information on a baseline finish date versus an actual finish date and provides information on the variance between the two. Within the view the display tile provides information on risks, issues, and safety for a given project. In one example, elements within the risk, issues, and safety window can provide information on a date initiated, a due date (for example for resolution), and potential consequences should a risk be realized. In further embodiments the risk, issue, safety window provides information on the type of issue that is being presented (e.g. risk). The project management view can also include an asks and needs display tile. The asks and needs display tile can include information on specific requests and the status for those requests (e.g. need from, the date needed, among other options).

In various embodiments, the system automatically calculates project key performance indicators based on predefined business rules. Any project deliverables and lifecycle management can be easily modified and managed in the project management view. In a further example, the project management view provides easily understood information on status, risks, milestones, and asks. The integrated display enables administrators or project managers to introduce project updates into a variety of projects and milestones in as little as five minutes per reporting cycle—this represents a significant improvement over conventional approaches which take significantly longer periods of time to introduce and reflect updates for project management, and struggle to provide a consistent analytical and anecdotal representation of the current state of individual projects or portfolios.

According to some embodiments, the user interface shown in FIG. 5 also provides access to input forms and user-defined reports. For example, the user can select an interface element to transition to templatized forms and any user-defined reports (e.g., “project details, forms, reports”). In further embodiments, the interface provides a variety of status indicators to reflect the current status of the respective project. For example, individual data elements can be displayed with status indicators. In one example, summary indications are set based on user defined relationships between the individual data element, user defined business rules, and the display indicators. The various indicators can be shown at an upper portion of the display, where green indicates on schedule or meeting the defined relationship and red indicates at risk of missing schedule or not meeting the user-defined relationship. Example indicators are shown at the top of the display and include, for example, “overall status”, “schedule”, “risk, issues and safety”, “asks/needs”, and “budget/spend”, among other options.

In further embodiments, each summary indicator can be presented with a detailed grid view (e.g., risks, issues and safety, schedule, asks and needs, etc.). For example, individual data elements that form part of the summary status indicator can be shown as rows of a display. Each row can include an individual status indicator the provide information as to which data element is responsible for the current visualization of a status indicator (e.g. risks, issues and safety being read).

According to some embodiments, the underlying data, record access, available data elements, and available metadata are determined by the system based on a combination of record type, user privileges, and record configurations set on the system. In one example, tabs within the project displaying provide access to additional information, underlying data, and associated metadata based on the available information.

According to one embodiment, the user interface shown in FIG. 5 includes multiple user interface elements configured to provide access to multiple views of the associated information and interfaces for editing data within a record. The interface may also provide options for editing multiple data elements simultaneously. Some example interface elements for providing editing functionality include “bulk edit”, “add new milestone”, and a drop-down indicator displayed at the beginning of a detailed information row. Another example element includes an edit icon displayed at the end of a row. Other options can be used to provide access to edit data elements.

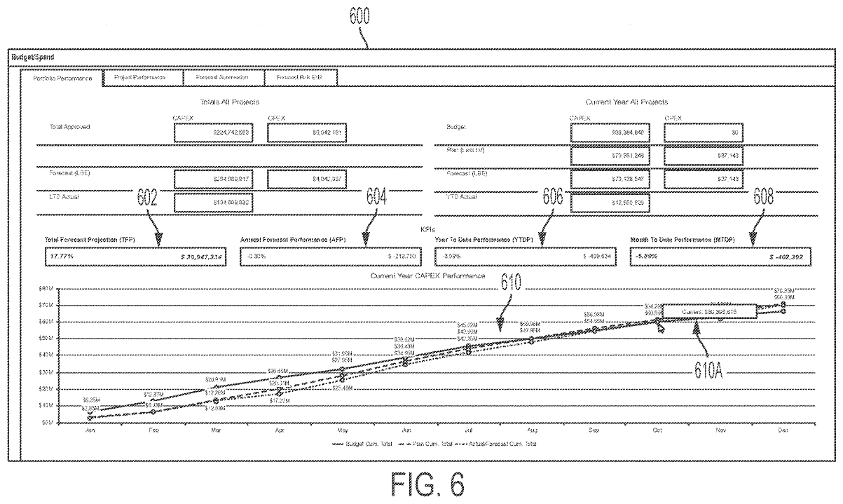

FIG. 6 is an example screen capture 600 showing a capital budget analytics view. In the budget analytics view, performance can be assessed for a complete portfolio and for individual projects within that portfolio. For example, the view includes a tab for navigating to a project grid view reflecting information on individual projects within a portfolio. In various embodiments key performance indicators are calculated in real time based on predefined business rules and visualized in the capital budget analytics view. The analytic view includes information on trends that are constructed by accessing historical data records in the database.

As shown in the example embodiment of FIG. 6, the user interface screen 600 includes indicators for various parameters of the portfolio. User interface screen 600 includes a total forecast projection (TFP) indicator 602, an annual forecast performance (AFP) 604, a year to date performance (YTDP) 606, and a month to date performance (MTDP) 608. Each one of the indicators 602-606 comprises a colored number. In some embodiments, the number may be a unit of measure for the parameter and the color may indicate a status of the indicator (e.g., relative to a target value). For example, a green color may indicate that the value is in an acceptable range while a red color may indicate that the value is outside of an acceptable value. As shown in FIG. 6, the user interface screen 600 includes a plot 610 of parameters over a period of time. The plot 610 shows a line for each of the following: cumulative total for budget, planned cumulative total, and actual/forecasted cumulative amount vs. time. In some embodiments, the user interface screen 600 can be configured to display an amount for each point of the line. For example, as shown in FIG. 6, a use may hover a mouse over a point and the user interface screen 600 may display a value 610A of the point.

FIGS. 7A-7F illustrated captures of example reports that can be generated by the portfolio management system. For example, FIG. 7A shows an interface 700 for defining options responsive to detected events and/or risk events occurring. The system permits users to define recommended options alternatives and provide summary information on recommendations. FIG. 7B illustrates a project charter report 710 that provides information on related programs, sponsors, project managers, portfolio owner, execution scope among other options. In another example, FIG. 7C shows an executive summary report 720 for a project. In another example, FIG. 7D shows a status report 730 for a portfolio and/or project. FIG. 7E illustrates an example report for prioritization 740. The prioritization report 740 can provide information on specific projects and or milestones in their alignment with business value and strategic goals. FIG. 7F illustrates an example report 750 that can be customized by an end-user to include status information on a respective portfolio, project, or milestone, among other options.

FIG. 7G is an example screen capture of a project documents view 760. As shown in FIG. 7G, the project documents view 760 includes a plurality of status indicators for the project. For example, the project documents view 760 shows an overall status indicator 762A, a schedule status indicator 762B, and a budget/spend status indicator 762C. Other examples of status indicators are discussed herein. As shown in FIG. 7G, the project documents view 760 includes a display 764 for a tree structure of project documents. The tree structure includes a tree of folders and documents. A user may navigate the tree structure to access project documents (e.g., by downloading them). In some embodiments, the system can be configured to allow a user to download, delete, modify, and/or add documents in the tree structure.

FIG. 7H is an example screen capture of an associated projects view 770. As shown in FIG. 7H, the associated projects view 770 shows projects associated with a respective project 772. In the example of FIG. 7H, the project 772 has project 774 and project 776 associated with it. The view 770 includes status indicators 772A for the project 772 and status indicators 774A, 776A for respective associated projects 774, 776. The view 770 also includes a milestone/progression indicator 772B for the project 772, and milestone/progression indicators 774B, 776B for respective associated projects 774, 776. As shown in FIG. 7H, the view 770 may organize the associated projects into a tree structure. The view 770 may allow a user to navigate through the tree structure to view associated projects and respective status indicators.

FIG. 10 is an example screen capture of a portfolio view 1000, according to some embodiments. As shown in the example embodiment of FIG. 10, the portfolio view 1000 includes a grid view 1002 and a set of configurable filters 1004. The grid view 1002 includes status indicators for projects that are part of the portfolio being viewed. As shown in FIG. 10, the grid view 1002 includes an overall indicator for each project. For example, the first project has an associated overall indicator 1005. The indicator is an arrow pointing down, and is yellow. In some embodiments, the color and direction of the arrow may indicate a status. For example, a yellow color may indicate that the project is not meeting set goals. The downward facing arrow may indicate a prediction for the project. For example, the downward arrow may indicate that the project is not expected to meet overall status goals. The grid view 1002 includes status indicators for various aspects of each project. As shown in FIG. 10, the grid view 1002 status indicators for project schedule, risks/issues/safety, ask/needs, and budget/spend. For example, the grid view 1002 includes a schedule indicator 1006 for a second project. The schedule indicator is a red arrow facing downward. For example, the red color may indicate that the second project has not met schedule goals and the downward arrow may indicate a prediction that the second project is not expected to meet future schedule goals. As shown in FIG. 10, the grid view 1002 includes a milestone/progression indicator for each of the projects. For example, the first project has a milestone/progression indicator that includes a horizontal bar 1008A whose length indicates progress towards a milestone represented by a vertical line 1008B.

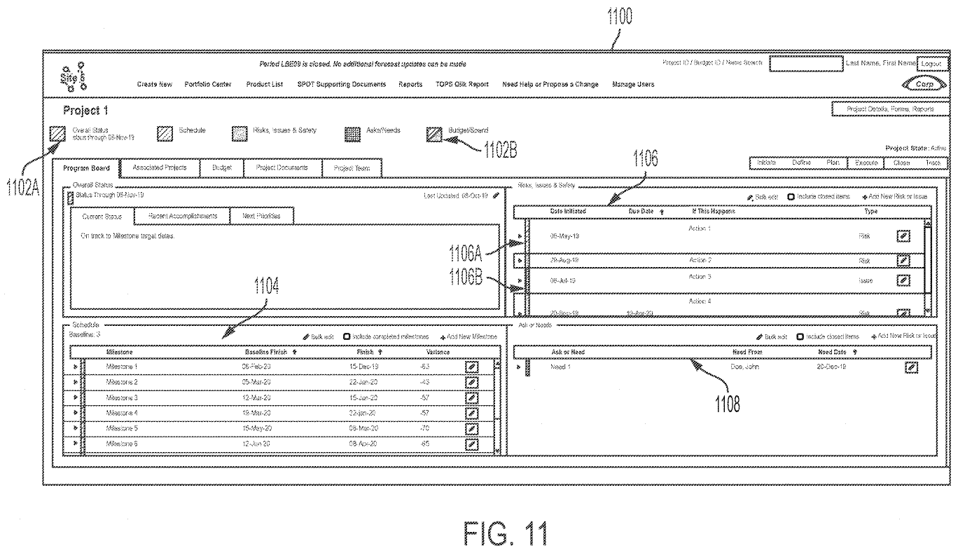

FIG. 11 is an example screen capture of a project dashboard 1100, according to some embodiments. As shown in FIG. 11, the project dashboard 1100 includes status indicators for a project. For example, the project dashboard 1100 includes an overall status indicator 1102A and a budget/spend indicator 1102B. As shown in the embodiment of FIG. 11, the indicator may have one or more colors. For example, the budget/spend indicator 1102B indicator is green and red. In some embodiments, the multiple colors may indicate that some items of the budget/spending are meeting set goals while others have failed to meet goals. The project dashboard 1100 includes sections for various aspects of the project. For example, the project dashboard 1100 includes a schedule section 1104, a risks/issues/safety section 1106, and a asks/needs section 1108. As shown in FIG. 11, each item in each of the sections may have an associated indicator. For example, in the risks/issues/safety section 1106, a first item has an associated status indicator 1106A and a second item has an associated status indicator 1106B. The status indicator 1106A associated with the first item is green indicating that the item is meeting goals, while the status indicator 1106B associated with the second item is yellow indicating that the item may be at risk of not meeting goals.

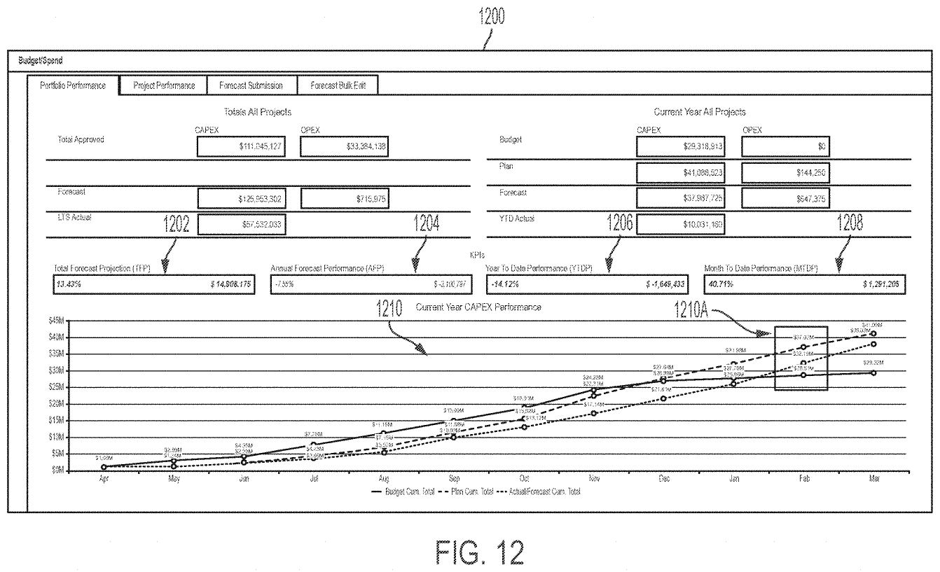

FIG. 12 is an example screen capture of a portfolio performance view 1200, according to some embodiments. The portfolio performance view 1200 includes displays values of various performance parameters. For example, as shown in FIG. 12, the portfolio performance view 1200 includes a display of total forecast project (TFP) 1202, annual forecast performance (AFP) 1204, year to date performance (YTDP) 1206, and month to date performance (MTDP) 1208. As shown in FIG. 12, the values may be colored to indicate whether the performance parameter has met a goal. The portfolio performance view 1200 includes a plot 1210 of parameters. The plot 1210 graphs a parameter with respect to time. In the example of FIG. 12, the plot includes a graph of CAPEX performance and includes a line for budget cumulative total, planned cumulative total, and actual/forecasted total. The graph may show values of each line at different points. For example, at the graph shows values for each line at the February point 1210A.

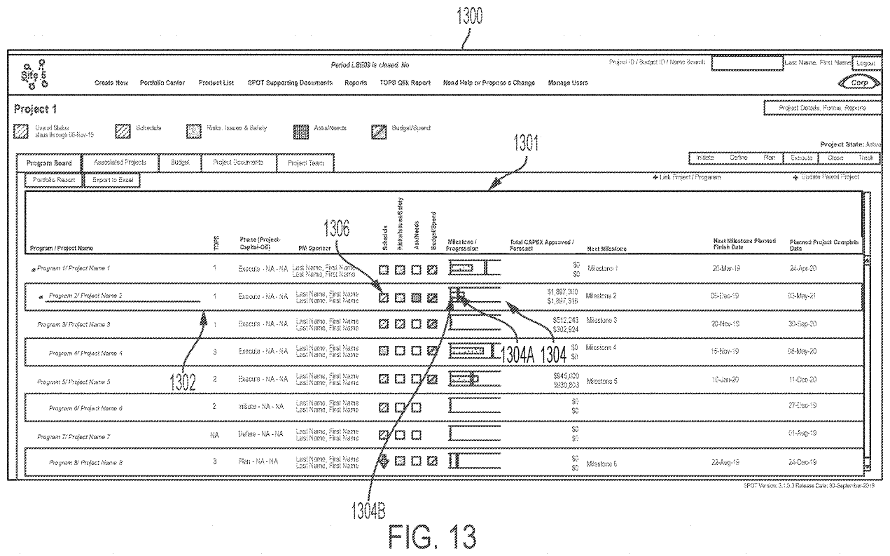

FIG. 13 is an example screen capture of an associated projects view 1300, according to some embodiments. The associated projects view 1300 displays one or more projects associated with a respective portfolio. In the example of FIG. 13, the associated projects view 1300 displays projects associated with the project named “Project 1.” The project view 1300 includes a grid view 1301 of the associated projects. The system can be configured to allow a user to select a project from the grid view 1300. For example, as shown in FIG. 13, project 1302 has been selected and highlighted to indicate its selection. The status indicators of a selected project may also be shown in the grid view 1301. For example, for selected project 1302, the associated row in the grid view 1301 includes status indicators 1306 (e.g., colors and/or arrows) for schedule, risks/issues/safety, asks/needs, and budget/spend. Example indicator operation is discussed herein. The selected project 1302 has an associated milestone/progression indicator 1304 including a horizontal bar 1304B indicative of progress, and a vertical line 1304A indicating a target.

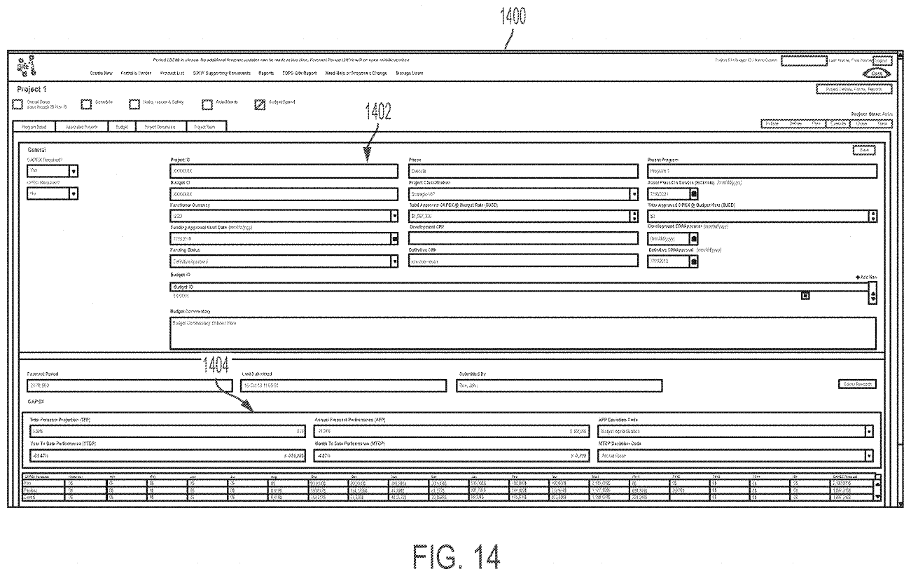

FIG. 14 is an example screen capture of a budget view 1400, according to some embodiments. The budget view 1400 includes various input fields 1402 allowing a user to enter and/or view information about a project budget. The budget view 1400 includes a CAPEX section 1404 displaying parameters indicating CAPEX for the project. As shown in FIG. 14, the parameter values may be colored to indicate whether they are good (e.g., whether they meet goals). For example, a green value may indicate that the value meets a goal while a red value may indicate that the value has not met a goal. In the example of FIG. 14, the CAPEX section 1404 includes a total forecast projection (TFP), a year to date performance (YTDP), an annual forecast performance (AFP), and a month to date performance (MTDP). Some embodiments may include displays of other parameters.

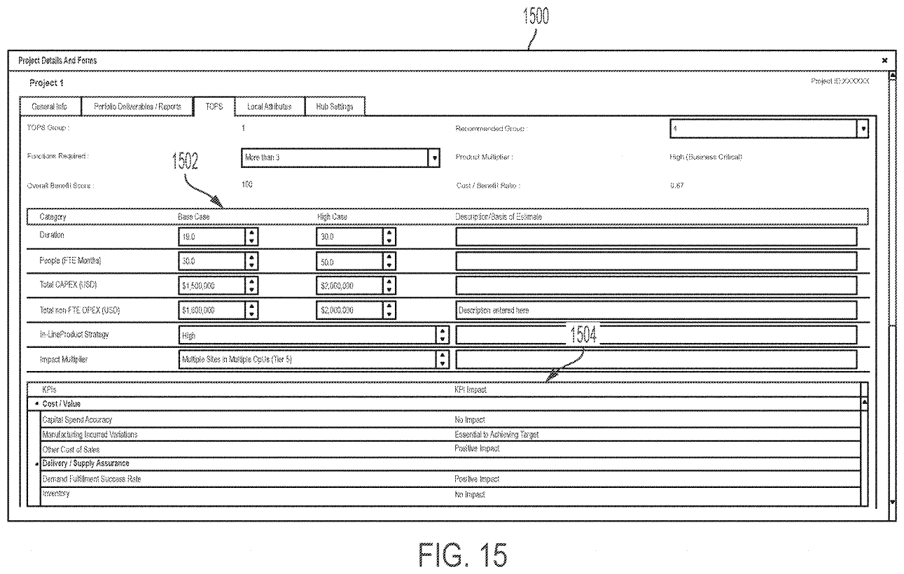

FIG. 15 is an example screen capture of project details and forms user interface 1500, according to some embodiments. The user interface 1500 can be configured to allow a user to specify information about a project. As shown in FIG. 15, the system may display information about a project in the user interface 1500. The user interface 1500 may include a section 1502 that allows a user to input one or more parameters for the project. For example, the section 1502 includes user inputs for estimates of project duration, people, and total CAPEX. The section 1502 includes input fields allowing users to input a description and/or basis of the estimates. The user interface 1500 includes a section 1504 showing impact of the project on key performance indicators (KPIs). For example, section 1504 shows impact of the project (e.g., no impact, essential to achieving target, or positive impact) on capital spend accuracy, manufacturing incurred variations, other cost of sales, demand fulfillment success rate, and inventory.

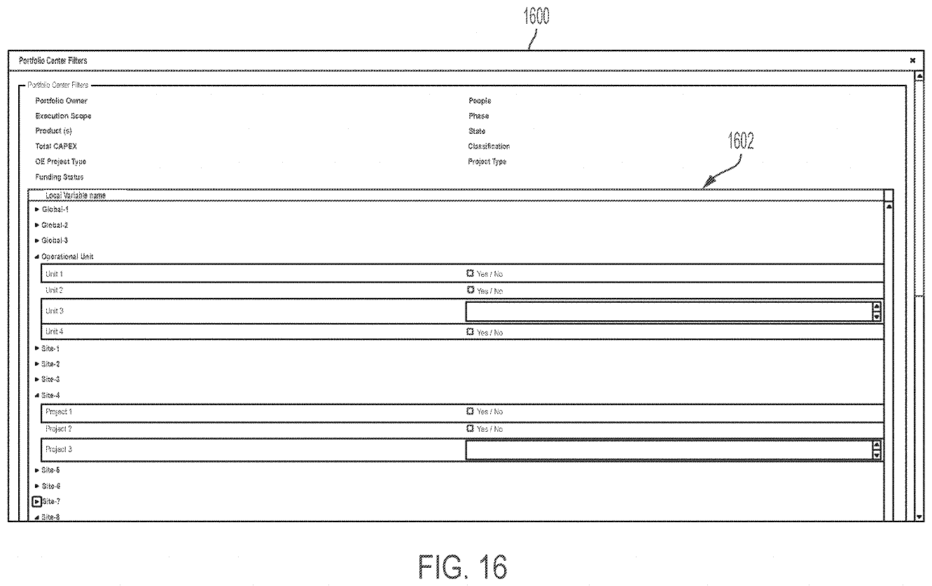

FIG. 16 is an example screen capture of a user interface 1600 for managing portfolio filters, according to some embodiments. The user interface 1600 shows information about one or more filters used (e.g., for generating a report). For example, as shown in FIG. 16, the user interface 1600 shows a portfolio owner, an execution scope, product(s), total CAPEX, OE project type, and funding status. The user interface 1600 includes a section 1602 for setting values of local variables of the filters. The user interface 1600 may allow a user to specify local variable values to filter information from within projects that are obtained from application of a portfolio filter.

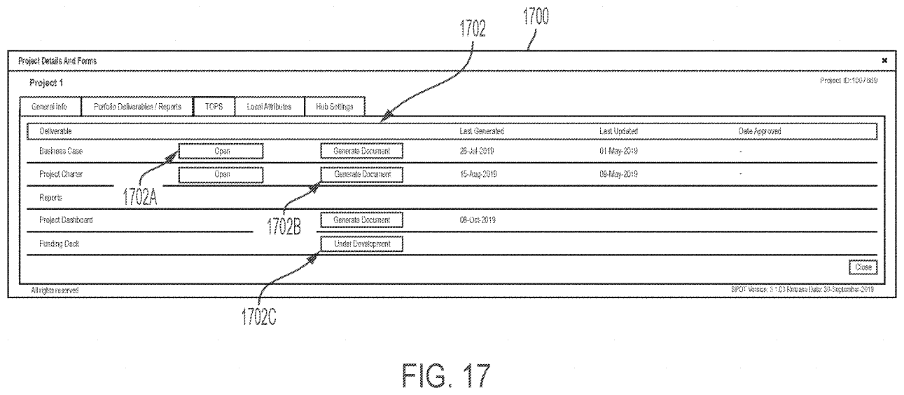

FIG. 17 is an example screen capture of a user interface 1700 for generating portfolio reports, according to some embodiments. As shown in FIG. 17, the user interface 1700 includes a section 1702 with multiple types of deliverables and/or reports. In some embodiments, the user interface 1700 may include a selectable option to view an existing report or deliverable. For example, the user interface 1700 of FIG. 17 includes an option 1702A to open a report for a first deliverable. In some embodiments, the user interface 1700 may include a selectable option that, when selected, triggers generation of a report. For example, the user interface 1700 of FIG. 17 includes an option 1702B to generate a document for a second deliverable. In some embodiments, the user interface 1700 can be configured to indicate that a status of a deliverable (e.g., when the deliverable is not available). For example, the user interface 1700 of FIG. 17 includes an indication 1702C that a third deliverable (“Funding Deck”) is under development.

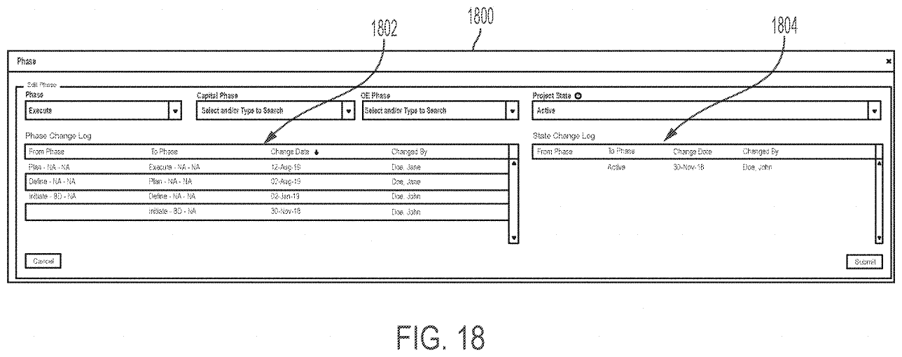

FIG. 18 is an example screen capture of a user interface 1800 for configuring project phase, according to some embodiments. As shown in FIG. 18, the user interface 1800 may include one or more editable options for configuring a phase and/or state of a project and/or portfolio. For example, the user interface 1800 may include a menu for specifying phase, capital phase, OE phase, and/or project state. As shown in FIG. 18, the user interface 1800 includes a phase change log 1802 tracking phase changes. The system may track an original phase, a changed phase, a time (e.g., date) when the phase change was made, and an identification (e.g., a name) of a person that made the phase change. As shown in FIG. 18, the user interface 1800 includes a state change log 1804. The system may track a original state, a changed state, a time (e.g., date) when the state change was made, and an identification (e.g., a name) of a person that made the state change.

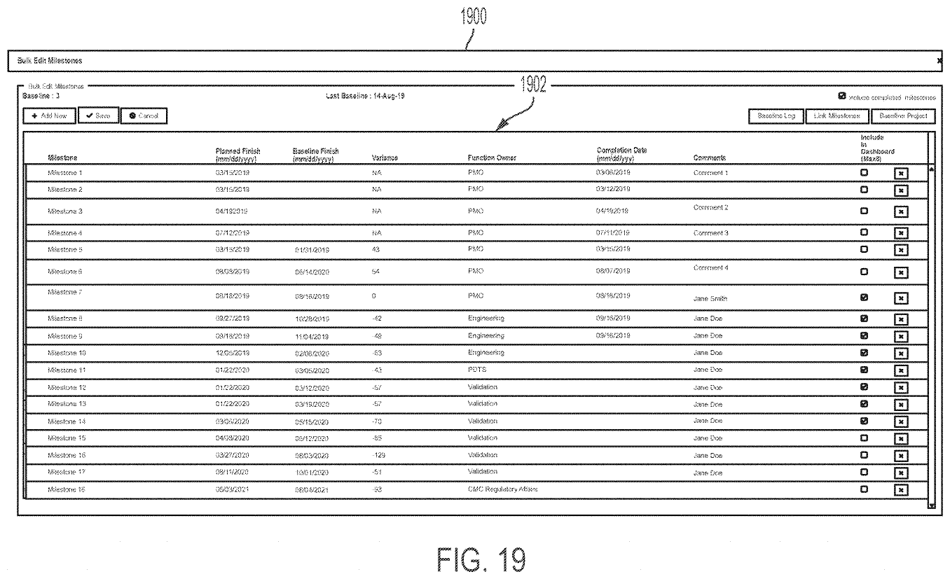

FIG. 19 is an example screen capture of a user interface 1900 for editing milestones, according to some embodiments. As shown in FIG. 19, the user interface 1900 includes a section 1902 listing milestones in a portfolio and/or project. In some embodiments, the user interface 1900 includes options to add milestones, modify milestones, and/or remove milestones.

FIG. 20 is an example screen capture of a user interface 2000 showing network performance, according to some embodiments. In some embodiments, the user interface 2000 may display a report of performance for a portfolio. User interface 2000 may show one or more graphs. For example, as shown in FIG. 20, user interface 2000 includes a bar graph 2002 for project data quality. The bar graph 2002 includes a bar for various phase of the project including define, plan, execute, and close. The bar graph 2002 includes bars for each aspect, and a line for target quality (e.g., 85%). The user interface 2000 includes a second bar graph 2004 for project data freshness. The bar graph 2004 includes bars for each phase of the project (e.g., define, plan, execute, and close), and a line for a target data freshness (e.g., 95%). The user interface 2000 includes a bar graph 2006 showing data quality hits and misses. For each project phase, the bar graph 2006 includes a first bar for data quality hits and a second bar for data quality misses. The user interface 2000 further includes a bar graph 2008 showing average project data quality for respective projects in a portfolio. The bar graph 2008 further shows a horizontal line indicating a target data quality for each project.

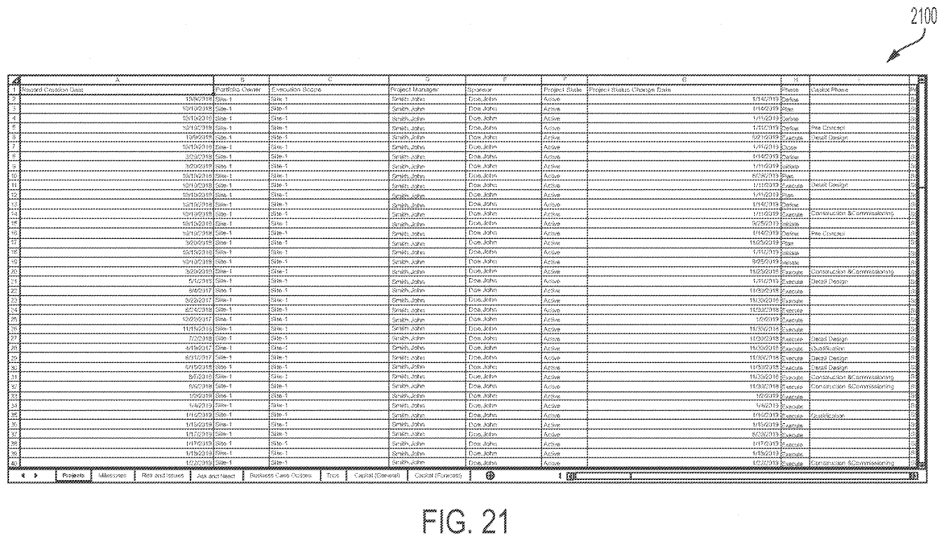

FIG. 21 is an example screen capture of a generated project report 2100, according to some embodiments. The generated project report 2100 includes information about each of multiple projects (e.g., that are part of a portfolio). As shown in FIG. 21, the project report 2100 includes a portfolio owners, execution scope, project manager, sponsor, project state, project status change data, phase, capital phase, and other parameters. In some embodiments, the system can be configured to generate the project report 2100 as a spreadsheet (e.g., as shown in FIG. 21).

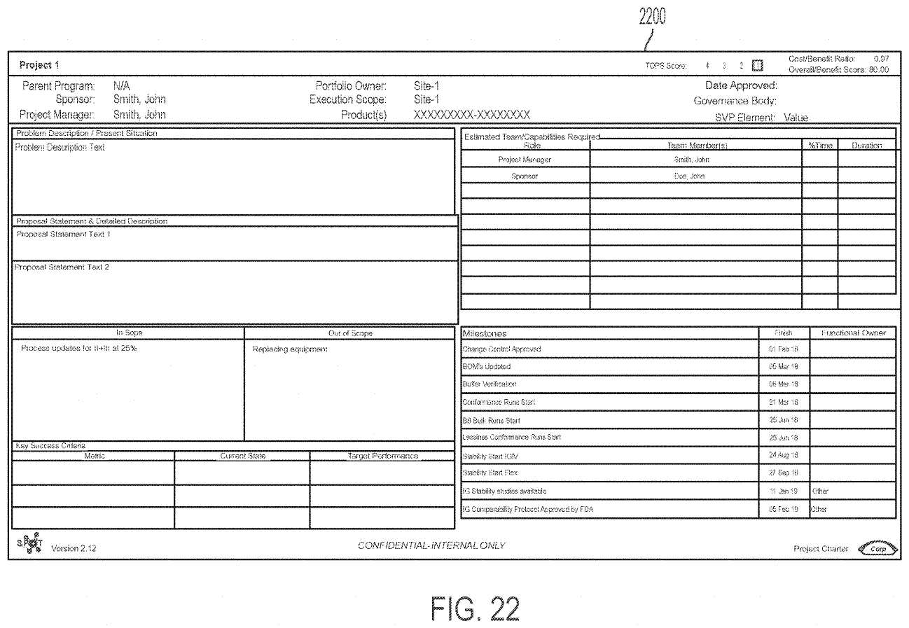

FIG. 22 is an example screen capture of a user interface 2200 for submission of a problem for a project, according to some embodiments. As shown in FIG. 22, the user interface 2200 includes fields for entering information about a problem for a project. In the example of FIG. 22, the user interface 2200 includes a field for entering a problem description, and a proposal statement. The user interface 2200 further provides fields to indicate actions that are in scope and actions that are outside of scope. The user interface 2200 includes a section for specifying team members and respective roles. The user interface 2200 displays one or more milestones of the project.

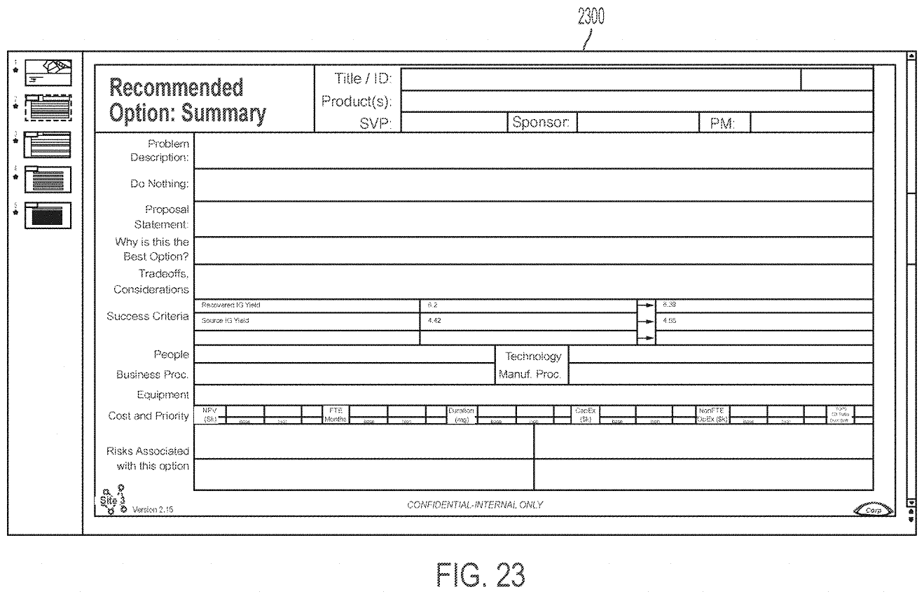

FIG. 23 is an example screen capture of a user interface 2300 for recommending an option, according to some embodiments. For example, the user interface 2300 may be provided to a user for recommending an option to address a problem. The user interface 2300 includes multiple fields for a user to enter information about the project and/or problem. For example, the user interface 2300 includes a title/ID field, a product(s) field, a sponsor field, a problem description field, a proposal statement field, a field for the best option, tradeoffs/considerations, success criteria, people involved, technology, equipment and other fields. The user interface 2300 further includes a field for displaying risks associated with respective options.

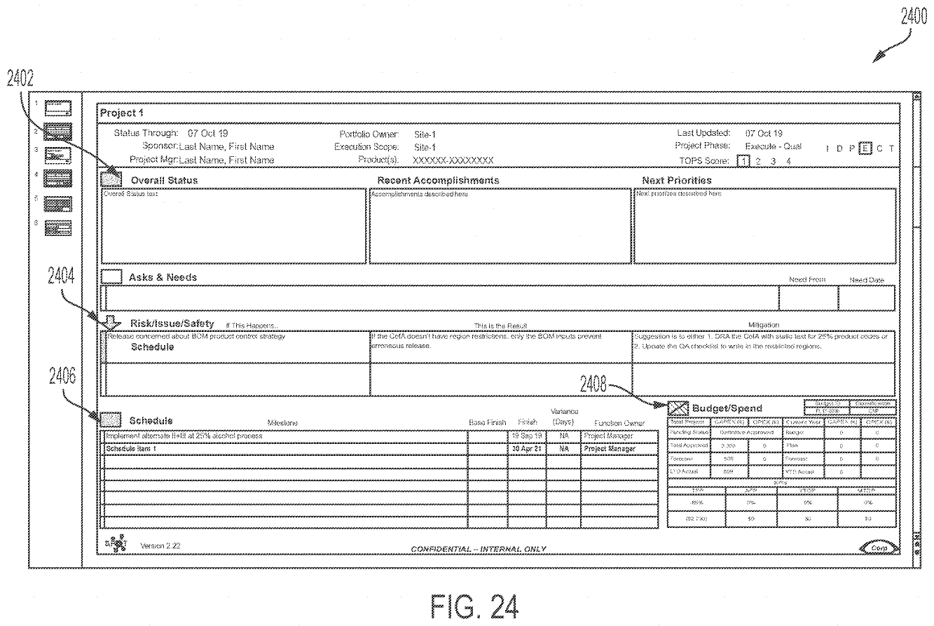

FIG. 24 is an example screen capture of a project specific report 2400, according to some embodiments. As shown in FIG. 24, the report 2400 shows an overall status indicator 2402 for the project. In some embodiments, a color of the status indicator 2402 may indicate an overall status of the project (e.g., red indicates that the project is not meeting goals while green indicates that the project is meeting goals). Example operation of status indicators is described herein. The report 2400 includes a status indicator 2404 for risk/issue/safety. In some embodiments, the status indicator 2404 may include an arrow and a color. The downward direction of the indicator 2404 may indicate that the project is not expected to meet future goals in terms of risk/issue/safety. The red color may indicate that the project has not met previous goals. The report 2400 includes an indicator 2406 for a status of the project in terms of schedule. The report 2400 includes an indicator 2408 for budget/spending for the project. The visual indicators may consolidate large amounts of information for a user in the report 2400 to indicate one or more statuses of the project.

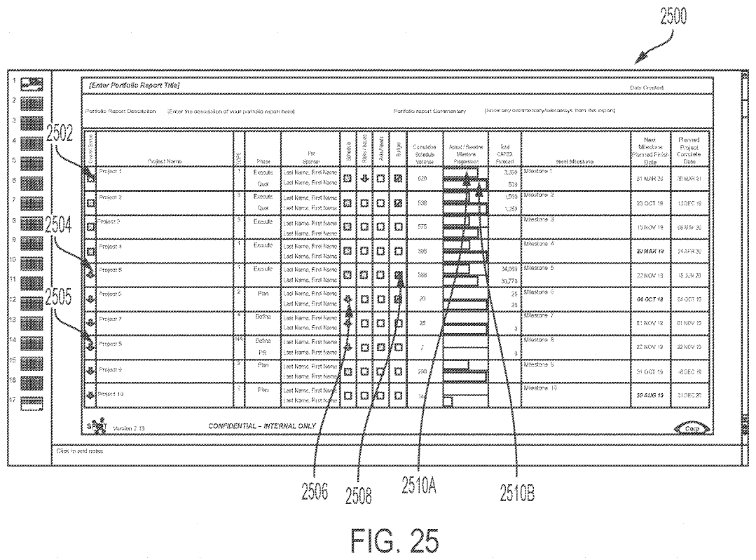

FIG. 25 is an example screen capture of a portfolio report 2500, according to some embodiments. The portfolio report 2500 includes information about one or more projects that are part of the portfolio. For example, the report 2500 includes an overall status indicator 2502 for a first project in the portfolio, an overall status indicator 2504 for a second project in the portfolio, and an overall status indicator 2505 for a third project in the portfolio. As shown in FIG. 25, a status indicator may provide an indication according to a color and/or arrow direction of the status indicator. For example, the status indicator 2502 is a red square, the status indicator 2504 is a downward facing red arrow, and the status indicator 2505 is a downward facing yellow arrow. The report 2500 includes status indicators for each project. For example, the report 2500 includes a schedule status indicator 2506 for a project and a budget status indicator 2508 for another project. As shown in FIG. 25, the status indicator may have multiple colors and/or be an arrow. Report 2500 includes progression indicators for each project. For example, the report 2500 includes a first bar 2510A indicating actual milestone progression for a project, and a second bar 2510B for baseline milestone progression for the project. Accordingly, the report 2500 may provide the user with an interface capturing large amounts of information in indicators on a single user interface screen.

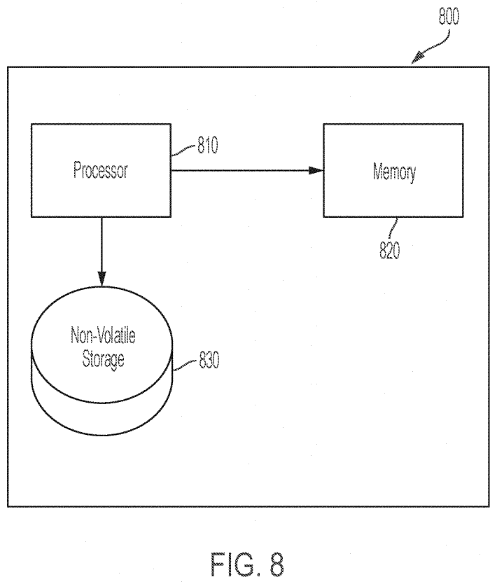

Additionally, an illustrative implementation of a computer system 800 that may be used in connection with any of the embodiments of the disclosure provided herein is shown in FIG. 8. The computer system 800 may include one or more processors 810 and one or more articles of manufacture that comprise non-transitory computer-readable storage media (e.g., memory 820 and one or more non-volatile storage media 880). The processor 810 may control writing data to and reading data from the memory 820 and the non-volatile storage device 880 in any suitable manner. To perform any of the functionality described herein, the processor 810 may execute one or more processor-executable instructions stored in one or more non-transitory computer-readable storage media (e.g., the memory 820), which may serve as non-transitory computer-readable storage media storing processor-executable instructions for execution by the processor 810.

### Greenhouse Gas Emission Management System

According to some aspects, the inventors have developed an electronic emission management system that allows users to efficiently manage greenhouse gas emissions of one or more portfolios. In some embodiments, the system can be configured to (1) accept emission values for emission sources of one or more portfolios according to native input formats for the emission sources; and (2) translate the native input formats into a first format (e.g., a universal format) that allows comparing emissions among the emission sources. The system can be configured to accept user input specifying a target emission for the portfolio(s). The system can be configured to use stored emission values (e.g., translated into the first format) to (1) determine one or more parameters (e.g., predicted net emission and/or cost) for the portfolio(s); and (2) generate user interface displays for the portfolio(s) using the determined parameter(s) to allow users to efficiently manage greenhouse gas emissions for the portfolio(s).

The inventors have recognized that conventional portfolio management systems fail to provide users with mechanisms to efficiently manage greenhouse gas emissions in portfolio(s). Conventional systems fail to provide users with a measure of overall emissions in the portfolio(s) and fail to provide a user interface for efficiently viewing and analyzing greenhouse gas emissions in the portfolio(s). For example, projects may have different emission sources form which the system receives respective inputs on greenhouse gas emissions in different input formats. Conventional systems are unable to combine and/or compare these different formats and may have to perform computations for each emission source in the portfolio(s) separately. Furthermore, conventional systems are unable to display emission for the portfolio(s) on a single user interface display as multiple displays may be required to capture different emission sources having different input formats.

Described herein are embodiments of an electronic emission management system that (1) computes emissions for a portfolio(s) more efficiently; and (2) provides a user interface which allows users to more easily understand overall emissions of the portfolio(s) as well as impacts of different factors on the emissions. Some embodiments can be configured to translate different emission value input formats into a single universal format, and use the translated value to determine parameters for the portfolio(s). The system can may then use these parameters to generate user interface displays that allow a user to visualize overall historical, present, and future emissions of the portfolio(s), and to understand impacts of various factors on the portfolio(s). By using a universal format, the system may use a fewer number of computations to assess emissions of the portfolio(s) (e.g., by eliminating computation of information using other formats) and generate fewer user interface displays.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, any combination of, and all of the described terms.

Shown in FIG. 26A is a block diagram of an environment 2600 in which some embodiments may be implemented. The environment 2600 includes an emissions management system 2602, projects 2604-2608, and user devices 2610-2614. As illustrated in the example embodiment of FIG. 26A, the emissions management system 2602 (also referred to herein as “system 2602”) receives input data from projects 2604-2608. The emissions management system 2602 also communicates with user devices 2610-2614.

In some embodiments, the emissions management system 2602 can be configured as a subsystem of system 100, functionality executed by an execution engine 102, and/or a component of execution engine 102 described herein with reference to FIGS. 1A-B. In some embodiments, the emissions management system 2602 can be configured as a subsystem of portfolio management system 250 described herein with reference to FIG. 2. In some embodiments, the emissions management system 2602 can be configured as stand-alone system.

In some embodiments, the emissions management system 2602 can be configured to accept emission values for one or more emission sources of the projects 2604-2608. As shown in the example embodiment of FIG. 26A, project 2604 includes emission sources 2604A-C, project 2606 includes emission sources 2606A-C, and project 2608 includes emission sources 2608A-C. The emissions management system 2602 can be configured to receive emission values for emission sources 2604A-C, 2606A-C, and 2608A-C. In some embodiments, the emissions management system 2602 can be configured to receive emission values for emission sources in native formats. A native format may include a unit of measurement for the emission source. For example, emission source 2604A may be electricity purchased by project 2604 measured in kilowatt-hour (kWh), emission source 2604B may be propane usage by the project 2604 measured in gallons (gal), and emission source 2604C may be diesel consumed in generators of project 2604 measured in gallons (gal). In this example, the system 2602 may receive a numerical value in kilowatt-hour (kWh) for emission source 2604A, a numerical value in gallons (gal) for emission source 2604B, and a numerical value in gallons (gal) for emission source 2604C.

In some embodiments, the emissions management system 2602 can be configured to translate emission values received for emission sources into a first format. The first format may be a universal format comprising a unit and numerical value. In some embodiments, the universal format may have a unit of measurement of tons of carbon dioxide (tCO₂). In some embodiments, the universal format may have a unit of measurement of tons of greenhouse gas (tGHG). tGHG may also be known as of tons of carbon dioxide equivalent (tCO2e or tCO2e). In some embodiments, the universal format may have a unit of measurement of tons of methane (tCH₄). In some embodiments, the universal format may have a unit of measurement per unit of time. For example, the unit of measurement may be tCO₂/year, tCO2e/year, or tCH₄/year. Some embodiments are not limited to a universal format herein. In some embodiments, the system 2602 can be configured to use multiple universal formats. For example, the system 2602 may translate emission values into tCO2e and tCH₄. In some embodiments, the system 2602 can be configured to receive a user input specifying universal format to be used and, in response, translate emission values into the specified universal format.

Although the example embodiment of FIG. 26A shows the emissions management system 2602 in communication with three projects, some embodiments are not limited to any number of projects. The emissions management system 2602 can be configured to communicate with any number of projects. Although the example embodiment of FIG. 26A shows three emission sources in each project, a project is not limited to any particular number of emission sources.

As shown in the embodiment of FIG. 26A, the emissions management system 2602 includes a reporting component 2602A. In some embodiments, the reporting component 2602A can be configured to use accepted emission values (e.g., translated into a universal format) to provide information to users of the system 102 (e.g., via user devices 2610-21614). In some embodiments, the reporting component 2602A can be configured to determine one or more parameters for one or more portfolios. For example, the system 102 may store a portfolio including projects 2604-2608. In this example, the reporting component 2602A may determine parameter(s) for the portfolio using emission values. Example parameters that may be determined are described herein.

In some embodiments, parameters determined by the emission management system 2602 for one or more portfolios may include net emission (e.g., tCO2e), mean emission per project (e.g., tCO2e/project), median emission of projects, net emission per unit of time (e.g., tCO2e/year), cost of emissions (e.g., dollars/tCO2e), projected net emission (e.g., tCO2e and/or tCO2e/year), projected cost of emissions (e.g., dollar/tCO2e), cost for reduction of emissions (e.g., in dollar spent), cost for achieving a target emission, date of realization of a target emission, change in emissions, cost per unit of emissions (e.g., dollars/tCO2e), emissions abated per unit of currency spent (e.g., tCO2e abated/dollar spent) contribution of projects to a target emission, and/or contribution of projects to net emission. Some embodiments are not limited to parameters described herein. Some embodiments can be configured to determine any parameter that may be derived using emission values.

In some embodiments, the reporting component 2602A can be configured to use historical emission values (e.g., stored in database 2602C). The system 2602 can be configured to use the historical values to generate user interface displays for portfolio(s) over a time period. For example, the reporting component 2602A may determine net emissions of a portfolio that includes projects 2604-2608 over a 10-year period, and report the net emissions for the portfolio of the period of 10 years (e.g., in the universal format). In one implementation, the reporting component 2602A may determine tCO2e emitted in the portfolio in each year of the period. In another example, the reporting component 2602A may determine parameter(s) for multiple different portfolios in a time period. The system 2602 may use these parameter(s) to provide a comparison of emissions among the different portfolios (e.g., by showing a bar graph which captures the emission of each portfolio).

In some embodiments, the reporting component 2602A can be configured to determine future emissions for a portfolio. In some embodiments, the reporting component 2602A can be configured to receive user-defined specifications of scenarios and/or actions that modify emission. For example, the system 102 may receive user input specifying that a different type of fuel will be used in a project, or more efficient lighting will be used for a project. In another example, the system may receive user input specifying a growth in operations of the portfolio. In some embodiments, the system reporting component 2602A can be configured to determine changes in emissions for one or more emission sources according to the specified scenario and/or action. For example, the reporting component 2602A may determine an amount of emissions that would be reduced by one or more emission sources in one or more projects of the portfolio as a result of the user-specified action. In some embodiments, the reporting component 2602A can be configured to determine predicted emissions for a portfolio. The reporting component 2602A can be configured to adjust the predicted emissions for the portfolio according to the user-specified action.

In some embodiments, the reporting component 2602A can be configured to predict future scenarios of portfolio(s). In some embodiments, the reporting component 2602A can be configured to predict future emissions using a parametric model. The parametric model may output changes in emission based on historical change in emission factors, technologies expected to turn on (e.g., due to a planned project), and/or other events that may affect emissions. In some embodiments, the reporting component 2602A can be configured to determine a future scenario for the portfolio(s) based on a combination of factors described herein. In some embodiments, the reporting component 2602A can be configured to incorporate variability in production into the parametric model. For example, the reporting component 2602A can be configured to determine (1) an increase in emissions of the portfolio(s) in the future based on an increase in production in projects of the portfolio(s); or (2) a decrease in emissions of the portfolio(s) in the future based a decrease of productivity in projects of the portfolio(s).

In some embodiments, the reporting component 2602A may include a machine learning model (e.g., a neural network, decision tree, support vector machine, and/or logistic regression model) trained to output indications of future scenarios. In some embodiments, the reporting component 2602A can be configured to provide input features to the machine learning model to obtain an output indicating one or more future scenarios of the portfolio(s). For example, the reporting component 2602A can be configured to generate values for the input features using emission values for emission sources of the portfolio(s). The output

In some embodiments, the reporting component 2602A can be configured to determine predicted emissions for a portfolio for multiple different scenarios. The reporting component 2602A can be configured to receive user input specifying different scenarios in project(s) of the portfolio. In some embodiments, the reporting component 2602A can be configured to determine a predicted emission impact for each of the scenarios. For example, the reporting component 2602A may receive a user input specifying a first scenario in which a project of the portfolio is shutdown, and a second scenario in which the project of the portfolio is kept active. The reporting component 2602A may determine predicted parameters for the portfolio for each scenario and provide the predicted parameters for user(s). In some embodiments, the system 2602 may be configured to use the predicted parameters to generate user interface displays (e.g., generated by user interface component 2602B).

In some embodiments, the reporting component 2602A can be configured to determine emission performance of a portfolio relative to a target emission for the portfolio. For example, the reporting component 2602A can be configured to compare emissions of the portfolio to a target net emission for the portfolio. In some embodiments, the reporting component 2602A can be configured to determine emission performance of the portfolio relative to a dynamic target emission for the portfolio. In some embodiments, the system 2602 can be configured to define a target emission as a changing target value (e.g., over a time period). In some embodiments, the system 2602 can be configured to define a target emission for a portfolio as a function of time. For example, the reporting component 2602A may specify a target emission for the portfolio for each year of a time period. In some embodiments, the reporting component 2602A can be configured to automatically define the dynamic target. For example, the reporting component 2602A may receive a user input specifying a target emission for the portfolio at a future time (e.g., a year). The reporting component 2602A may determine a target emission value for the portfolio for points in time (e.g., years) between the current time and the future time. In some embodiments, the reporting component 2602A can be configured to compare predicted emission changes for a portfolio (e.g., based on determined actions and/or scenarios) to future emission targets. The reporting component 2602A can be configured to show users how predicted emission changes will affect emission performance of the portfolio relative to the target emission.

In some embodiments, the system 2602 can be configured to accept a target emission for one or more portfolios as an absolute emission value (e.g., in tCO2e), a percentage decrease in emissions, and/or a quantity of emissions to be reduced. In some embodiments, the system can be configured to determine a target percentage decrease in emissions and/or quantity of emissions to be reduced from a baseline for the portfolio(s). A baseline may be a snapshot in time for values of one or more parameters for the portfolio(s). For example, the system may accept a target emission percentage reduction relative to emission levels in a specific year (e.g., 2019). In this example, the values of the parameter(s) in 2019 may provide a baseline for the portfolio(s). Some embodiments are not limited to accepting a particular type of target emission. In some embodiments, the system 2602 can be configured to accept a time period over which a target emission is to be achieved.

In some embodiments, the reporting component 2602A can be configured to determine performance of a portfolio relative to a target emission for the portfolio using a universal format. For example, projects 2604-2608 may be part of a portfolio, and emissions sources 2604A-C, 2606A-C, and 2608A-C may each have different native formats. The reporting component 2602A may (1) convert the native formats into a universal format (e.g., to units of tCO2e); (2) combine the emissions in the portfolio in the native formats; and (3) compare the combined emissions in the native format to one or more target emission values in the native format. The reporting component 2602A may thus determine performance of the portfolio(s) a target emission.

In some embodiments, the reporting component 2602A can be configured to determine emissions of each of one or more projects of a portfolio. For example, the reporting component 2602A can be configured to determine an emission for project 2604, an emission for project 2606, and an emission for project 2608. In some embodiments, the reporting component 2602A can be configured to determine the emission for each project in the universal format to allow comparisons among projects of the portfolio. The reporting component 2602 can be configured to determine the emission for a respective project in the universal format by (1) determining emissions of each emission source of the respective project in the universal format; and (2) summing the determined emissions of the emission sources to determine the emission for the project. In some embodiments, the reporting component 2602A can be configured to determine emissions per unit of time for each project. For example, the reporting component 2602A may determine tCO2e/year for each project. In some embodiments, the reporting component 2602A can be configured to determine a cost efficiency for each project. The cost efficiency may indicate an amount of emission reduced per unit of currency spent. For example, the reporting component 2602A may determine a dollar/tCO2e or tCO2e/dollar for each project.

In some embodiments, the emissions management system 2602 can be configured to define a portfolio that includes multiple other portfolios. In some embodiments, the portfolio may include portfolios that affect greenhouse emissions. For example, an organization (e.g., a corporation or a company) may define a single portfolio that includes all projects and/or portfolios that affect the greenhouse gas emission. In this manner, the system 2602 may provide an organization with a single portfolio to measure overall greenhouse gas emissions by the organization. For example, a drug manufacturing corporation may define a universal emission portfolio for managing all the organizations greenhouse gas emissions. The emissions management system 2602 may associate all portfolios that include projects with greenhouse gas emissions with the universal emission portfolio.

In some embodiments, the reporting component 2602A can be configured to provide information on how each of multiple portfolios in a single emissions portfolio contributes emissions. In some embodiments, the reporting component 2602A can be configured to determine a percentage of emissions in the emissions portfolio that are attributed to each sub portfolio. For example, the reporting component 2602A may determine that the portfolio of projects in Los Angeles, Calif. accounts for 48% of emissions of the total greenhouse gas emissions of the organization. In some embodiments, the reporting component 2602A can be configured to determine a percentage of emissions in one or more portfolios attributed to each of the projects in the portfolio(s).

In some embodiments, the reporting component 2602A can be configured to determine a scope for the portfolio(s). A scope of emissions may indicate a category of greenhouse gas emissions. In some embodiments, the system 2602 can be configured to define three different scopes of greenhouse gas emissions: scope 1, scope 2, and scope 3. Scope 1 may include emissions from sources owned and controlled by an entity (e.g., a company using the system 2602). For example, scope 1 may include fossil fuel combustion by a facility of the entity. Scope 2 may include indirect emissions from sources that are owned or controlled by the entity. For example, scope 2 may include emissions resulting from generation of electricity purchased by the entity. Scope 3 may include emissions from sources not owned or directly controlled by the entity, but related to entity actions. For example, scope 3 may include emissions resulting from employees of the entity commuting. In some embodiments, the reporting component 2602A can be configured to determine a scope based on a user input. For example, the system 2602 may accept a user input specifying a scope.

In some embodiments, the reporting component 2602A can be configured to determine parameter(s) for a scope of the portfolio(s). For example, the system 2602 may receive a user input selecting scope 1 for the portfolio(s). In this example, the reporting component 2602A may determine parameter(s) incorporating only scope 1 emission sources. In some embodiments, the reporting component 2602A can be configured to determine parameter(s) for multiple scopes of the portfolio(s). For example, the reporting component 2602A may determine parameter(s) using scope 1 and scope 2 emission sources.

As illustrated in the example embodiment of FIG. 26A, emissions management system 2602 includes a user interface component 2602B. The user interface component 2602B can be configured to generate a user interface displaying information (e.g., provided by reporting component 2602A). In some embodiments, the system can be configured to display information on emissions/emission sources in a native format for each emission source. Typically, a user has little information on how to compare such native versions of emission data where a plurality of different formats can be presented. For example, reporting information on the emissions/emission sources can be communicated in any number of different formats (e.g., 1, 2, 3, 4, 5, 6, 7, 8, 9, 10 . . . etc.) and the user observing the display would gain little benefit from a list of disparate sources and formats. According various embodiments, the system can employ translations (e.g., universal formats) as discussed herein to order the native displayed formats. For example, the system can provide ordering of the displayed native formats (e.g., greatest emission contributor to least emission contributor, least contributor to greatest contributor, highest cost to a reduce emissions by a translated unit (e.g., one, two, three, four, five, six, . . . , ten, etc.) of emissions, lowest cost to reduce emissions by a translated unit (e.g., one, two, three, four, five, six, . . . , ten, etc.) of emissions, etc.) so that a user can readily understand the native display formats and how they relate with respect to each other. In some examples, the induced ordering can be manipulated by the user based on selecting header information or making selection in the UI on which to order the data, which triggers re-ordering of the display based on a translated format (e.g., a universal format). In some examples, the translated format may not be displayed. How the native data is displayed in the user interface (e.g., based on un-visualized translations) improves the user interface itself providing functionality that is associated with information that no longer needs to be displayed, and still conveys that information based on the ordering of the native formats. Various conventional systems fail to provide such functionality and fail to provide the users such information without resort to having to display that information. Thus, for example, the user interface itself is made more efficient based on not having to incorporate displays of the translated information, while still conveying that information in the ordering of items in the display. In various embodiments, the system can provide functions that enable users to order any display on un-visualized information available in the project data set, and for example, based on a universal/translated emissions source format.

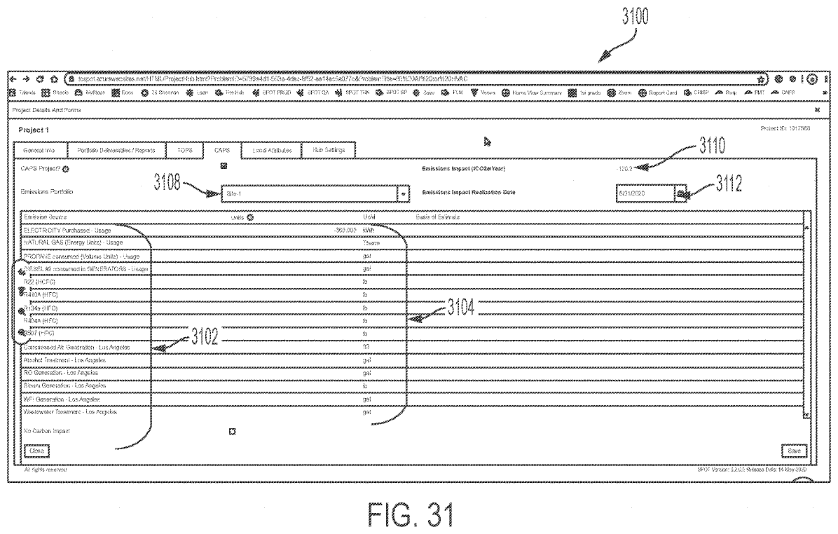

As shown in FIG. 26A, users may access the emissions management system 2602 via user devices 2610-2614. The user interface component 2602B can be configured to generate user interface displays of the devices 2610-2614. Example user interface displays are described herein with reference to FIGS. 31-35.

In some embodiments, the user interface component 2602B can comprise one or more application program interfaces (API) used by the user interface component 2602B to generate user interfaces displays on the devices 2610-2614. In some embodiments, the user interface component 2602B can be configured to generate displays in a user interface of an application on the devices 2610-614. For example, devices 2610-2614 may access the emissions management system 2602 using an Internet browser application. In this example, the user interface component 2610 may generate displays as webpages displayed in the Internet browser application. In another example, a user device (e.g., one of devices 2610-2614) may access the emissions management system 2602 using an application locally installed on the device (e.g., a desktop application or a smartphone application). The user interface component 2602B can be configured to generate a user interface as display windows or screens of the application.

In some embodiments, the user interface component 2602B can be configured to display emission source(s) in a native format and/or in the universal format. In some embodiments, the user interface component 2602B can be configured generate a view displaying emission source(s) of a project in native formats with respective value(s) in a universal format. The display of both formats may allow a user to compare native format values to universal format values (e.g., for a portfolio). In some embodiments, the user interface component 2602B can be configured to order emission source(s) based on universal format values. For example, the user interface component 2602B may order displayed emission sources in descending order of the emission value in the universal format (e.g., tCO2e). In some embodiments, the user interface component 2602B can be configured to generate a view displaying emission source(s) in the universal format. The universal format may allow a user to have single measure to use for quantifying emission sources and comparing emission sources. In some embodiments, the user interface component 2602B can be configured to generate a view displaying emission values in native format(s). In some embodiments, the user interface component 2602B can be configured to generate a view in which a user can toggle between displays of emission values in native format(s) and universal format(s). For example, the user interface component 2602B may generate a selectable option (e.g., button) in a user interface. The user interface component 2602B may change between a display of native format values and a display of universal format values in response to a user input (e.g., click, tap, touch, and/or swipe).

In some embodiments, the user interface component 2602B can be configured to generate one or more visualizations (e.g., of information provided by the reporting component 2602A). In some embodiments, the user interface component 2602B can be configured to generate visualizations of historical, present, and future emissions of a portfolio. For example, the user interface component 2602B can be configured to generate a line graph showing emissions of a portfolio over a time period. The line graph may include points for points in the time period (e.g., for each year in the time period). The line graph may include historical emission values, present emission values, and predicted future emission values (e.g., determined by the reporting component 2602A). In another example, the user interface component 2602B may generate a bar graph showing emissions of multiple projects in a portfolio.

In some embodiments, the user interface component 2602B can be configured to generate visualizations of target emissions. For example, the user interface component 2602B can be configured to plot target emission values (e.g., determined by the reporting component 2602A) on a graph. In some embodiments, the user interface component 2602B can be configured to plot graphs showing emissions of a portfolio (e.g., past, present, and/or future values) relative to a target emission value for the portfolio. The graph may allow the user to visually compare portfolio emissions to target emission(s). In some embodiments, the user interface component 2602B can be configured to plot predicted emissions for user specified actions and/or scenarios. The user interface component 2602B can be configured to plot the predicted emissions with target emissions. A user may thus visualize emissions, determined from actions and/or different scenarios, relative to target emissions for portfolio(s).

In some embodiments the user interface component 2602B can be configured to plot emissions for multiple portfolios. The graphs may allow a user to compare emissions of different portfolios. In some embodiments, one portfolio may be a sub portfolio of a universal emissions portfolio (e.g., of all portfolios having greenhouse gas emissions). The user interface component 2602B may plot the sub portfolio with the universal emissions portfolio. This may provide a user with a visualization of an influence of a sub portfolio on the overall greenhouse gas emissions (e.g., of an organization). For example, the user interface may generate line graph showing values (e.g., tCO2e) over a time period for the universal emissions portfolio, and a second line of emission values over the time period for a sub portfolio (e.g., a portfolio of projects in a specific location).

In some embodiments, the user interface component 2602B can be configured to dynamically modify a visualization. In some embodiments, the user interface component 2602B can be configured to modify a visualization (e.g., a line graph) of emission values in response to determination of an action. For example, the system 2602 may receive user input specifying that fuel for a project in the portfolio is switching from a fossil fuel source (e.g., oil) to a renewable energy source (e.g., wind power). The user interface component 2602B may modify a display (e.g., a graph) of predicted emission in response to receiving the user input specifying the action. In some embodiments, the user interface component 2602B can be configured to modify a visualization of emission values in response to a scenario. For example, the user interface component 2602B may modify a display (e.g., a graph) of predicted emission for a portfolio in response to a user-defined scenario. In some embodiments, the user interface component 2602B can be configured to modify a display (e.g., a graph) of predicted emission for a portfolio in response to a determined change in scenario. For example, the user interface component 2602B can be configured to modify the display in response to determining that operations in a portfolio are to increase.

As illustrated in the example embodiment of FIG. 26A, emissions management system 2602 includes a data store 2602C. In some embodiments, the data store 2602C may be a system for storing data. In some embodiments, the data store 2602C may include one or more databases hosted by one or more computers (e.g., servers). In some embodiments, the data store 2602C may include one or more physical storage devices. As an example, the physical storage device(s) may include one or more solid state drives, hard disk drives, flash drives, and/or optical drives. In some embodiments, the data store 2602C may include one or more files storing data. As an example, the data store 2602C may include one or more text files storing data. As another example, the data store 2602C may include one or more XML files. In some embodiments, the data store 2602C may be storage (e.g., a hard drive) of a computing device. In some embodiments, the data store 2602C may be a cloud storage system. Some embodiments are not limited to a particular type of data store.

In some embodiments, the emissions management system 2602 can be configured to store emissions data in the data store 2602C. In some embodiments, the system 2602 can be configured to store emission values in the data store 2602C. The system 2602 can be configured to store accepted emission values (e.g., from projects 2604-2608). The system 2602 can be configured to store historic, present, and predicted emission values. In some embodiments, the system 2602 can be configured to store parameters for portfolio(s) (e.g., determined by reporting component 2602A). In some embodiments, the system 2602 can be configured to store target emission values in the data store 2602C.

In some embodiments, the user interface component 2602B can be configured to use data stored in the data store 2602B to generate visualizations. For example, the user interface component 2602B may use stored emission values to generate graphs. In another example, the user interface component 2602B may display values from the data store 2602C in tables displayed in a user interface.

In some embodiments, the system 2602 can be configured to store portfolio definitions in the data store 2602C. In some embodiments, the system 2602 can be configured to store a hierarchical data structures specifying projects that belong to a portfolio in the data store 2602C. In some embodiments, the system 2602 can be configured to store a hierarchical data structure specifying sub portfolios that belong to a portfolio. For example, the system 2602 may store a specification of which portfolios belong to a universal portfolio for greenhouse gas emissions (e.g., used by an organization to manage its cumulative greenhouse gas emissions).

Each of user devices 2610-2614 may be any computing device. For example, the device may be a laptop computer, a desktop computer, a tablet, or a smartphone. Some embodiments are not limited to any computing device.

In some embodiments, the emissions management system 2602 can be configured to be accessed by user devices 2610-2614 through a network (e.g., the Internet). For example, the emissions management system 2602 may be a distributed computer system accessed remotely by the user devices 2610-2614 via the Internet. In some embodiments, the emissions management system 2602 may be a cloud-based application accessed by the user devices 2610-2614 via the Internet. For example, the system 2602 may be accessed using an Internet browser application on the devices 2610-2614. In some embodiments, the emissions management system 2602 may comprise an application installed locally on the devices 2610-2614. For example, the emissions management system 2602 may comprise a computer application and/or a smartphone application that allows users to interface with the emissions management system 2602. Some embodiments are not limited to a specific configuration of application software.

Shown in FIG. 26B is a system data flow diagram illustrating translation of emission value format, according to some embodiments. As shown in the example embodiment of FIG. 26B, the emission management system 2602 receives emission values for emission sources 2604A, 2604B, and 2606A in their respective native formats: emission values for emission source 2604A are received in native format 1, emission values for emission source 2604B are received in native format 2, and emission values for emission source 2606A are received in native format 3.

In some embodiments, the native format may comprise a unit of measurement for emission values of an emission source. For example, the system 2602 may receive emission values for (1) emission source 2604A in kilowatt-hour (kWh); (2) emission source 2604B in gallons (gal); and (3) emission source 2606A in pounds (lb.). In some embodiments, a native format may comprise a precision (e.g., number of significant digits) for emission values of an emission source. In some embodiments, a native format may comprise an indication of a valid range for emission values of an emission source. For example, the native format may include an indication of a maximum and/or lower emission value for the emission source.

As shown the example embodiment of FIG. 26B, the emissions management system 2602 accepts the emission values in their respective native formats and translates the native formats into a first format (e.g., tCO2e). The “first format” may also be referred to herein as a “universal format.” The system 2602 translates (1) emission values for emission source 2604A from native format 1 (e.g., having units in kWh) into the first format; (2) emission values for emission source 2604B from native format 2 (e.g., having units in gal) to the first format; and (3) emission values for emission source 2606A from native format 3 (e.g., having units in lbs) to the first format. Emission values for each of the emission sources may then be in a single format. The single format may be used by the system 2602 as described herein. The single format may allow a user to compare emission sources, and to understand relative effects of emission sources on overall emissions for portfolio(s).

Some embodiments are not limited to the number of emission sources shown in FIG. 26B. In some embodiments, emission management system 2602 can be configured to translate emission values for any number of emission sources into the first format. In some embodiments, the emission management system 2602 can be configured to translate any number of native formats into the first format.

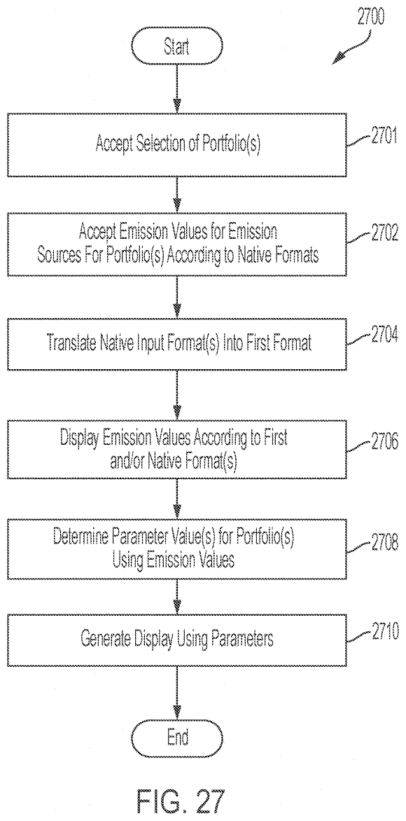

Shown in FIG. 27 is a flow chart of an example process 2700 for determining one or more parameters for one or more portfolios, according to some embodiments. Process 2700 may be performed by any suitable computing device. For example, process 2700 may be performed by emission management system 2602 described above with reference to FIGS. 26A-B.

Process 2700 begins at block 2701 where the system accepts a selection of the portfolio(s). In some embodiments, the system can be configured to provide a menu for selection of the portfolio(s). For example, the system may provide a menu in a user interface generated by the system in which a user can specify the portfolio(s). In some embodiments, the system can be configured to identify the portfolio(s) based on criteria accepted. For example, the system may receive a user input specifying a location or region (e.g., a city, state, and/or country). In this example, the system may identify all projects in the location or region as a portfolio. In another example, the system may receive a user input specifying a particular type of operation (e.g., drug manufacturing facility). In this example, the system may identify all projects including a drug manufacturing facility as a portfolio. The system can be configured to define portfolios by identifying projects from the criteria. In some embodiments, the system can be configured to accept a user selection of a previously defined portfolio. For example, the user may have previously defined a portfolio and saved it in the system. The system may provide a selection menu from which the user can select the previously defined portfolio.

Next, process 2700 proceeds to block 2702 where the system accepts emission values for emission sources of the portfolio(s) according to one or more native formats for the emission sources. In some embodiments, the system can be configured to accept emission values from different emission sources in different units. For example, the system may accept a first emission value from a first emission source in kWh, and a second emission value from a second emission source in gallons.

In some embodiments, the system can be configured to periodically accept emission values for the emission sources. For example, the system may accept updated emission values for emission sources at a set frequency (e.g., every hour, day, week, month, quarter and/or year). In some embodiments, the system can be configured to accept the emission values in response to a user input. In some embodiments, the system can be configured to access the emission values in response to a software application command. In some embodiments, the system can be configured to accept the emission values in response to a trigger even detected by the system. For example, the system may detect that a user has accessed the portfolio(s) and, in response, automatically obtain emission values for the emission sources (e.g., from project computer devices).

Next, process 2700 proceeds to block 2704 where the system translates emission values from respective native input format(s) into a first format (e.g., tons of CO₂). In some embodiments, the system can be configured to use the first format as a universal format in which emission values from all emission sources are converted into. The universal format may provide a consistent measure of emissions across all emission sources and portfolios. In some embodiments, the system can be configured to translate a native format into the first format by converting a unit of measurement of the native format into a unit of measurement of the first format. In some embodiments, the unit of measurement for the first format is tons of CO₂ (tCO2e).

Next, process 2700 proceeds to block 2706 where the system displays emission values for the emission sources. In some embodiments, the system can be configured to display emission values for the emission sources in respective native formats of the emission sources. For example, the system may display emission values in the same units in which they were accepted. In some embodiments, the system can be configured to use first format emission values to organize the emission values shown in the native formats. For example, the system may translate emission values into the first format, and use the emission values in the first format to determine an order in which the emission values are displayed in native formats.

In some embodiments, the system can be configured to display emission values for the emission sources in the translated format. For example, the system may display emission values for all the emission sources in the portfolio(s) in the first format. The emission values displayed in the first format may allow a user to compare emission among different emission sources. In some embodiments, the system can be configured to provide a selectable option in a user interface for toggling between a display of the emission values in native formats, and a display of the emission values in the first format. For example, the system may provide a button in a user interface generated by the system. The system may toggle between native format(s) and the first format in response to selection of the button in the user interface. In some embodiments, the system can be configured to display emission values in both the native format(s) and the first format. For example, the system may display emission values in native format(s) adjacent to corresponding emission values in the first format in a list.

In some embodiments, the system can be configured to display emission values in a table. For example, the system may display the emission values in native format(s) in a table including (1) a column that identifies emission sources; (2) a column that lists an emission value for each emission source in a respective native format; and (3) a column that lists am emission value for each emission source in the first format. In another example, the table may include (1) a column that identifies emission sources; and (2) a column that lists an emission value for each emission source in the first format. In some embodiments, the system can be configured to display emission values in graphs. For example, the system may display a line graph of emission values for emission sources over a time period. In some embodiments, the system can be configured to display emission values for a single emission source. For example, the system may (1) receive a user selection of a first emission source in the portfolio(s); and (2) display one or more emission values (e.g., historic, present, and/or future) in response to the user selection.

Next, process 2700 proceeds to block 2708 where the system determines one or more parameters for the portfolio(s). Example parameters are described herein. In some embodiments, the system can be configured to determine a net emission value for the portfolio(s) by (1) translating emission values for emission sources into a first format; and (2) summing the emission values in the first format to obtain the net emission value. In some embodiments, the system can be configured to determine a mean, median, and/or range of emission values for the portfolio(s). In some embodiments, the system can be configured to determine parameter values indicating emission of the portfolio(s) relative to a target emission. For example, the system may determine how much higher emission of the portfolio(s) is relative to a target emission. In another example, the system may determine a percentage by which the portfolio(s) exceed a target emission. In some embodiments, the system can be configured to determine parameter value(s) at different points. For example, the system may determine parameter values at different points in time.

Next, process 2700 proceeds to block 2710 where the system generates a user interface display using the parameters. For example, user interface component 2702B of system 2702 described above with reference to FIGS. 26A-B may use the determined parameter value(s) to generate a display. In some embodiments, the system can be configured to generate a graph in which parameter value(s) are plotted. In one implementation, the system may plot net emission of the portfolio(s) over a time period on a graph. For example, the system may plot net emission of the portfolio(s) by year over a period of multiple years. In another implementation, the system may generate a bar graph where each bar indicates the net emission of a respective portfolio, project, or emission source. Example user interface displays are described herein with reference to FIGS. 31-35.

In some embodiments, the system can be configured to display parameter values for multiple different portfolios simultaneously. For example, the system may generate a line graph where each line specifies net emission values for a respective set of one or more portfolios. In some embodiments, the system can be configured to display the parameter values with one or more other values. For example, the system may plot a graph of emission values for a set of portfolios with a plot of a target emission for the portfolio(s).

After block 2710, process 2700 ends. In some embodiments, the system can be configured to dynamically update parameter value(s) and/or generated displays. For example, the system may receive updated data and, in response, update parameter value(s) and corresponding displays. In some embodiments, the system can be configured to update displays in response to user inputs. For example, the system may update a display in response to a user input specifying a future scenario for emissions of portfolio(s). In another example, the system may update a display in response to a user input specifying an action to modify emissions for the portfolio(s) in the future. In another example, the system may update a display in response to a determined change in emission factor for one or more emission sources of the portfolio(s). In some embodiments, the system can be configured to update a user interface display in response to an automatic determination of a change in the portfolio(s). For example, the system may determine a change in emission factor, a growth in operation, or other change and, in response, update the user interface display based on updated parameters.

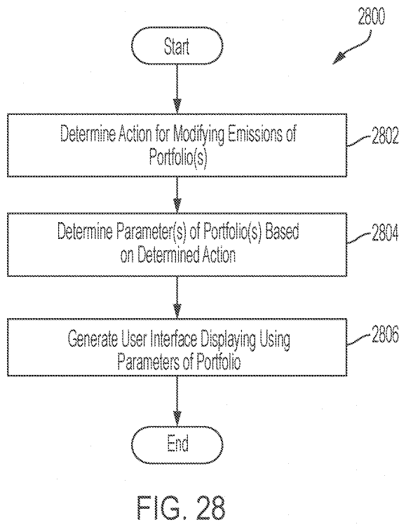

Shown in FIG. 28 is a flow chart of an example process 2800 for implementing actions to modify emission of one or more portfolio(s). Process 2800 may be performed by any suitable computing device. For example, process 2800 may be performed by emission management system 2602 described above with reference to FIGS. 26A-B.

Process 2800 begins at block 2802 where the system determines an action for modifying emission of the portfolio(s). In some embodiments, the portfolio(s) may have a target emission (e.g., one or more target net emission values) that is to be achieved for the portfolio(s). The system can be configured to determine an action for modifying emissions of the portfolio(s) to achieve the target emission. For example, the target emission may be a percentage reduction in emissions that is to be achieved for the portfolio(s). The system may also receive a time (e.g., year) that the percentage reduction is to be achieved by. In another example, the target emission may comprise a net emission value that is to be achieved by the portfolio(s) at a point in time (e.g., by a specific year). In another example, the target emission may comprise multiple net emission values that are to be achieved at different points in time (e.g., at different years).

In some embodiments, the system can be configured to determine the action for modifying emissions of the portfolio(s) by receiving a user input specifying the action. In some embodiments, the system can be configured to generate a user interface through which a user may specify one or more actions for modifying emissions for the portfolio(s). For example, the user may select from a pre-populated set of actions. Examples of actions include modification of a fuel source, installation of high efficiency lighting, reduction in heating and/or air conditioning usage, and/or other actions to reduce emissions. In some embodiments, the system can be configured to receive user input specifying actions for one or more projects of the portfolio(s). For example, the system may receive a user input specifying an action to be implemented in a manufacturing facility in Los Angeles. In some embodiments, the system can be configured to receive user input specifying an action to be implemented across the portfolio(s).

In some embodiments, the system can be configured to provide an indication of actions taken to impact emissions in one or more projects. The system can be configured to provide details associated with the project(s) and actions. For example, the system may provide cost, duration, resource requirements, and/or schedule details for the project(s) and actions. Users of the system may access the information to determine actions for modifying emissions of the portfolio(s).

In some embodiments, the system can be configured to determine the action for modifying emissions of the portfolio(s) automatically. In some embodiments, the system can be configured to make suggestions for projects based on one or more factors. The system can be configured to automatically determine an action based on historical emissions, emissions trajectory, regulatory restrictions and constraints, installed technology footprint, measurements taken to date, and/or other factors. In some embodiments, the system can be configured to determine the action automatically by providing input to a machine learning model (e.g., neural network, support vector machine, and/or decision tree) obtain an output indicating an action to be implemented in the portfolio(s) (e.g., at one or more projects). In some embodiments, the system can be configured to generate input to the machine learning model by using stored emission values for emission sources of the portfolio(s) and/or identifications of emission sources. For example, the system may determine values of input features to be emission values for the emission sources.

In some embodiments, the system can be configured to train the machine learning model using supervised learning (e.g., using past emission values and corresponding results in emission reduction). In some embodiments, the system can be configured to train the machine learning model using unsupervised learning. Some embodiments are not limited to a particular technique for training the machine learning model.

In some embodiments, the system can be configured to determine the action for modifying emissions by accepting a user-defined scenario. The user-defined scenario may represent actual modifications or be a theoretical scenario that represents possible modifications. For example, the system may receive input from a user indicating a scenario in which a fuel source for a project has been modified. In some embodiments, the system can be configured to generate a user interface providing one or more selectable inputs, wherein the selectable input(s) indicate actions for modifying emissions. The input(s) selected by a user may indicate a scenario to be analyzed by the system. For example, the system may generate a user interface including options that, when selected, indicate one or more actions to modify emissions to define a scenario.

In some embodiments, the system can be configured to determine a user scenario based on one or more user inputs. In some embodiments, the system can be configured to determine a user scenario based on project milestones specified by user input. The milestones may include target dates and/or actual completion dates. In some embodiments, the system can be configured to determine a user scenario based on implementation date(s) for project(s). In some embodiments, the system can be configured to determine a user scenario based on expenditure/cost (e.g., capital and/or operational expenses).

After determining the action for modifying emissions of the portfolio at block 2802, process 2800 proceeds to block 2804 where the system determines one or more parameters of the portfolio(s) based on the determined action. In some embodiments, the system can be configured to determine one or more net emission values expected for the portfolio(s) in the future. For example, the system may determine expected emission values based on a predicted reduction in emissions resulting from the determined action. In some embodiments, the system can be configured to determine a percentage decrease in emissions of the portfolio(s) based on the determined action. For example, the system may determine a percentage decrease in emissions resulting from implementation of the determined action for the portfolio(s). In some embodiments, the system can be configured to determine a cost and/or reduction in cost due to emissions for the portfolio(s). Examples of other parameters are discussed herein.

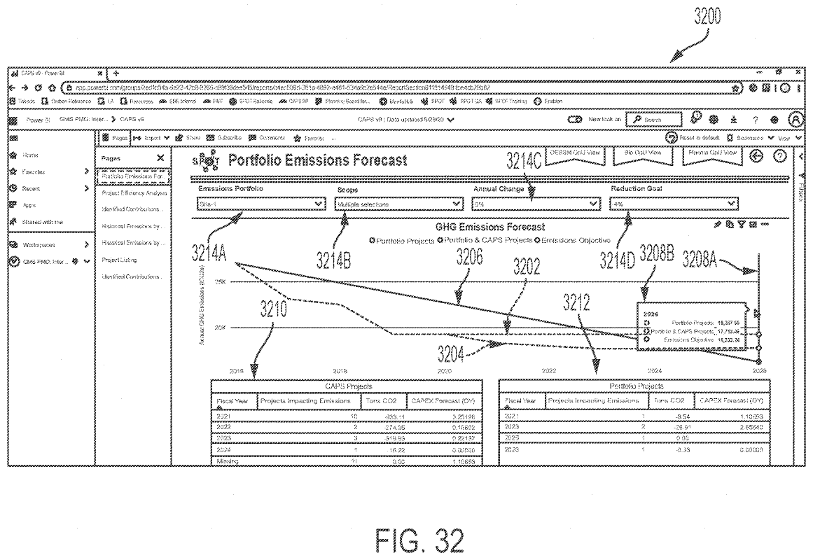

Next, process 2800 proceeds to block 2806 where the system generates a user interface using the parameter(s) determined for the portfolio(s). In some embodiments, the system can be configured to generate a display of emissions for the portfolio. For example, the system may generate a line graph plotting net emission of the portfolio(s) (e.g., in tCO2e) with respect to time. In this example, the system may plot points at future points in time (e.g., future years) determined from the action at block 2804. In some embodiments, the system can be configured to generate a user interface displaying emissions for the portfolio in conjunction with a target emission for the portfolio. For example, the system may generate a line graph including a first line for net emission of the portfolio(s) and a second line for the target emission. In this example, the system may modify points on the first line corresponding to future points in time based on the determined parameters of the portfolio(s). An example user interface generated using the parameter(s) is described herein with reference to FIG. 32.

After block 2806, process 2800 ends. A user of the system may access the generated user interface for managing emission for the portfolio(s). For example, the user may use the display to understand effects of the determined action and/or to decide whether to proceed with implementation of the determined action in the portfolio(s).

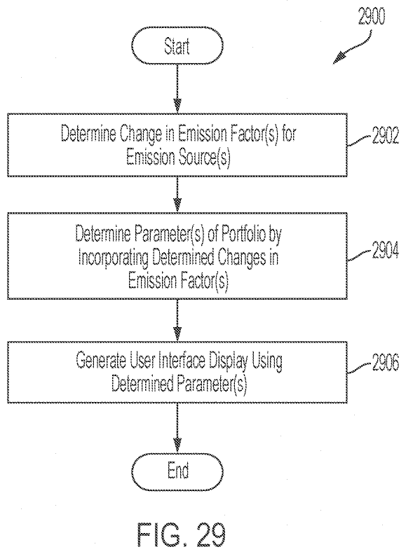

Shown in FIG. 29 is a flow chart of an example process 2900 for implementing a change in one or more emission factors, according to some embodiments. Process 2900 may be performed by any suitable computing device. For example, process 2900 may be performed by emission management system 2602 described above with reference to FIGS. 26A-B.

Process 2900 begins at block 2902 where the system determines a change in emission factor(s) for one or more emission source(s). In some embodiments, the system can be configured to accept an input indicating a change in the emission factor(s). In some embodiments, the system can be configured to receive data from an external computer system indicating the change in the emission factor(s). For example, the system may include an application program interface (API) via which the system may obtain the data indicating the change in the mission factor(s) from the external computer system.

In some embodiments, the system can be configured to automatically determine the change in the emission factor(s). In some embodiments, the system can be configured to (1) identify one or more changes in a project; and (2) determine a change in emission factor(s) corresponding to the identified change(s). For example, the system may determine that lighting in a project is being changed to more efficient LED lighting and, in response, determine a corresponding change in emission factor(s) for lighting in the project. The system may use the changed emission factor(s) to update emission values (e.g., in native and/or universal format) for one or more emission sources of the project. In another example, the system may determine that a fuel source being used for a project is being changed to a renewable energy source (e.g., wind energy) and, in response, determine a corresponding change in emission factor(s) for the project. The system may update emission values (e.g., in native and/or universal format) for emission source(s) of the project.

In some embodiments, the system can be configured to determine the change in the mission factor(s) by predicting the change. In some embodiments, the system can be configured to predict the change based on a model of the emission factor(s). In some embodiments, the system can be configured to use a linear regression model to determine the change in emission factor(s) based on one or more previous changes in emission factor. For example, the system may extrapolate change in emission factor(s) from one or more previous years to determine the change in emission factor(s). In some embodiments, the system can be configured to determine the change in emission factor(s) using a trained machine learning model. The machine learning model may be trained using past changes in emission factors and associated values of features (e.g., using a supervised learning technique). The system can be configured to generate feature values as input (e.g., using data indicating activity in the portfolio(s)), and provide the input to the machine learning model to obtain output indicating the change in emission factor(s). In some embodiments, the system can be configured to determine the change in emission factor(s) based on user inputs specifying future projections in the portfolio(s). The system may use the projections to determine the change in emission factor(s). For example, the system may determine the change in emission factor(s) based on user inputs specifying changes in projects of the portfolio(s) for which the system may determine corresponding change in emission factor(s).

Next, process 2900 proceeds to block 2904 where the system determines one or more parameters for one or more portfolios by incorporating the determined change in emission factor(s). In some embodiments, the system can be configured to update values of parameters for the portfolio(s). For example, the system may update a value of a current net emission of the portfolio(s) in response to determining a change in emission factor(s) for a project of the portfolio(s). In another example, the system may have previously determined predicted net emission of the portfolio(s) at one or more points in the future. In response to determining the change in emission factor(s), the system may modify the predicted net emission value(s) for the portfolio(s) by incorporating the change in emission factor(s) in determination of the predicted emission value(s).

In some embodiments, the system can be configured to determine that an emission factor changes (e.g., over a time period). For example, the system may determine that an emission factor for electricity of a project will change over a time period. The system can be configured to capture variability in the emission factor over time. In some embodiments, the system can be configured to capture the change in the emission factor by using varying values for the emission factor in determining parameter(s). For example, the system may use a first value for the emission factor to determine predicted emission for the portfolio(s) for a first year, and use a second value for the emission factor to determine predicted emission for the portfolio(s) for a second year. The system may thus capture variation in the emission factor in determining parameter(s) for the portfolio.

Next, process 2900 proceeds to block 2906 where the system generates a user interface using the determined parameter(s). In some embodiments, the system can be configured to update one or more existing displays in a user interface provided by the system. For example, the system may be displaying a graph showing predicted net emission for one or more portfolios. In response to updating the parameter(s) of the portfolio(s) based on the change in emission factor(s), the system may update the graph showing predicted net emission for the portfolio(s). In some embodiments, the system can be configured to dynamically update a display in response to a changed in emission factor(s) determined in real time. In some embodiments, the system can be configured to update the display by modifying a display shown to a user. For example, the system may change points on a graph based on the determined parameter(s). In another example, the system may update one or more emission values in a table displayed to the user. In some embodiments the system can be configured to regenerate a display shown to the user. For example, the system may regenerate a graph displayed to the user using the parameter(s) determined at block 2904.

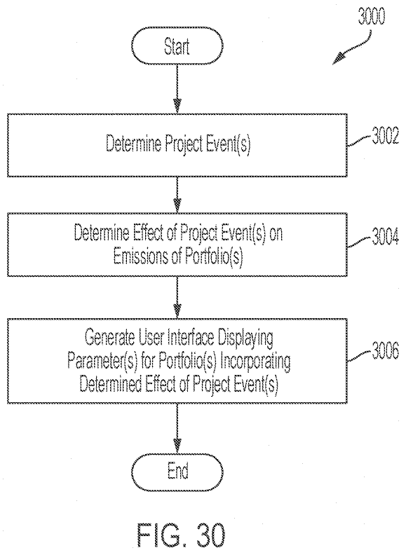

Shown in FIG. 30 is a flow chart of an example process 3000 for implementing project events in one or more portfolios, according to some embodiments. Process 3000 may be performed by any suitable computing device. For example, process 3000 may be performed by emission management system 2602 described above with reference to FIGS. 26A-B.

A project event may be any modification in a project of the portfolio(s). For example, a project event may be an increase or decrease in operations, an addition of a new operation, a stopping or starting of an operation in the project, a change in resources being used for a project, a change in timeline of an operation, and/or other modification. Some embodiments are not limited to example project events described herein.

Process 3000 begins at block 3002 where the system determines one or more project events for the portfolio(s). In some embodiments, the system can be configured to determine the project event(s) based on user input specifying the project event(s). For example, the system may receive, via a user interface shown on a display of a user device, user input specifying a change in operation for a project (e.g., reduction in manufacturing operation). In some embodiments, the system can be configured to automatically detect project event(s). For example, the system may be in communication with one or more computer systems associated with a project (e.g., via an API). The system can be configured to actively monitor projects to detect changes in status indicating a project event. For example, the system may access data indicating project status at a regular interval (e.g., every hour, day, month, and/or year). The system may determine that project event(s) have taken place in response to detecting a change in one or more statuses. For example, the system may determine that an additional manufacturing operation and/or facility has been added to a project and, in response, determine that there are additional emission sources to be included for the project.

In some embodiments, the system can be configured to determine project event(s) by accepting a user-defined scenario (e.g., as described above with reference to FIG. 28). The user-defined scenario may represent actual project event(s) or be a theoretical scenario that represents possible project event(s). For example, the system may receive input from a user indicating a scenario in which a project operation has grown (e.g., with increased manufacturing). In some embodiments, the system can be configured to generate a user interface providing one or more selectable inputs, wherein the selectable input(s) indicate project event(s). The input(s) selected by a user may indicate a scenario to be analyzed by the system. For example, the system may generate a user interface including options that, when selected, indicate operation growth, change in emission factor(s), one or more actions to modify emissions, and/or other conditions defining a scenario.

Next, process 3000 proceeds to block 3004 where the system determines the effect of the determined project event(s) on emissions of the portfolio(s). In some embodiments, the system can be configured to determine the effect of the project event(s) by determining values for one or more parameters affected by the event. For example, the system may update projected net emission values for the portfolio(s) based on the determined project event(s). In some embodiments, the system can be configured to use user input defining a scenario to determine the effect of the project event(s) on the emissions of the portfolio(s). For example, the system may use the user input to update predicted net emission value(s) for the portfolio(s) based on the user input.

In some embodiments, the system can be configured to determine the effect of the project event(s) based on a fixed growth rate. The system can be configured to determine the fixed growth rate based on an anticipated growth in production. For example, if production is to increase by 15%, the system may determine a corresponding effect on emissions of the portfolio(s). In some embodiments, the system can be configured to determine emissions of the portfolio(s) based on a quantity of products being produced. The system can be configured to determine a variable indicating marginal change in emissions for change in production. For example, the system may determine the emissions of the portfolio(s) based on a number of vials produced by a manufacturing facility. In another example, the system may determine the emissions of the portfolio(s) based on an average number of products produced. In some embodiments, the system can be configured to determine the variable for a plant. In some embodiments, the system can be configured to determine multiple variables for a plant. For example, the system may determine a variable for each of multiple facilities within the plant. In some embodiments, the system can be configured to determine a fixed emission amount for a project. A fixed emission amount may indicate emissions when nothing is being produced by one or more plants of the project.

In some embodiments, the system can be configured to determine the effect of the project event(s) based on user input. In some embodiments, the system can be configured to receive user input specifying a percentage change in emissions associated with the project event(s). In some embodiments, the system can be configured to determine the effect of the project event(s) based on past effects associated with related event(s). For example, the system may store changes in emission with respect to one or more previously occurring project events. The system may determine effects of the project event(s) based on the stored effects of the previous project event(s). In some embodiments, the system can be configured to determine effects of the project event(s) using a trained machine learning model (e.g., a neural network, decision tree model, and/or support vector machine). In some embodiments, the system can be configured to train the machine learning model using supervised learning techniques using historical data indicating project events and associated changes in parameter(s). In some embodiments, the system can be configured to train the machine learning model using unsupervised learning techniques. The system can be configured to generate input to the trained machine learning model using data indicative of the project event(s), and provide the input to the trained machine learning model. The machine learning model may output data indicating one or more parameter values for the project event(s).

Next, process 3000 proceeds to block 3006 where the system generates a user interface displaying parameter(s) for the portfolio(s) incorporating the effects of the project event(s). In some embodiments, the system can be configured to update one or more existing displays in a user interface provided by the system. For example, the system may be displaying a graph showing predicted net emission for the portfolio(s). In response to updating the parameter(s) of the portfolio(s) based on the determined effect of the project event(s), the system may update the graph showing predicted net emission for the portfolio(s). In some embodiments, the system can be configured to dynamically update a display in response to changes from the determined effect of the project event(s) on emissions of the portfolio(s). In some embodiments, the system can be configured to update the display by modifying a display shown to a user. For example, the system may change points on a graph based on the determined parameter(s). In another example, the system may update one or more emission values in a table displayed to the user. In some embodiments the system can be configured to regenerate a display shown to the user. For example, the system may regenerate a graph displayed to the user using the parameter(s) determined at block 3004.

a shows an example user interface display 3100 of emission values for a project, according to some embodiments. User interface display 3100 may be generated by emission management system 2602 described above with reference to FIGS. 26A-B. As shown in the example embodiment of FIG. 31, the user interface display 3100 includes a listing of emission sources 3102 of the project 3108. As described herein, the project 3108 may be part of a portfolio of multiple projects. The user interface display 3100 includes a listing of emission values for the emission sources in respective native formats. For example, as shown in FIG. 31, the “ELECTRICITY Purchased” emission source has an emission of −360,000 kWh. The other emission sources are shown in their native formats 3104. The user interface display 3100 includes a display of emissions for the project 3108 in a universal format of tons of CO₂/year (tCO2e/year). The user interface display 3100 includes an emissions impact realization date 3112 indicating when the emissions impact 3110 is projected to occur.

FIG. 32 shows a user interface display 3200 of emission information for portfolios, according to some embodiments. The user interface display 3200 includes a line graph with (1) a first line 3202 emissions for a first portfolio (labelled “Portfolio Projects”); and (2) a second line 3204 of emissions for a second portfolio (labelled “Portfolio & CAPS Projects”). A shown in FIG. 32, the plots for each of the first and second portfolio present historical emissions (e.g., prior to the year 2020), current emissions (e.g., in the year 2020), and predicted future emissions (e.g., after year 2020). The plot in user interface display 3200 also includes a line 3206 for a target emission (labelled “Emissions Objective”). The target emission may represent target emission values for the first and second portfolio to meet at different points in time. The user interface display 3200 may allow users to select a time to view values of each line at the point. For example, as shown in FIG. 32, the user may select point 3208A for the year 2026 to view values 3208B of estimated emissions for the first and second portfolio, and a target emission in that year.

User interface display 3200 includes a table 3210 displaying emission values by year for the “CAPS Projects” portfolio in the column labelled “Tons CO₂”, and a table 3212 displaying emission values for the “Portfolio Projects” portfolio in the column labelled “Tons CO₂.” Each of the tables 3210-3212 includes a capital expenditure forecast in the columns labelled “CAPEX Forecast (OY).” The capital expenditure may provide an impact cost for the emissions. Each of the tables includes a specification of number of projects that will impact emissions for each year in the columns labelled “Projects Impacting Emissions.”

User interface display 3200 includes an emissions portfolio menu 3214A which may be used to select a portfolio for which to view a forecast. The system can be configured to update the graph to display the selected portfolio(s). The user interface display 3200 includes a scope menu 3214B which may be used to select a scope. The system can be configured to update the graph based on the scope selected. The user interface display 3200 includes an option to specify annual change 3214C. The system can be configured to update the graph based on the annual change value specified. The user interface display 3200 includes a target emission specification 3214D where a target emission can be entered. The system can be configured to update a plot of the target emission responsive to the target emission specification 3214D.

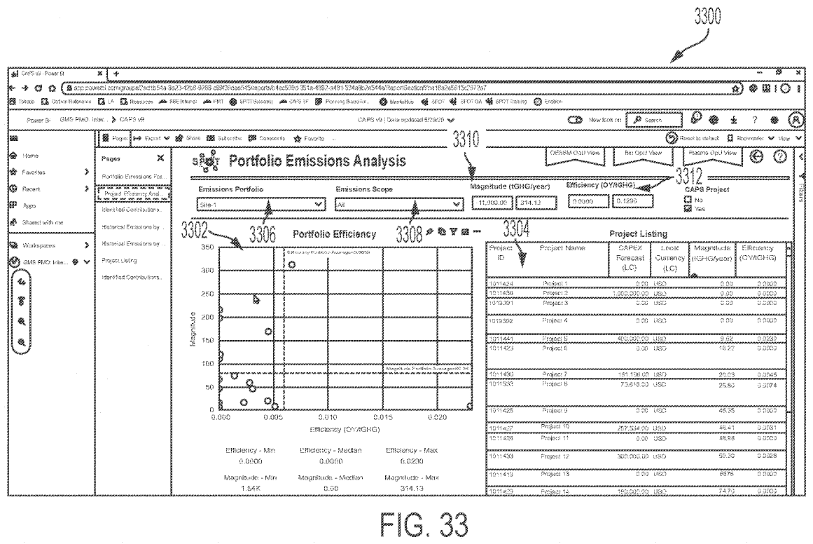

FIG. 33 shows a user interface display 3300 of emission information for projects of a portfolio, according to some embodiments. The user interface display 3300 includes a graph 3302 of portfolio efficiency. The 3302 plots a magnitude of emissions (in tGHG/year) vs. efficiency (in OY/tGHG) for each project in the portfolio. The user interface display 3300 includes a table 3304 showing emission values (in the “Magnitude” column) and efficiency values for each of the projects in the portfolio. The table 3304 also includes capital expenditure forecasts for each project (in the “CAPEX Forecast (LC)” column). The user interface display 3300 includes a portfolio menu 3306 where a user may specify a portfolio. The user interface display 3300 includes a scope menu 3308 where a user may specify a scope. The user interface display 3300 includes a magnitude setting 3310 for defining the upper and lower limits of emission values displayed. The user interface display 3300 includes an efficiency setting 3312 for defining upper and lower limits of efficiency to be displayed.

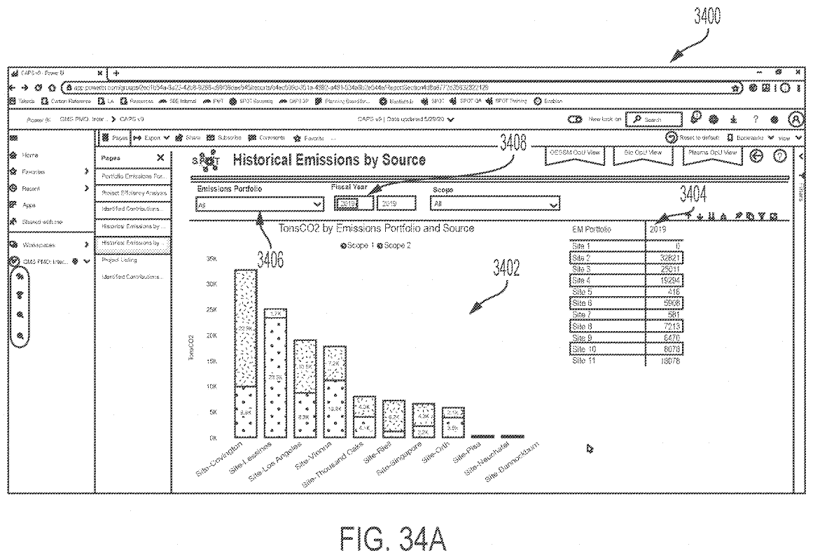

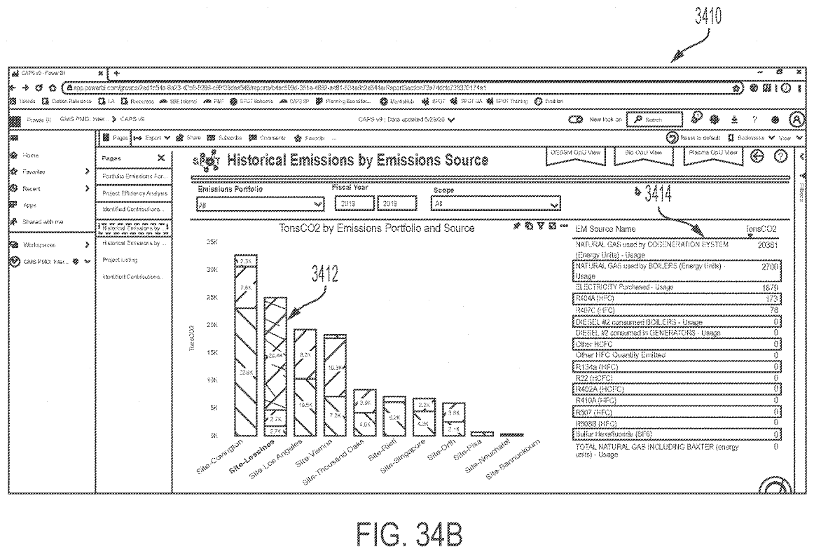

FIG. 34A shows a user interface display 3400 of historical emissions for one or more portfolios, according to some embodiments. The user interface display 3400 includes a bar graph 3402 showing tons of CO₂ emitted by each project in the selected portfolio(s). The user interface display 3400 includes a table 3404 with the emission value for each project in the portfolio. The user interface display 3400 includes a portfolio menu 3406 which allows a user to select which portfolio to view historical emissions for. In the example of FIG. 34A, all portfolios have been selected. The user interface display 3400 includes a year setting 3408 allowing a user to specify one or more years for which emissions are to be displayed.

FIG. 34B shows a user interface display 3410 of emission information for a specific project 3412 selected from user interface display 3400 shown in FIG. 34A. In the example of FIG. 34B, the user selected the Site-Lessines project. As shown in the example of FIG. 34B, the system may highlight the bar for the selected project in the graph in response to a user selection. The user interface display 3410 displays a table 3414 of emission values for emissions sources of the selected project 3412.

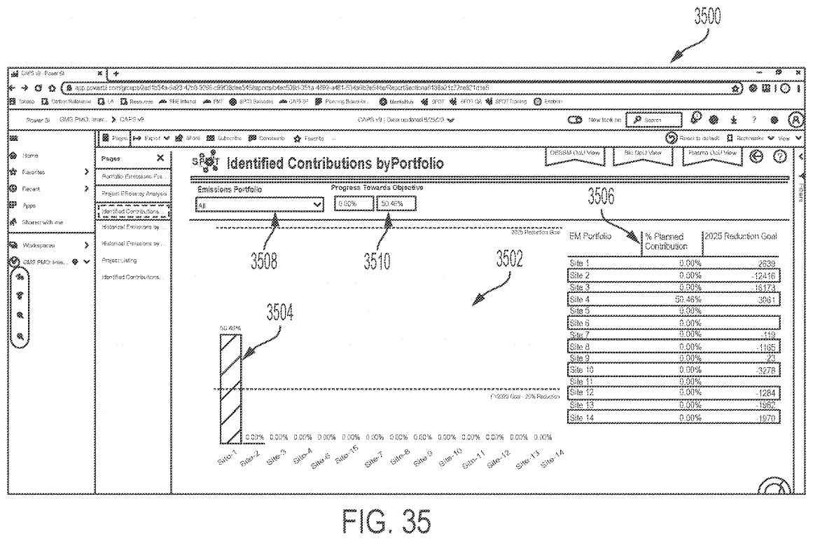

FIG. 35 shows a user interface display 3500 of target contributions of different projects of one or more portfolios to a target emission reduction of the portfolio(s), according to some embodiments. As shown in the example of FIG. 35, the user interface display 3500 includes a graph 3502 showing a percentage contribution of multiple projects to target emission reduction. The project 3504 of Site-1 has a contribution of 50.46% to the target emission reduction. The user interface display 3500 includes a table 3506 listing projects, respective contributions, and emission reduction goals. The user interface display 3500 includes a portfolio menu 3508 which allows selection of portfolio(s) to view. The user interface display 3500 includes a setting 3510 which allows specification of a range of contributions for viewing. As illustrated in the example of FIG. 35, a range of 0.00% to 54.6% has been specified.

### Example Implementation of Some Embodiments

Some embodiments (e.g., system 102 and/or system 450 described herein with reference to FIGS. 1A-B) can be configured to implement one or more of the following functions:
a. Program Management—Organizing multiple, individual project records into a hierarchical tree structure for treatment and management as a collection. In some embodiments, associated projects may be organized into a tree structure. The system can be configured to provide a user interface allowing a user to view associated projects and information about the associated projects (e.g., status indicators, milestone progression, and/or target dates). An example user interface displaying a tree structure of associated projects is described herein with reference to FIG. 7G.
b. Templatized project lifecycle management—Functionality to advance a project through a lifecycle, from inception to closure, using templatized artifacts and standardized data structures. In some embodiments, the data structures are implemented as connected tables in a database (e.g., an SQL database).
c. Document Management—Store documents within a project record. In some embodiments, the system can be configured to store documents in a folder tree. Users may access the documents for downloading, modification, deletion, and/or addition of new documents. An example user interface displaying a document record is described herein with reference to FIG. 7G.
d. Currency Management—Functionality to input financial forecasts and receive financial reports in any combination of currencies (e.g., enter forecasts in Euros and generate corresponding reports in Dollars).
e. Portfolio Management
   i. User-facing functions
      1. Filtering
      2. Portfolio Assessment
      3. Project Grid Analysis
      4. Event driven updates. Examples of events that can be configured to trigger an update include user request for a dashboard, update of data, and/or update made to an associated project (e.g., a child project). An event may trigger an update to a project and/or portfolio. For example, the event may trigger an update to project status and/or data quality.
      5. Portfolio definition and attribute identification—(Portfolio unique data structure defined as a logical collection of projects).
   ii. Flexible and standardized data architecture/back-end
      1. Establish and define a minimum set of data elements for analysis based on templates
      2. Enable extensibility beyond standard sets (e.g., augment the minimum without conflict)
      3. Filter data and projects by standard and custom attributes
   iii. Organized reporting into Portfolios
      1. Portfolio definition that is easy and flexible
         a. Owner/Admin defines groupings of projects and Templates of data to analyze/display for respective portfolios. Example user access levels can include:
         i. Read only—View data in the system and generate reports without editing.
         ii. Project Manager—Edit data in the system but restricted from one or more operations (e.g., setting baseline dates for schedules and/or configuring metadata). Project managers can grant project manager level access to users for respective projects.
         iii. Administrator—Full access to all available functions, including setting access levels for other users and access to all projects including those that are confidential. In some embodiments, projects may be marked confidential by administrator and/or project manager. Administrators can grant project manager level access to users for respective projects.
         b. Data displays that are standardized yet flexible (e.g., define standard set of data elements, enable extension)
         i. Portfolio Tiles—dynamic real time data
         ii. Detailed view linked to teach tile
         iii. Project Grid
      2. Template selection eliminates complex query/data design issues by automatically populating data from the database into pre-defined, flexible reporting templates (e.g., Powerpoint). In some embodiments, the templates are preconfigured arrangements of fields, each of which is linked to one or more database fields (e.g., columns). When the user initiates a request for a report, the system may retrieve the fields related to that specific record or set of record (e.g., rows) and populate the relevant fields into the template. The populated template is then made available to the user (e.g., as an email attachment, or as a file available for download on a website). In some embodiments, the system may perform calculations on one or more database fields to populate one of the template fields (e.g., a status indicator and/or a progress bar).
   iv. Standardized templates of groups of metadata
      1. Simple options for Owner/Administrator to select data templates for inclusion into a desired Portfolio. A user may specify data that is to be populated into a template via a user interface. For example, a user may select milestones to include in a report from a set of available milestones on record. A populated template may be editable by a user for style and content.
      2. Flexible additions of template and/or addition of custom metadata fields
   v. Key Performance Indicators (KPI) & Data Consumption/Analysis
      1. Establish a standard set (MVP) of performance indicators for analyzing Portfolio Performance
         a. Pre-defined business rules enable consistent calculation of KPIs across the entire constellation of project data records, which further enable meaningful consolidation of KPIs into portfolio views
      2. Distill entire data set into minimum set of KPI (e.g., 6)
      a. Establish dependencies between Performance Indicators
         i. E.g., risk indicator/schedule dependency
         ii. In a project record of some embodiments, milestones may be early, on time, or late. The combination of the milestones' individual statuses is interpreted by the system via configurable business rules to present a single, overall assessment of the project schedule. The same is true for all cases in which individual status elements may be combined to inform an overarching status. In another example, the system may combine project schedule statuses to establish the overall status of a parent program's schedule, or combine respective project risk statuses to garner an overall risk status for a project. The business rules may be pre-defined (e.g., by an administrator). In some embodiments, the business rules may be applied across the entire portfolio to enable consistent status reporting across an enterprise.
      3. Data Status Analysis
         a. Red/Yellow/Green
         b. Timeliness indicators (e.g., squares, arrows, etc.)
      4. Confidence Evaluation of Data
         a. Assets “freshness” of data (e.g., provide a visualization)
f. Prioritization
   i. Business rules aligned with strategic objectives
   ii. Mathematical Model
   iii. Deliver consistent ranking of projects based on “business value”
      1. Standardized modeling of value across projects/portfolios/acquisitions
g. Scenario Planning
   i. Predictive modeling
      1. In some embodiments, key performance indicators (KPIs) have a lead-lag relationship. Accordingly, if one status KPI goes bad (e.g., red) and remains un-remediated, others may be likely to follow. In some embodiments, this relationship may be defined based on the intent of the use of the KPIs.
      2. In some embodiments, a machine learning algorithm is trained on patterns of key KPIs as they relate to individual projects and portfolios. The trained machine learning model may be used to predict the future state of those KPIs. For example, if there is a risk that the KPI will be red for 3 reporting cycles, there may be a risk of a schedule turning from green to yellow. A machine learning model may be used to predict that a schedule will turn red in the next reporting cycle.
h. User Interface
   i. Dashboard—Portfolio Center
      1. Portfolio Tiles
      2. At glace—Summary of All Data and Status (via KPI)
      3. Visual indicators
   ii. Dashboard—Project Hub
      1. Project KPI Management
      2. Status, Risk, Milestone displays
i. Data Capture/Ingestion (Tabled for further review—Low Priority)
   i. Consider “playbook” for data ingestion of acquired entities
   ii. Potential value in subsequent mergers/partnerships

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

As described herein “authentication system” includes systems that can be used for authentication as well as systems that be used for identification. Various embodiments describe helper network that can be used to improve operation in either context. The various functions, processes, and algorithms can be executed in the context of identifying an entity and/or in the context of authenticating an entity.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to FIGS. 4-7, 9-11, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. An electronic gas emission management system, the system comprising:
at least one processor configured to:
accept emission values for a plurality of emission sources of at least one portfolio according to native input formats for the plurality of emission sources;
translate the native input formats into a first format, wherein the first format allows comparing the emission values for the plurality of emission sources; and
accept user input specifying a target emission for the at least one portfolio;
a data store configured to store the emission values for the plurality of emission sources of the at least one portfolio in the first format;
a reporting component, executed by the at least one processor, configured to determine values for one or more parameters using the emission values for the plurality of emission sources stored in the first format; and
a user interface component, executed by the at least one processor, configured to generate a display for the at least one portfolio responsive to determination of the one or more parameters by the reporting component.

2. The system of claim 1, wherein the first format comprises a first unit of measurement of emission.

3. The system of claim 2, wherein the first unit of measurement is tCO2e/year.

4. The system of claim 1, wherein the plurality of input formats comprise a plurality of units of measurement.

5. The system of claim 4, wherein the plurality of units of measurement include one or more of the following units: kilowatt-hours (kWh), gallons (gal), or pounds (lbs.).

6. The system of claim 1, wherein the one or more parameters include one or more of net emission, mean emission per project, or projected net emission.

7. The system of claim 1, wherein the one or more parameters include cost of emissions, projected cost for reduction of emissions, cost for achieving the target emission, emissions abated per unit of currency spent.

8. The system of claim 1, wherein the at least one processor is configured to accept the target emission in the first format.

9. The system of claim 1, wherein the at least one processor is configured to:
use the stored emission values and the target emission to generate input features for a machine learning model; and
provide the generated input features to the machine learning model to obtain an output indicating one or more actions to achieve the target emission.

10. The system of claim 1, wherein the at least one processor is configured to determine a resource value associated with projected changes in greenhouse emission values for the at least one portfolio.

11. The system of claim 10, wherein the resource value is a cost of impact, a cost of reduction, or a temporal averaged cost for reduction.

12. The system of claim 10, wherein the at least one processor is configured to determine a resource valuation for achieving the target emission for the at least one portfolio.

13. The system of claim 12, wherein the at least one processor is configured to:
determine a timeline associated with achieving the target emission; and
dynamically project the resource valuation based on the timeline.

14. The system of claim 13, wherein the reporting component is configured to access project events associated with the target emission and the timeline.

15. The system of claim 14, wherein the at least one processor is configured to:
automatically generate the project events; and
evaluate completion criteria associated with the project events against the target emission and the timeline.

16. The system of claim 1, wherein the target emission comprises a target percentage decrease in emissions and/or a target emission output value.

17. The system of claim 1, wherein the user interface component is configured to:
generate a display showing the emission values for the plurality of emission sources in the native input formats and the first format.

18. The system of claim 1, wherein the user interface component is configured to:
toggle display of the emissions values between the native input formats and the first format responsive to a user selection.

19. The system of claim 1, wherein:
the at least one processor is configured to accept an input specifying an action for modifying emission for the at least one portfolio;
the reporting component is configured to determine, responsive to the specified action, a predicted change in an emission value for the at least one portfolio in the first format; and
the user interface component is configured to generate a visualization of the predicted change in emission in the display for the at least one portfolio.

20. The system of claim 1, wherein the reporting component is configured to:
determine a change in emission factor for at least one of the plurality of emission sources; and
update at least one of the one or more parameters responsive to the change in emission factor.

21. The system of claim 1, wherein the data store is configured to store historical, present, and projected emission values for the plurality of emission sources of the at least one portfolio.

22. The system of claim 21, wherein:
the at least one processor is configured to use the historical, present, and projected emissions values to determine net emission for the at least one portfolio over a time period; and
the user interface component is configured to generate a graph including a plot of the net emission over the time period.

23. A computer-implemented method of managing greenhouse gas emissions, the method comprising:
accepting emission values for a plurality of emission sources of at least one portfolio according to native input formats for the plurality of emission sources;
translating the native input formats into a first format, wherein the first format allows comparing the emission values for the plurality of emission sources;
accepting user input specifying a target emission for the at least one portfolio;
storing, in a data store, the emission values for the plurality of emission sources of the at least one portfolio in the first format;
determining values for one or more parameters using the emission values for the plurality of emission sources stored in the first format; and
generating a display for the at least one portfolio responsive to determination of the one or more parameters by the reporting component.

24. The method of claim 23, wherein the first format comprises a unit of measurement of emission.

25. The method of claim 24, wherein the first unit of measurement of emission is tCO2e/year.

26. The method of claim 24, wherein the plurality of input formats comprise a plurality of units of measurement of emission.

27. The method of claim 23, wherein the one or more parameters include one or more of net emission, mean emission per project, or projected net emission.

28. The method of claim 23, wherein the one or more parameters include cost of emissions, projected cost for reduction of emissions, cost for achieving the target emission, emissions abated per unit of currency spent.

29. The method of claim 23, further comprising determining a resource value associated with projected changes in greenhouse emission values for the at least one portfolio.

30. The method of claim 23, further comprising:
automatically generating the project events; and
evaluating completion criteria associated with the project events against the target emission and the timeline.

31-50. (canceled)
